(19) United States
(12) Patent Application Publication
(10) Pub. No.: US 2006/0168551 A1
(43) Pub. Date: Jul. 27, 2006

(54) Integrated circuit having a multi-layer structure and design method thereof

(75) Inventor: Mamoru Mukuno, Hashima-shi (JP)

Correspondence Address: McDERMOTT WILL & EMERY LLP, 600 13th Street, N.W., Washington, DC, 20005-3096, US

(73) Assignee: SANYO ELECTRIC CO., LTD., Osaka (JP)

(21) Appl. No.: 11/319,644

(22) Filed: Dec. 29, 2005

Related U.S. Application Data
(63) Continuation of application No. PCT/JP04/09190, filed on Dec. 30, 2004.

(30) Foreign Application Priority Data
Jun. 30, 2003 (JP) 2003-186449
Jun. 30, 2003 (JP) 2003-186450
Apr. 27, 2004 (JP) 2004-131520
Apr. 28, 2004 (JP) 2004-132688

(51) Int. Cl. G06F 17/50

(52) U.S. Cl. 716/5

(57) ABSTRACT

An integrated circuit has a multi-layer wiring structure formed on a substrate. The integrated circuit comprises wiring patterns provided to multiple wiring layers so as to extend as signal paths in generally the same direction in a manner in which the images of the wiring patterns projected onto the substrate of the integrated circuit overlay or overlap one another. The wiring patterns provided to the multiple wiring layers are connected with each other through via holes so as to form a single wiring pattern connecting two desired points in the integrated circuit. The single wiring pattern thus formed has one of: a wiring structure for connecting predetermined terminals of two desired circuit elements; a wiring structure for fixing the electric potential of a predetermined terminal of a desired element; and a wiring structure in which one end of the single wiring pattern is substantially opened.

### BACKGROUND OF THE INVENTION

1. Field of the Invention

The present invention relates to an integrated circuit having a multi-layer wiring structure formed on a substrate.

2. Description of the Related Art

In recent years, layout design of semiconductor integrated circuits using a general-purpose automatic layout wiring tool is becoming widespread for increasing the circuit density of the semiconductor integrated circuit while reducing design time. With such an automatic layout wiring tool, a grid is defined so as to satisfy a design rule requested from the side of the manufacturing process for the semiconductor integrated circuit. The wiring pattern can be designed on the grid.

The grid is defined in the X-axis direction and the Y-axis direction orthogonal thereto. In each wiring layer, the aforementioned grid is defined in the form of stripes extending in parallel to each other. Furthermore, the grid pitch is set so as to correspond to the wiring pitch satisfying the design rule. With the layout design using the aforementioned automatic layout wiring tool with such settings, trial and error are repeated for designing the layout and wiring so as to satisfy the aforementioned design rule and the requested circuit properties, thereby determining a final mask layout.

However, in some cases, layout design employing such a grid creates an excessive wiring layer which is not effectively used. That is to say, such layout design does not always provide the desirable result from the perspective of the effective wiring. Accordingly, as disclosed in Patent document 1, a method has been proposed employing a grid defined in an oblique direction with respect to the X-axis direction and the Y-axis direction, as well as being defined in the X-axis direction and the Y-axis direction.

[Patent document 1]

Japanese Patent Application Laid-open No. 7-86407

In recent years, improved fine processing technology of a semiconductor integrated circuit involves increased wiring resistance due to reduction in the wiring width in the semiconductor integrated circuit, increased capacitance between the wiring patterns due to the reduced interval between the adjacent wiring patterns, and so forth. These adverse effects lead to various kinds of problems such as increased voltage drop in the wiring (IR drop), increased crosstalk noise, electromagnetic interference (EMI), electromigration, and so forth, which are becoming great problems that cannot be ignored from the perspective of circuit design.

In semiconductor circuit design, there is a need to design a circuit satisfying desired properties while packing the layout of circuit elements (or devices) and wiring patterns in a limited space. The aforementioned increase in resistance and increase in capacitance between the wiring patterns lead to great adverse effects on transmission of signals. However, a simple countermeasure such as circuit design, in which the wiring pattern are designed with a greater wiring width in order to reduce the resistance thereof and the capacitance therebetween, leads to difficulty in designing a desirable circuit in such a limited space.

In some cases, with the aforementioned automatic layout wiring tools developed so as to make wiring between the components of a semiconductor integrated circuit, it is becoming difficult to handle such problems due to the improved fine processing technology. That is to say, with the trial and error processing performed by the aforementioned automatic layout wiring tools for designing connections, it has become extremely difficult to obtain a solution which satisfies design constraints such as timing and so forth due to the aforementioned problems. This increases the load of design and development of a semiconductor integrated circuit, leading to a new problem of an increased development time.

### SUMMARY OF THE INVENTION

The present invention has been made in view of the aforementioned problems. Accordingly, it is an object thereof to provide an integrated circuit which allows more effective design thereof so as to satisfy the desired circuit properties while suppressing an increase in a space in which the semiconductor circuit is formed, and a design method thereof.

One embodiment of the present invention relates to an integrated circuit having a multi-layer wiring structure formed on a substrate, and a feature thereof is the manner in which the wiring pattern is provided to the multi-layer wiring layers. These features are as follows.

A second wiring layer is provided separately from a first wiring layer where a first wiring pattern necessary for connecting two desired points in an integrated circuit. The second wiring layer is provided with a second wiring pattern, separate from and supplementary to the first wiring pattern for connecting the two desired points. This supplementary second wiring pattern is connected to the first wiring pattern by via holes in various manners, such as serially, in parallel, and so forth. Combining wiring patterns formed thus serves to adjust electric properties of the wiring pattern connecting the two desired points of the integrated circuits, such as resistance, inductance, parasitic capacitance occurring between adjacent wiring patterns, delay time of signal transmission, and so forth.

With an arrangement wherein the first wiring layer and the second wiring layer are adjacent one to another, the first wiring layer and the second wiring layer can be easily connected by via holes. Also, with an arrangement wherein images of the first wiring pattern and the second wiring pattern projected onto the substrate match one another, both wiring layers can be masked using the same mask, and further, connection of the wiring patterns through via holes can be easily performed.

Another embodiment of the present invention relates to a design method of an integrated circuit. The overview of this integrated circuit design method is as follows.

Multiple circuit elements of which the integrated circuit is configured are laid out. The circuit elements that have been laid out are connected using temporary wiring patterns based on wiring pattern settings characterized by a temporary physical layer which is a virtual wiring. Whether or not the electric properties of circuit blocks formed by connection using the temporary wiring patterns satisfy desired properties is determined by computation means.

The wiring pattern provided as a temporary physical wiring layer is converted into an actual wiring layer. First, the wiring pattern of a single temporary physical wiring layer is converted into the wiring pattern of a single actual wiring layer. In a case that determination has been made that the circuit block obtained by such conversion does not satisfy the desired properties, the wring pattern of the temporary physical wiring layer is converted into the wiring patterns of multiple actual wiring layers. This conversion using the multiple actual wiring layers is made in various layout manners used in an integrated circuit as described above. Specifically, with such conversion, the wiring length and the capacitance between the wiring patterns are adjusted, thereby allowing the circuit block to be designed with desirable properties.

With conventional techniques, in the event that a circuit block did not satisfy the desired properties, the wiring is designed on the temporary physical wiring layers again from the start, with this process being repeated until the desired properties were finally obtained. With one embodiment of the present invention, in the event that a circuit block does not satisfy the desired properties, conversion of the temporary wiring is performed again using the additional wiring layers, so as to adjust the electrical properties of the wiring pattern. This conversion of the temporary wiring layer is performed according to predetermined rules, and accordingly, the computational load can be reduced as compared with cases wherein the temporary wiring is redone all over again.

It is to be noted that any arbitrary combination or rearrangement of the above-described structural components and so forth are all effective as and encompassed by the present embodiments.

Moreover, this summary Qf the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A through 1C are plan views of the configuration of an integrated circuit according to a first embodiment of the present invention;

FIGS. 2A through 2D are diagrams illustrating a wiring structure according to the embodiment;

FIGS. 3A through 3D are diagrams illustrating a wiring structure according to the embodiment;

FIGS. 4A through 4E are diagrams illustrating a wiring structure according to the embodiment;

FIG. 5 is a block diagram illustrating the overall configuration of a design support apparatus of the integrated circuit according to the embodiment;

FIG. 6 is a flowchart illustrating the design procedures for designing the integrated circuit according to the embodiment;

FIGS. 7A through 7C are diagrams illustrating the relation between a circuit diagram, and a layout using a temporary physical wiring pattern of the same circuit diagram, with the embodiment;

FIGS. 8A through 8D are diagrams illustrating the relation between a circuit diagram, and a layout using a temporary physical wiring pattern of the same circuit diagram, with the embodiment;

FIGS. 9A through 9F are diagrams illustrating masks created with the embodiment;

FIGS. 10A through 10C are diagrams illustrating the wiring structure of an integrated circuit according to a second embodiment of the present invention;

FIGS. 11A through 11D are diagrams illustrating a wiring structure according to the seconds embodiment;

FIGS. 12A through 12F are diagrams illustrating masks created with the second embodiment;

FIGS. 13A and 13B are diagram illustrating wiring structures according to the first and second embodiments;

FIG. 14 is a flowchart illustrating the design procedures for designing the integrated circuit according to a third embodiment of the present invention;

FIG. 15 is a block diagram illustrating the overall configuration of a design support apparatus of the integrated circuit according to a fourth embodiment of the present invention;

FIG. 16 is a flowchart illustrating the design procedures for designing the integrated circuit according to the fourth embodiment of the present invention;

FIGS. 17A and 17B are diagrams illustrating examples of setting sub-regions in the fourth embodiment;

FIGS. 18A through 18D are diagrams illustrating line connection between adjacent sub-sections in the fourth embodiment;

FIGS. 19A through 19D are diagrams illustrating line connection between adjacent sub-sections in the fourth embodiment;

FIGS. 20A through 20E are diagrams illustrating the wiring structure of an integrated circuit according to a fifth embodiment of the present invention;

FIG. 21 is a flowchart illustrating the design procedures for the integrated circuit according to the fifth embodiment;

FIGS. 22A through 22D are diagrams illustrating line connection between adjacent sub-sections in the fifth embodiment;

FIGS. 23A through 23D are diagrams illustrating line connection between adjacent sub-sections in the fifth embodiment;

FIGS. 24A through 24F are diagrams illustrating examples of setting sub-regions in an integrated circuit according to a sixth embodiment of the present invention;

FIG. 25 is a flowchart illustrating the design procedures for an integrated circuit according to a seventh embodiment of the present invention;

FIGS. 26A through 26C are plan views illustrating the wiring structure of the seventh embodiment;

FIGS. 27A through 27C are plan views illustrating the wiring structure of the seventh embodiment;

FIGS. 28A through 28C are plan views illustrating the wiring structure of the seventh embodiment;

FIGS. 29A through 29E are diagrams illustrating the wiring structure for an integrated circuit according to an eighth embodiment of the present invention;

FIGS. 30A through 30D are diagrams illustrating masks created with the eighth embodiment;

FIGS. 31A through 31E are diagrams illustrating the wiring structure for an integrated circuit according to a ninth embodiment of the present invention;

FIGS. 32A through 32D are diagrams illustrating masks created with the eighth embodiment;

FIGS. 33A and 33B are perspective views illustrating the wiring structure according to modifications of the aforementioned embodiments;

FIGS. 34A through 34D are circuit diagrams of the wiring patterns in the aforementioned embodiments;

FIGS. 35A through 35C are schematic diagrams illustrating the wiring structure in a modification;

FIGS. 36A through 36C are schematic diagrams illustrating the wiring structure in a modification;

FIGS. 37A through 37C are schematic diagrams illustrating the wiring structure in a modification;

FIGS. 38A through 38D are schematic diagrams illustrating the wiring structure in a modification;

FIGS. 39A through 39C are schematic diagrams illustrating the wiring structure in a modification;

FIGS. 40A through 40D are schematic diagrams illustrating the wiring structure in a modification;

FIGS. 41A through 41D are schematic diagrams illustrating the wiring structure in a modification;

FIGS. 42A through 42C are schematic diagrams illustrating the wiring structure in a modification;

FIGS. 43A through 43C are schematic diagrams illustrating the wiring structure in a modification;

FIGS. 44A through 44D are schematic diagrams illustrating the wiring structure in a modification;

FIGS. 45A through 45E are plan views illustrating the configuration of a semiconductor integrated circuit according to an eleventh embodiment of the present invention;

FIGS. 46A through 46C are diagram illustrating the way in which wiring patterns are provided according to the eleventh embodiment;

FIGS. 47A through 47D are diagrams illustrating the way in which wiring patterns are provided according to the eleventh embodiment;

FIGS. 48A through 48D are diagram illustrating the way in which wiring patterns are provided according to the eleventh embodiment;

FIG. 49 is a block diagram illustrating the configuration of a design support apparatus of the semiconductor integrated circuit according to the eleventh embodiment;

FIG. 50 is a flowchart illustrating the design procedures for designing the semiconductor integrated circuit according to the eleventh embodiment;

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

First, an overview of the embodiments will be described.

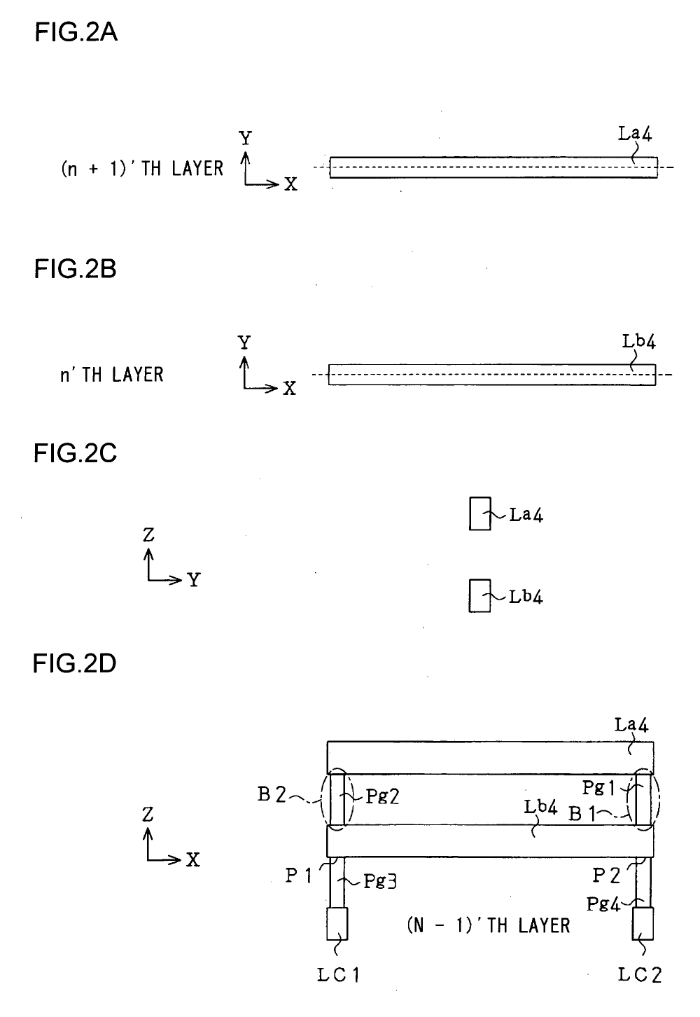

(1) An integrated circuit, serving as one arrangement, has a multi-layer wiring structure formed on a substrate, comprising wiring patterns provided to multiple wiring layers so as to extend in generally the same signal path direction in a manner in which the images of the wiring patterns projected onto the substrate of the integrated circuit overlay or overlap one another. The wiring patterns provided to the multiple wiring layers are connected with each other through via holes so as to form a single wiring pattern connecting two desired points in the integrated circuit, and the single wiring pattern thus formed has one of: a wiring structure for connecting predetermined terminals of desired two circuit elements; a wiring structure for fixing the electric potential of a predetermined terminal of a desired element; and a wiring structure in which one end of the single wiring pattern is substantially opened. The wiring structures illustrated in FIGS. 2A through 4D, 10A through 11D, FIGS. 13B and 13B, and so forth correspond to this arrangement.

The term “the images of the wiring patterns projected onto the substrate of the integrated circuit overlay or overlap one another” means that the multiple wiring patterns provided to different wiring layer have essentially the same signal path direction, and includes, but is not restricted to, the following configurations when projecting the multiple wiring patterns into the substrate: one projected image matching another projected image; one projected image being completely encompassed within another projected image; and one projected image and another projected image overlapping at a part thereof such that the two wiring patterns can be connected through a via hole.

(2) An integrated circuit, serving as one arrangement, having a multi-layer wiring structure formed on a substrate, comprises: a first wiring pattern for connecting two desirable points in the integrated circuit; and a second wiring pattern provided to a wiring layer different from the wiring layer where the first wiring pattern is provided. The first wiring pattern and the second wiring pattern are provided in a manner in which the images thereof projected onto the substrate of the integrated circuit overlay or overlap one another, and the first wiring pattern and the second wiring pattern are connected with each other through via holes so as to form a single wiring pattern connecting the two desired points. This wiring pattern functions serve as one of: a wiring structure for connecting predetermined terminals of two desired elements; a wiring structure for fixing the electric potential of a predetermined terminal of a desired element; and a wiring structure in which one end of the single wiring pattern is substantially opened. The wiring structures illustrated in FIGS. 2A through 2D, 4A through 4D, FIGS. 20A, 20B, 20D, and so forth correspond to this arrangement.

According to this integrated circuit, the degree of freedom of electrical properties which the wiring pattern is capable of assuming increases over the technique wherein signal paths are determined for each single actual wiring layer and providing actual wiring patterns accordingly, further enabling problems owing to reduction of size to minute dimensions to be easily dealt with.

(3) An integrated circuit, serving as one arrangement, having a multi-layer wiring structure formed on a substrate, comprises: a first wiring pattern for connecting two desired points in the integrated circuit; and a second wiring pattern provided to a wiring layer different from the wiring layer where the first wiring pattern is provided in parallel with the first wiring pattern. The first wiring pattern and the second wiring pattern are electrically connected in parallel with each other so as to form a single wiring pattern for connecting the two desired points.

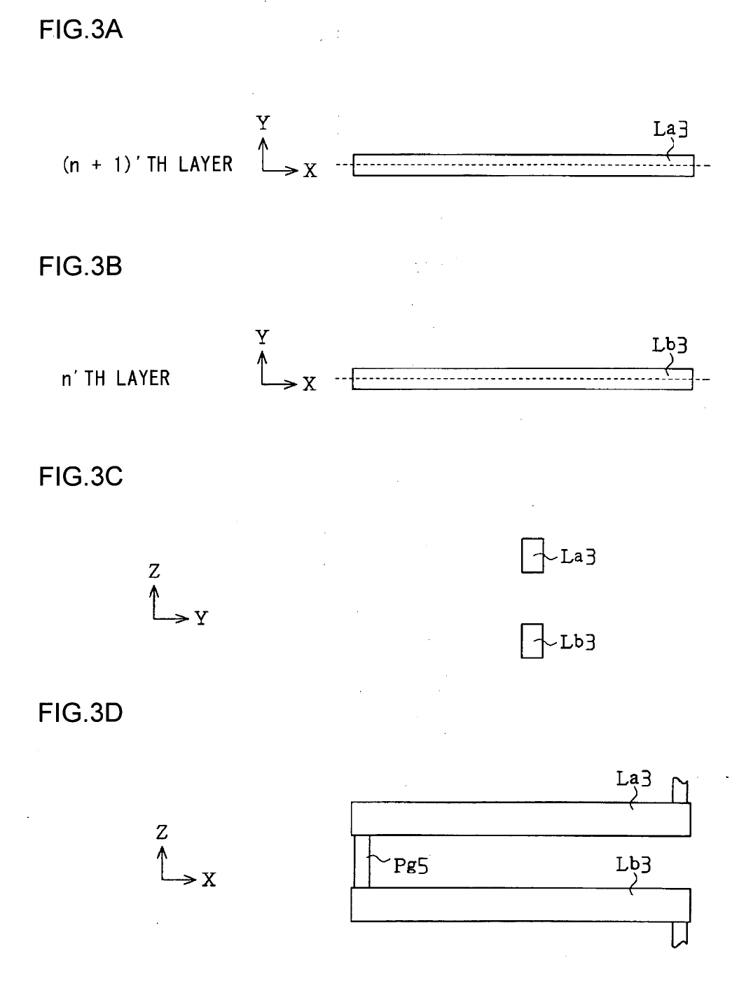

According to this integrated circuit, the second wiring pattern connected in parallel with the first wiring pattern allows wiring resistance to be reduced as compared with connecting two points with a single first wiring pattern. FIGS. 3A through 3D illustrate one example of this arrangement.

Note that this arrangement may be configured such that projected images of the first wiring pattern and second wiring pattern onto the substrate overlap. This enables the first wiring pattern and the second wiring pattern to be easily connected through a via hole, and also allows resistance values of the wiring patterns to be reduced while minimizing the layout area of the wiring patterns, and moreover enables reduction in inductance.

Further, preferably, no wiring pattern for transmitting other signals is disposed between the first wiring pattern and the second wiring pattern. Thus suitably avoids and suppresses electrical interference between the first wiring pattern and second wiring pattern with wiring patterns for transmission of other signals.

Also, the first wiring pattern and the second wiring pattern may be provided to mutually-adjacent wiring layers. Laying the wiring layers out adjacently enables electrical inference with other wiring patterns, which occurs in arrangements wherein a wiring pattern i-s provided at an intermediate layer, to be avoided and suppressed.

(4) An integrated circuit, serving as one arrangement, has a multi-layer wiring structure formed on a substrate, comprising multiple wiring patterns provided in parallel with multiple wiring layers in a manner in which the images thereof projected onto the substrate of the integrated circuit overlay or overlap one another. The multiple wiring patterns are electrically connected in serial with each other through via holes such that a signal is transmitted in the direction opposite to that of the adjacent wiring pattern, thereby forming a single wiring pattern for connecting desired two points in the integrated circuit. FIGS. 3A through 3D illustrate one example of this arrangement.

According to this integrated circuit, the resistance of the wiring can be aggressively increased without increasing the area for laying out the wiring patterns. Increase in resistance value can also be applied to adjusting signal delay, adjusting generation of reference potential, etc., in the integrated circuit. Further, the inductance of the wiring can be increased.

Further, preferably, no wiring pattern for transmitting other signals is disposed between the multiple wiring patterns. This suitably avoids and suppresses electrical interference between the multiple wiring patterns with wiring patterns for transmission of other signals.

Also, the multiple wiring patterns may be provided to mutually-adjacent wiring layers. Laying the wiring layers out adjacently enables electrical inference with other wiring patterns, which occurs in arrangements wherein a wiring pattern is provided at an intermediate layer, to be avoided and suppressed.

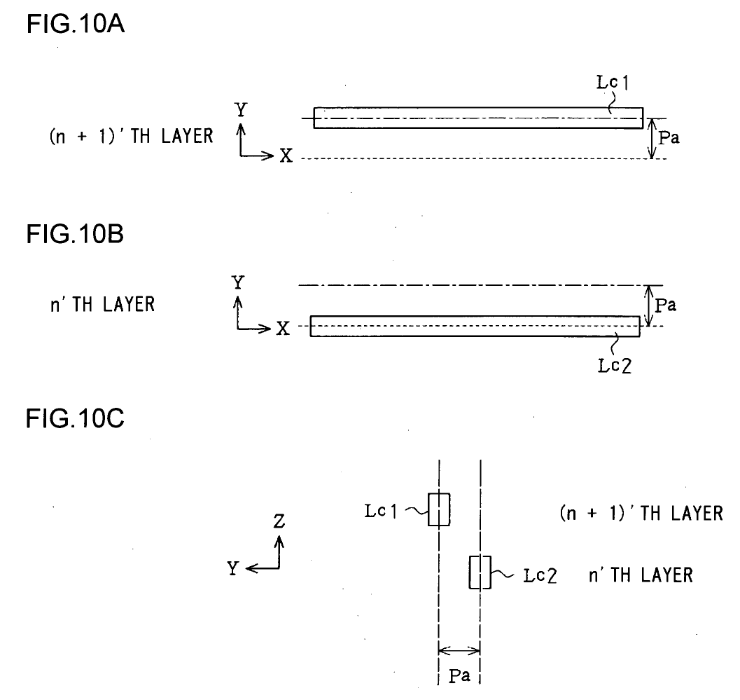

(5) An integrated circuit, serving as one arrangement, has a multi-layer wiring structure formed on a substrate, comprising a region having adjacent wiring layers to which wiring patterns are provided so as to extend in generally the same direction with generally the same pitch. The wring patterns are provided to the adjacent wiring layers with a smaller offset in the direction orthogonal to the wiring-extending direction than the pitch at which the wiring patterns are provided in the same wiring layer. FIGS. 10A through 10C illustrate an example of this arrangement.

Here, the “pitch” of the wiring patterns means the distance between center lines of wiring disposed in parallel.

According to this integrated circuit, the adjacent wiring patterns are disposed offset one from another, so the capacitance between adjacent wiring layers can be suitably reduced without enlarging the pitch in the horizontal direction of the wiring patterns.

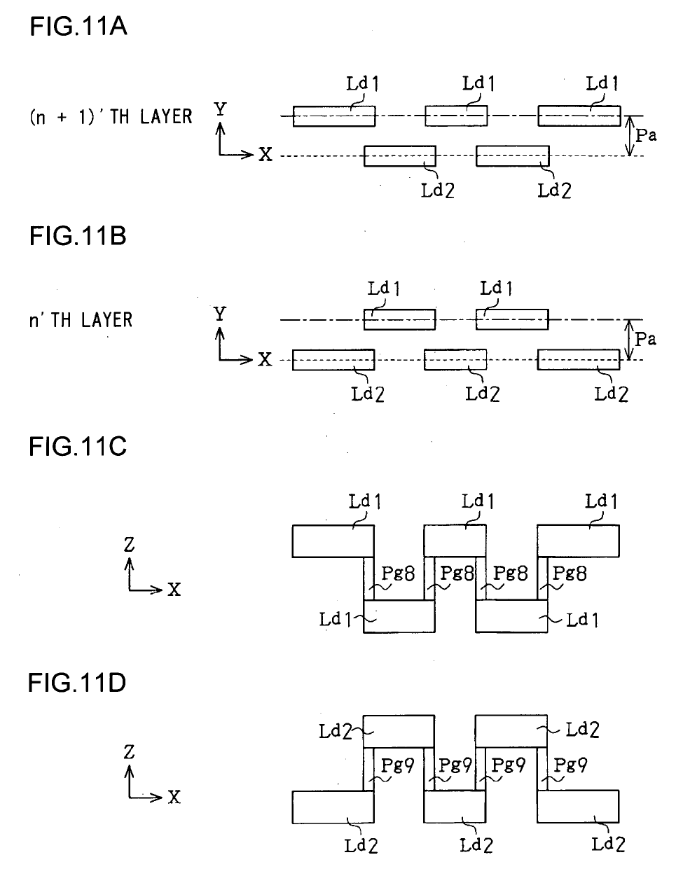

(6) An integrated circuit, serving as one arrangement, has a multi-layer wiring structure formed on a substrate, comprising a region where a first wiring pattern and a second wiring pattern are provided adjacent one another such that the images thereof projected onto the substrate extend in parallel with each other. The first wiring pattern and the second wiring pattern are provided to a first wiring layer and a second wiring layer and are situated therein, shifting back and forth between the first wiring layer and a second wiring layer, wherein each one of the first wiring pattern and the second wiring pattern are always situated in the wiring layer in which the other is not situated. FIGS. 11A through 11D illustrate an example of this arrangement.

That is to say, an integrated circuit has a multi-layer wiring structure formed on a substrate, comprising a first wiring pattern and a second wiring pattern of whose images projected onto the substrate are adjacent with each other. The first wiring pattern and the second wiring pattern are arranged such that, at portions where the first wiring pattern and second wiring pattern could be disposed adjacently, one wiring pattern is disposed at a wiring layer other than the wiring layer where the other wiring pattern is disposed. Consequently, the first wiring pattern and the second wiring pattern are permitted to be adjacent one to another as far as projection thereof onto the substrate is concerned, while reducing the length of actually being adjacent in the same wiring layer, as compared with an arrangement in which the wiring patterns are arranged adjacent to one another in a single wiring layer.

According to this integrated circuit, the length where the pair of wiring patterns are adjacent in the horizontal direction within the same wiring layer can be reduced, thereby suitably reducing the capacitance between the pair of wiring patterns.

Further, preferably, no wiring pattern for transmitting other signals is disposed between the pair of wiring patterns. This suitably avoids and suppresses electrical interference between the first wiring pattern and the second wiring pattern with wiring patterns for transmission of other signals.

Also, the pair of wiring patterns may be provided to mutually-adjacent wiring layers. Laying the wiring layers out adjacently enables electrical inference with other wiring patterns, which occurs in arrangements wherein a wiring pattern is provided at an intermediate layer, to be avoided and suppressed.

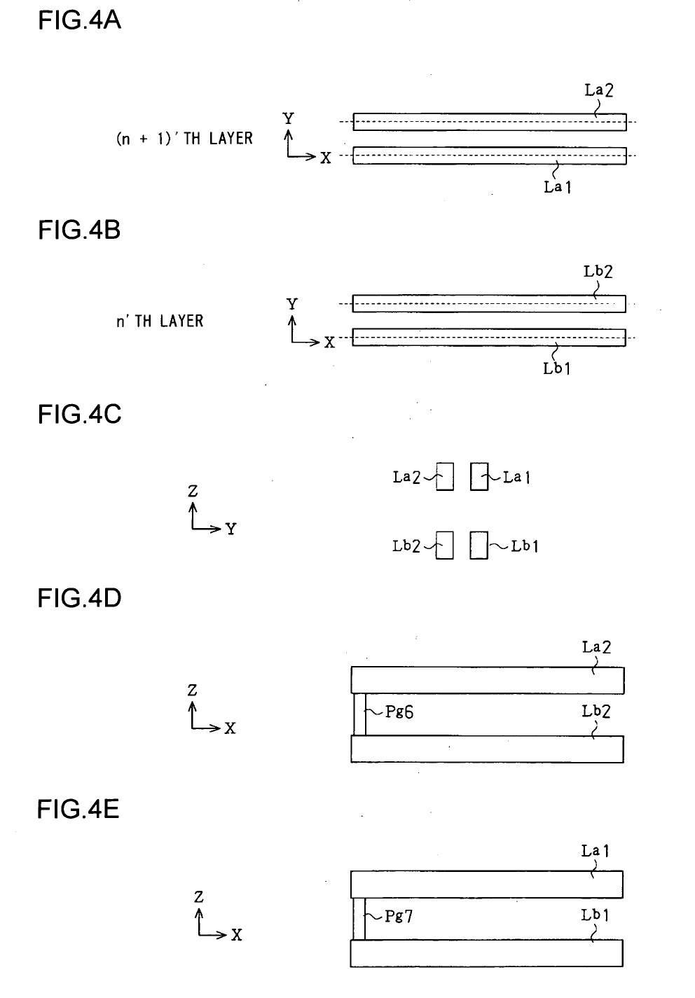

(7) An integrated circuit, serving as one arrangement, having a multi-layer wiring structure formed on a substrate, comprises: a first pair of wiring patterns provided to a predetermined wiring layer adjacent one another in parallel with each other; and a second pair of wiring patterns provided to another predetermined wiring layer adjacent one another in parallel with each other. The first pair of wiring patterns and the second pair of wiring patterns are provided such that the images thereof projected onto the substrate overlay or overlap one another, and while the one ends of the second pair of wiring patterns are connected to the first pair of wiring patterns through via holes, the other ends thereof are substantially open, whereby the second pair of wiring patterns serve as a dummy wiring pattern. FIGS. 4A through 4D illustrate an example of this arrangement.

According to this integrated circuit, wiring patterns are adjacent in multiple wiring layers, so capacitance between wiring patterns can be increased, enabling adjustment of delay of signals propagated over the wiring patterns, and also enabling impedance matching. Further, there is no need to extend the length of the wiring patterns to increase the capacitance value, so this neither violates the design rules nor increases the resistance.

Also, with this integrated circuit, the first pair of wiring patterns and the second pair of wiring patterns may be disposed such that the projection thereof onto the substrate match. Accordingly, the same mask pattern can be used for the wiring layer where the first pair of wiring patterns is disposed and the wiring layer where the second pair of wiring patterns is disposed, at least for the portion of the pair of wiring patterns.

Further, preferably, no wiring pattern for transmitting other signals is disposed between the first pair of wiring patterns and the second pair of wiring patterns. This suitably avoids and suppresses electrical interference between the first pair of wiring patterns and the second pair of wiring patterns with wiring patterns for transmission of other signals.

Also, the wiring layer where the first pair of wiring patterns is disposed and the wiring layer where the second pair of wiring patterns is disposed may be mutually adjacent wiring layers. Laying the wiring layers out adjacently enables electrical inference with other wiring patterns, which occurs in arrangements wherein a wiring pattern is provided at an intermediate layer, to be avoided and suppressed.

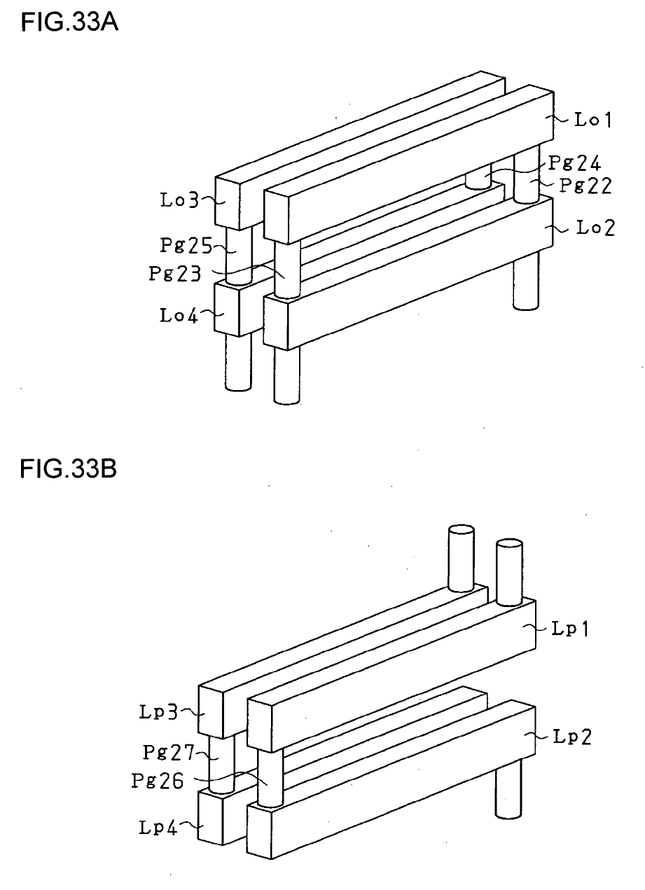

(8) An integrated circuit, serving as one arrangement, having a multi-layer wiring structure formed on a substrate, comprises a first wiring structure formed of wiring patterns which are provided to multiple wiring layers, and which are connected in parallel with each other through via holes. This integrated circuit further comprises a second wiring structure formed of wiring patterns which are provided to the same multiple wiring layers as with the first wiring structure, and which are connected in parallel with each other through via holes. Each wiring pattern of the first wiring structure and the corresponding wiring pattern of the second wiring structure are provided adjacent one another in parallel with each other in the same wiring layer. FIG. 33A illustrates an example of this arrangement.

According to this integrated circuit, the wiring resistance can be reduced as compared with cases wherein the first and second wiring patterns are single lines. Further, the first and second wiring patterns are formed adjacent one another in parallel with each other in each wiring layer, so capacitance between the wiring patterns can be made to be greater as compared with a case of forming the wiring patterns in a single wiring layer.

Further, preferably, no wiring pattern for transmitting other signals is disposed between the wiring patterns making up the first wiring pattern and the second wiring pattern. This suitably avoids and suppresses electrical interference between the first wiring pattern and the second wiring pattern with wiring patterns for transmission of other signals.

Also, the wiring layers where the first wiring pattern and the second wiring pattern are disposed may be mutually adjacent wiring layers. Laying the wiring layers out adjacently enables electrical inference with other wiring patterns, which occurs in arrangements wherein a wiring pattern is provided at an intermediate layer, to be avoided and suppressed.

(9) An integrated circuit, serving as one arrangement, having a multi-layer wiring structure formed on a substrate, comprises: a first wiring structure formed of wiring patterns which are provided to a plurality of wiring layers such that the images thereof projected onto the substrate overlay or overlap one another, and which are electrically connected in serial with each other through via holes; and a second wiring structure formed of wiring patterns which are provided to the same plurality of wiring layers such that the images thereof projected onto the substrate overlay or overlap one another, and which are electrically connected in serial with each other through via holes. Each wiring pattern of the first wiring structure and the corresponding wiring pattern of the second wiring structure may be provided adjacent one another in parallel with each other in the same wiring layer. FIG. 33B illustrates an example of this arrangement.

According to this integrated circuit, the resistance of the first and second wiring patterns can be increased without increasing the layout area of the wiring patterns. Further, the first and second wiring patterns are formed mutually adjacent in each wiring layer, so the capacitance between the wiring patterns can be increased as compared with cases wherein the wiring patterns are formed as wiring patterns in a single wiring layer.

Further, preferably, no wiring pattern for transmitting other signals is disposed between the wiring patterns making up the first wiring pattern and the second wiring pattern. This suitably avoids and suppresses electrical interference between the first wiring pattern and the second wiring pattern with wiring patterns for transmission of other signals.

Also, the wiring layers where the first wiring pattern and the second wiring pattern are disposed may be mutually adjacent wiring layers. Laying the wiring layers out adjacently enables electrical inference with other wiring patterns, which occurs in arrangements wherein a wiring pattern is provided at an intermediate layer, to be avoided and suppressed.

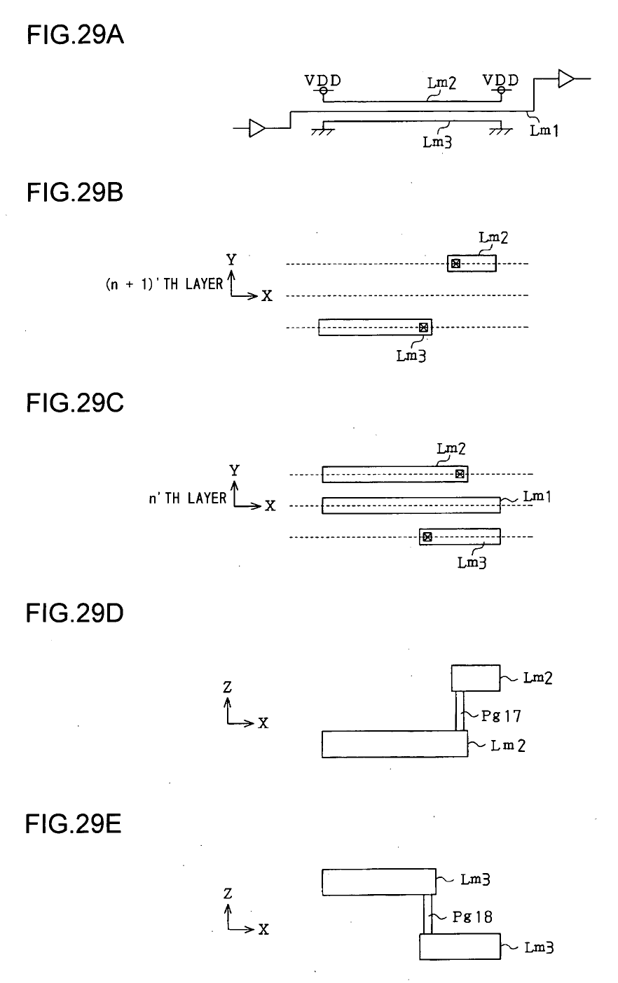

(10) An integrated circuit, serving as one arrangement, having a multi-layer wiring structure formed on a substrate, comprises: a signal-transmission wiring pattern for transmitting a signal; and multiple fixed-electric-potential wiring patterns fixed to different electric potentials. The signal-transmission wiring pattern and the multiple fixed-electric-potential wiring patterns are provided to multiple wiring layers. One of these wiring patterns is provided so as to shift from one wiring layer to another. With such an arrangement, the signal-transmission wiring pattern and the multiple fixed-electric-potential wiring patterns are provided such that the images thereof projected to the substrate are adjacent to one another. FIGS. 29A through 32D illustrate an example of this arrangement.

The signal-transmission wiring pattern and the multiple fixed-electric-potential wiring patterns are arranged such that, at portions where these wiring patterns could be disposed adjacently, a part of one wiring pattern is disposed at a wiring layer other than the wiring layer where the other wiring patterns are disposed. With such an arrangement, while the images of the signal-transmission wiring pattern and the multiple fixed-electric-potential wiring patterns projected to the substrate are adjacent to one another, these wiring patterns are arranged at a different pitch in each wiring layer as compared with an arrangement in which these wiring patterns are provided adjacent to one another in a single wiring layer.

According to this integrated circuit, the length over which the signal-transmission wiring pattern and the fixed-electric-potential wiring pattern are adjacent is changed, whereby the capacitance between these wiring patterns can be adjusted, and the signal transmission speed over the signal transmission wiring pattern can be adjusted. Additionally, the ratio of the length over which the signal-transmission wiring pattern is adjacent to each of the fixed-electric-potential wiring patterns each of which are fixed to different potentials can be used to change the waveform of the signals transmitted over the signal-transmission wiring pattern.

(11) An integrated circuit, serving as one arrangement, has a multi-layer wiring structure formed on a substrate, comprising a region having multiple wiring layers in which wiring patterns are provided so as to extend in generally the same direction at a pitch of an integer multiple of a predetermined unit pitch. The region of this integrated circuit comprises an integrated circuit according to at least one of the integrated circuits described in (3) through (10) above, formed therein.

According to this integrated circuit, a region is provided wherein the direction and pitch of wiring patterns in adjacent wiring layers are unified, thereby allowing the semiconductor integrated circuit according to each of the above-described arrangements to be easily formed. Further, the pitch of wiring patterns is an integer multiple of a predetermined unit pitch, thereby enabling design to be easily performed with an automatic wiring tool.

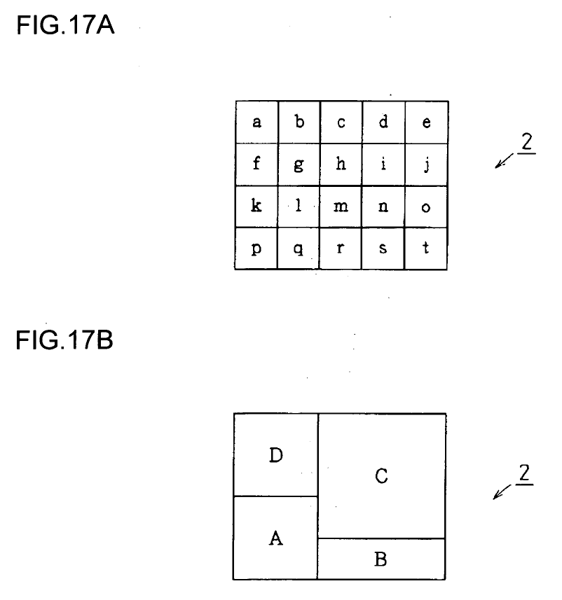

(12) Also, with this integrated circuit, the wiring patterns may be provided so as to extend in different directions in at least one wiring layer between adjacent regions. FIGS. 17A and 17B illustrate one example of this arrangement.

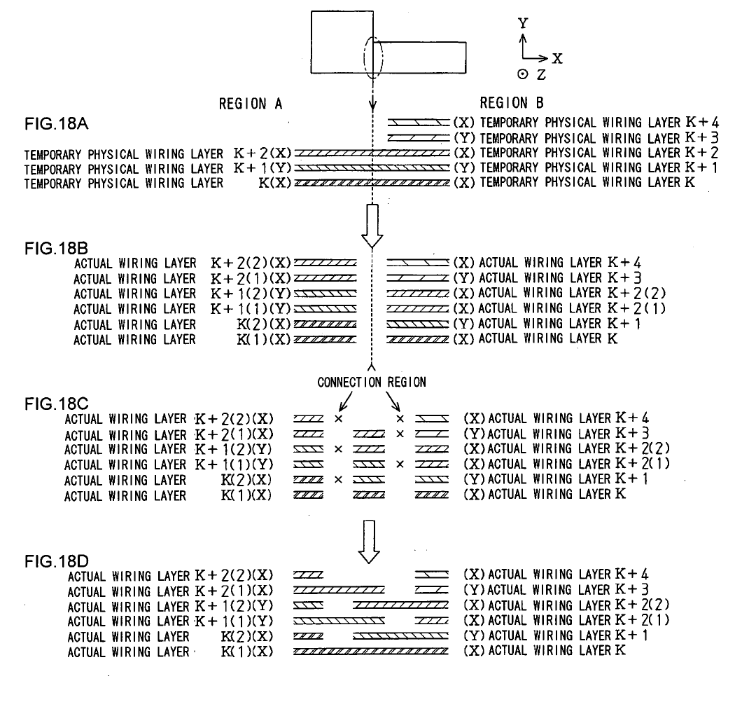

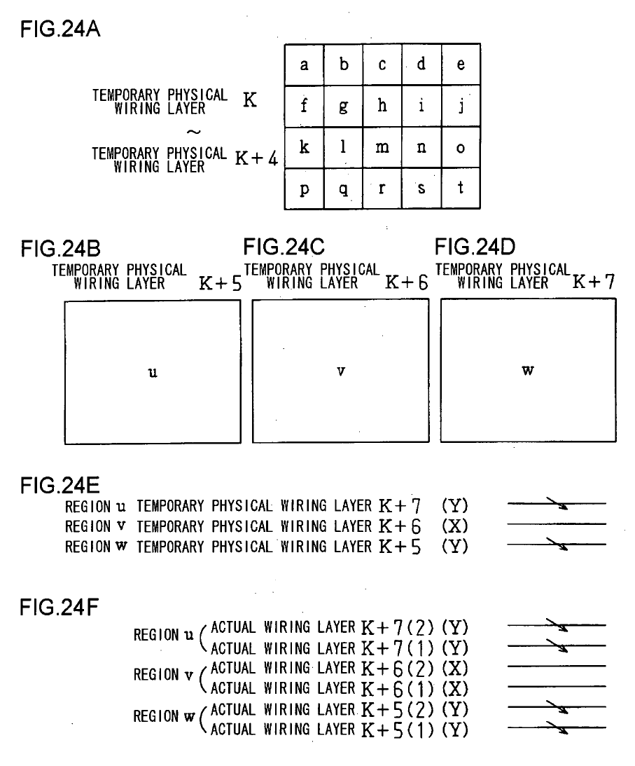

(13) Further, the adjacent regions, having at least one wiring layer where the wiring patterns are provided, in different manners one from another, may be electrically connected using a wiring pattern provided in a wiring layer other than the one wiring layer, in which the image thereof projected to the substrate forms a single line across the boundary between the adjacent regions. That is to say, near the boundary of regions where wiring patterns are provided in different manners in the same wiring layer, the wiring patterns switch to wiring patterns in other wiring layers so as to form a wiring pattern on a single line through the other wiring layer, thereby connecting the regions on a horizontal plane which have wiring patterns provided in different manners. FIGS. 18A through 18D and 24A through 24F illustrate an example of this arrangement.

According to this integrated circuit, near the boundary of regions where wiring patterns are provided in different manners in the same wiring layer, a wiring pattern is switched to a wiring pattern in another wiring layer so as to be formed as a single light through another wiring layer, so connection can be performed without detouring on the horizontal plane, and accordingly complicated search processing for finding a connection path comprising a detour on the horizontal plane becomes unnecessary, and moreover, the path length necessary for the connection can be suitably suppressed.

Other embodiments of the present invention relate to a design method for an integrated circuit. The following is a description of the overview of this integrated circuit design method.

(14) With a design method for an integrated circuit, serving as one arrangement, wiring layers of the integrated circuit, in which layout has been designed, are set to temporary physical wiring layers, calculation means perform conversion of predetermined one or more of the temporary physical wiring layers in at least one region, and with the conversion, the calculation means convert each predetermined temporary physical wiring layer into wiring patterns of multiple actual wiring layers such that the images thereof projected onto the substrate generally match one another, thereby enabling adjustment of circuit properties of the wiring pattern thereof to desired circuit properties.

With the above design method, in at least one region including at least one actual wiring layer, the wiring pattern of the temporary physical wiring layer are converted into the wiring patterns of multiple actual wiring layers generally in a mirror image relation therebetween. Accordingly, circuit properties (properties such as wiring pattern properties, capacitance between wiring patterns, and so forth) can be realized which were impossible to realize with conventional wiring techniques that do not use such a wiring pattern formation technique employing conversion can be realized. Accordingly, circuit property adjustment can be easily performed.

Further, wiring pattern conversion is performed at this time based on the wiring pattern paths of each wiring pattern in the temporary physical wiring layers, so such circuit property adjustment can be performed without performing correction to electrical connection arrangements in wiring patterns on the same physical wiring layer.

Note that the phrase “projected onto the substrate generally match one another” is not necessarily restrictive to a region of projection in the normal line direction as to the temporary physical wiring layer, and also includes regions in contact with such a region. Also, the phrase “an integrated circuit . . . , in which layout has been designed” means an integrated circuit having layout data and mask data with each part being connected.

(15) With a design method for an integrated circuit, serving as one arrangement, for determining a wiring path connecting each element of the integrated circuit, wiring layers for the connection are set to temporary physical wiring layers, conversion of predetermined one or more temporary physical wiring layers in at least one region is performed, and with the conversion, each predetermined temporary physical wiring layer is converted into wiring patterns of multiple actual wiring layers such that the images thereof projected onto the substrate generally match one another, the conversion is performed while calculating the circuit properties thereof, and the optimum wiring path on the temporary physical wiring layer is calculated based upon the calculation results thus obtained.

According to this design method, at the time of providing temporary wiring patterns by automatic wiring layout or the like, temporary wiring patterns can be provided in an arrangement which would have been impossible to realize without conversion using a greater number of wiring layers. Consequently, the degree of freedom in selection of wiring layers can be improved, and the computation load of determining the routing of temporary wiring patterns by automatic wiring layout can be reduced. Also, conversion to the wiring patterns on actual wiring layers based on the temporary wiring patterns thus determined enables wiring patterns having desired circuit properties to be easily designed, and property adjustment of the overall circuit can be easily performed. Further, with wiring patterns converted in this way, projection of images of the wiring patterns onto the substrate either match or are in close proximity, so wiring patterns with a high-density projection can be formed.

(16) With a design method for an integrated circuit, serving as one arrangement, for automatically determining the layout of circuit elements of the integrated circuit, wiring layers for connecting any portion of the integrated circuit are set to temporary physical wiring layers, conversion of predetermined one or more temporary physical wiring layers in at least one region is performed, and with the conversion, each predetermined temporary physical wiring layer is converted into wiring patterns of multiple actual wiring layers such that the images thereof projected onto the substrate generally match one another, the conversion is performed while calculating the circuit properties thereof, and the optimum layout of the circuit elements is designed based upon the calculation results thus obtained.

According to this design method, circuit properties can be realized which were impossible to realize with conventional techniques, i.e., forming wiring patterns with just temporary physical wiring layer wiring patterns. Accordingly, with circuit element layout by automatic placement, circuit properties (properties such as wiring pattern properties, capacitance between wiring patterns, and so forth) which were impossible to realize with wiring techniques that do not assume converting wiring patterns from temporary physical wiring layers into actual wiring layers, thereby improving freedom of placement. Particularly, with conversion of wiring patterns onto actual wiring layers, high density is more readily enabled as compared to before conversion, so according to the above design method, high density of placement of the elements of the integrated circuit can be achieved. At the time of providing the temporary wiring patterns to the temporary physical wiring layers, Steiner routing or the like may be employed as a rough indication for placement, for example.

(17) With a design method for an integrated circuit, serving as one arrangement, for determining the circuit configuration of the integrated circuit, wiring layers for connection necessary for forming the circuit configuration are set to temporary physical wiring layers, conversion of predetermined one or more temporary physical wiring layers in at least one region is performed, and with the conversion, each predetermined temporary physical wiring layer is converted into wiring patterns of multiple actual wiring layers such that the images thereof projected onto the substrate generally match one another, the conversion is performed while calculating the circuit properties thereof, and the optimum circuit configuration is designed based upon the calculation results thus obtained.

The circuit configuration may be optimized by temporary wiring based on the temporary physical wiring layers. In this case, providing of the wiring patterns with various kinds of freedom regarding circuit properties improves the freedom of circuit configuration, and a circuit with excellent performance and can be realized effectively and easily. Optimization of circuit configuration also includes optimization of the properties of the elements making up the circuit, optimization of circuit architecture selection by substitution with functionally equivalent circuits, and so forth.

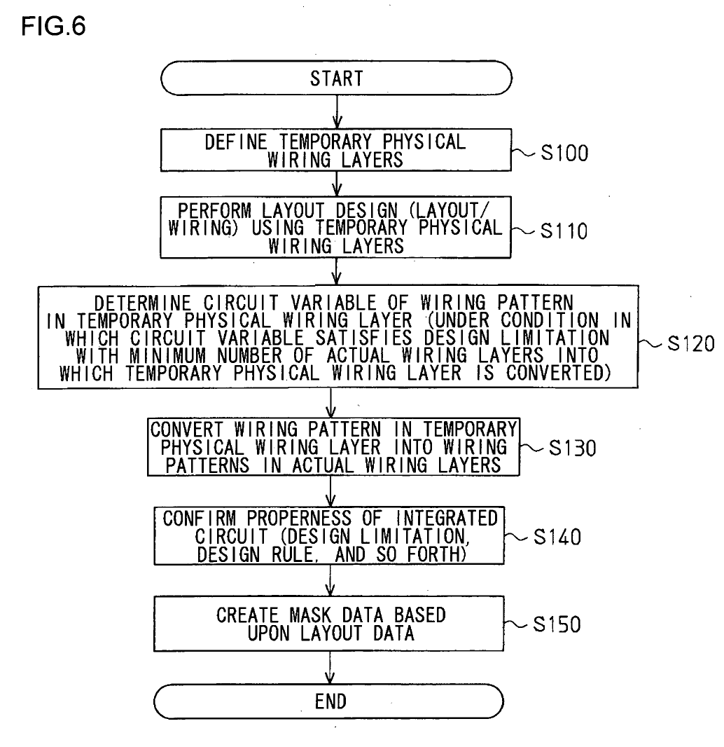

(18) With a design method for an integrated circuit, serving as one arrangement, a temporary wiring pattern, which is used in design in a virtual manner, is provided to each temporary physical wiring layer for connecting circuit device elements in a designed layout to form a circuit block. Computation means determine whether or not the properties of the circuit block, which has been created by connection using the temporary wiring patterns, satisfy desired properties, and the temporary wiring patterns provided to each temporary wiring layer are converted into actual wiring patterns provided to actual wiring layers. An example of this arrangement can be understood from the flowchart shown in FIG. 6.

In the conversion of the temporary wiring pattern into the wiring patterns of the actual wiring layers, the temporary wiring pattern provided to a temporary physical wiring layer may be transferred to multiple corresponding actual wiring layers, and in a case that determination has been made that the properties thus obtained do not satisfy the desired properties in the determination step, the actual wiring patterns in the region where the circuit block has been transferred may be designed again using the wiring patterns of the multiple actual wiring layers such that the circuit block satisfies the desired properties.

The term “conversion” of wiring patterns means transferring temporary wiring patterns on temporary physical wiring layers to actual wiring layers corresponding to the temporary physical wiring layers, and providing the transferred temporary wiring patterns using multiple actual wiring layer. Further, “transfer” means to project temporary wiring patterns of temporary physical wiring layers onto actual wiring layers without any change in the arrangement thereof, but not all transferred wiring patterns need to have the same arrangement as the original temporary wiring patterns on the temporary physical wiring layers. That is to say, in the event that the integrated circuit is divided into several blocks for each function or section, having the same arrangement of wiring patterns corresponding to each block is sufficient.

In the event that the actual wiring patterns realized by transfer from the temporary wiring patterns needs re-designing, transferring can be performed again using the actual wiring layer where the actual wiring pattern has been provided and also the actual wiring layer adjacent thereto, so as to provide wiring patterns generally the same as those of the temporary wiring patterns onto the temporary physical wiring layers. In this case, wiring patterns are formed which are generally the same on adjacent actual wiring layers, so the wiring patterns on adjacent wiring layers can be easily connected by via holes in various manners, such as serially, in parallel, and so forth.

According to this design method, circuit properties (properties such as wiring pattern properties, capacitance between wiring patterns, and so forth) can be realized which were impossible to realize with conventional techniques, i.e., forming wiring patterns with just temporary physical wiring layer wiring patterns, and adjustment of circuit properties can be easily performed. That is to say, the actual wiring patterns transferred onto the actual wiring layers can be realized as an arrangement using multiple actual wiring patterns, and accordingly can be formed as wiring patterns with more varied freedom with regard to circuit properties as compared with a wiring pattern arrangement on a single actual wiring layer.

Further, wiring pattern conversion is performed at this time based on the wiring pattern paths of temporary wiring patterns on the temporary physical wiring layers, so such circuit property adjustment can be performed without performing correction to electrical connection arrangements in wiring patterns on the original physical wiring layer.

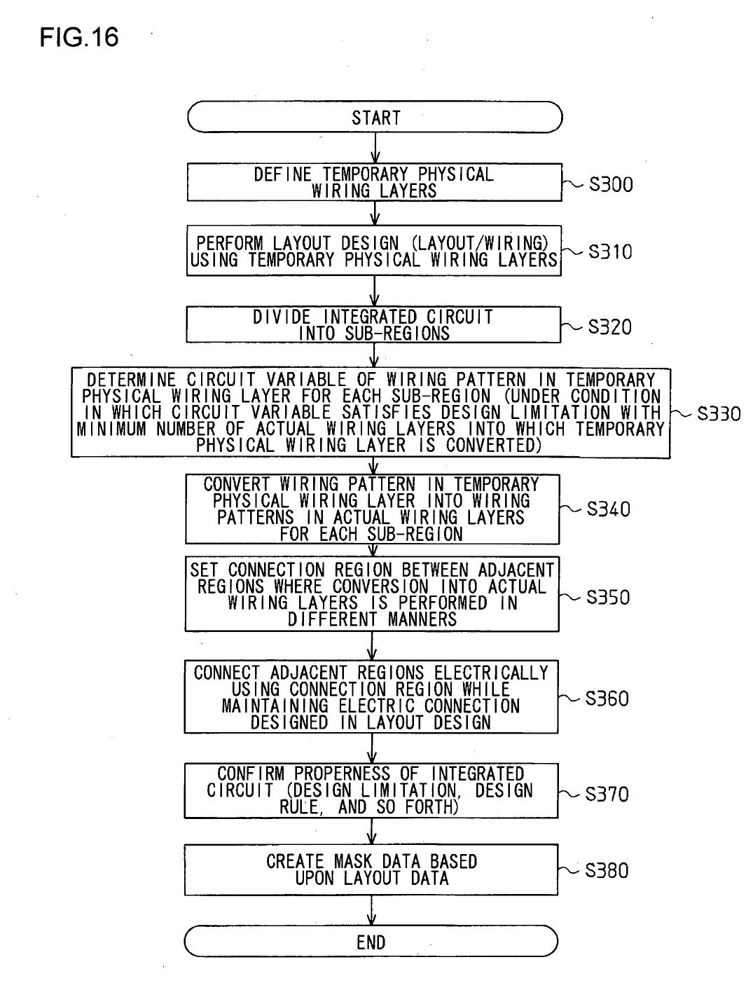

(19) With this design method for an integrated circuit, the integrated circuit may be divided into multiple sub-regions, and the wiring pattern of the temporary wiring layer may be converted into the wiring patterns of the actual wiring layers in a different manner for each sub-region thus divided. An example of this arrangement can be understood from FIGS. 16, 17A, and 17B.

With this design method, wiring patterns are converted from the temporary physical wiring layers to actual wiring layers for each sub-region, so the desired circuit properties can be efficiently realized. That is to say, wiring patterns are not necessarily provided uniformly over all regions of each of the wiring layers in the layout design, and there are often regions where no wiring pattern is provided. Accordingly, the present design methods performs the above conversion in increments of sub-regions, wherein, the more temporary physical wiring layers with no wiring patterns provided a sub-region contains, the more actual wiring layers, which are used for conversion from a temporary physical wiring layer, are provided thereto, thereby suitably suppressing increase in the final number of wiring layers of the integrated circuit.

(20) Also, with this design method, in the event that the wiring pattern of the temporary wiring layer is converted into the wiring patterns of the actual wiring layers in a different manner for each sub-region thus divided, wiring patterns for connection across adjacent sub-regions may be provided around the boundary of sub-regions while maintaining the connection state designed on the temporary wiring layers, using computation means for conversion from temporary physical wiring layers around the boundary of sub-regions. An example of this arrangement can be understood from FIGS. 16, and 17A through 18D.

That is to say, with the present arrangement, the entire region is divided into sub-regions. Then, the wiring pattern of the temporary physical wiring layer is converted into the wiring patterns of the actual wiring layers in different manner for each sub-region. As a result, in some cases, the actual wiring layers are provided to regions adjacent to one another in different manners. With the present arrangement, a wiring pattern for connecting these adjacent sub-regions may be provided in the form of an actual wiring pattern across the adjacent sub-regions. Such an actual wiring pattern may be created using the computation means by converting the wiring pattern of the temporary physical wiring layer into the wiring patterns of the multiple actual wiring layers while maintaining the connection state designed on the temporary physical wiring layers.

After performing the above conversion in increments of sub-regions in the above-described arrangements, the arrangement of conversion into actual wiring patterns on multiple actual wiring layers may not always be the same between adjacent sub-regions. For example, there are cases wherein the direction in which the wiring patterns are provided differs between the adjacent sub-regions. With such portions, direct connection of the wiring patterns between sub-regions may be difficult in some cases. With the present arrangement, a wiring pattern of the actual wiring layer is provided across these adjacent sub-regions in order to maintain the connection state designed on the temporary physical wiring layers in these adjacent sub-regions. Specifically, the wiring pattern for connection of the adjacent sub-regions is provided so as to shift from one actual wiring layer to another, thereby enabling suitable connection between these adjacent sub-regions.

One arrangement of the present invention relates to an integrated circuit having a multi-layer wiring structure formed on a substrate, and a feature thereof is the manner in which the wiring pattern is provided to the multi-layer wiring layers. These features are as follows.

A pitch is determined beforehand for each wiring layer. Providing of wiring patterns to the wiring layer is performed such that the pitch of the wiring patterns is an integer multiple of a predetermined unit pitch. Accordingly, the wiring patterns are provided so as to extend in generally the same direction in parallel within one wiring layer. Further, adjacent wiring layers are also provided with a region wherein the direction in which the wiring patterns extend is the same. The first wiring pattern is disposed in one of the adjacent wiring layers set to such conditions, and the second wiring pattern is provided to the other wiring layer. With this integrated circuit, the electric properties of the wiring patterns are adjusted by providing the wiring components in various arrangements.

The following is examples of arrangements of the integrated circuit configured using such wiring patterns, and the design method thereof.

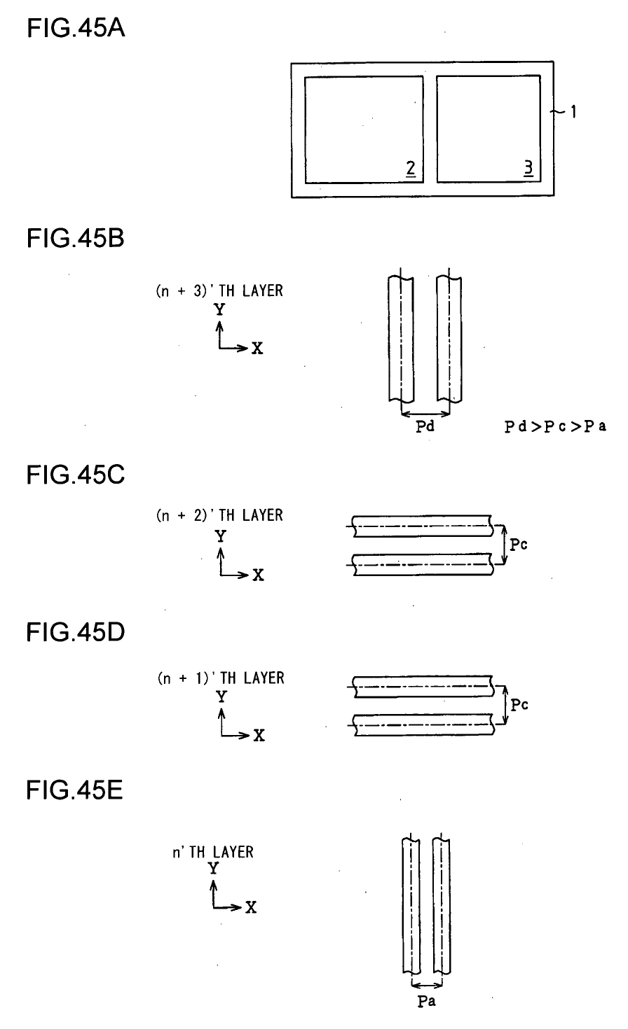

(21) An integrated circuit, serving as one arrangement, has a multi-layer wiring structure formed on a substrate having a region comprising wiring layers where multiple wiring patterns are provided so as to extend in parallel with each other such that the pitch between the adjacent wiring patterns is a pitch of an integer multiple of a unit pitch determined beforehand for each wiring layer. With this integrated circuit, the region may include at least a pair of adjacent wiring layers having wiring patterns provided so as to extend in the same direction. FIGS. 45A through 45E illustrate an example of this arrangement.

This integrated circuit has adjacent wiring layers having wiring patterns provided so as to extend in the same direction. Accordingly, generally the same wiring pitch may be set for these adjacent wiring layers without particular difficulty. Accordingly, electrical connection of the adjacent wiring layers can be easily performed.

Also, designing the wiring layers adjacent to each other can avoid and suppress electrical interference between the wiring patterns thereof and other wiring patterns, as compared to arrangements having an intermediate layer introduced therebetween. Accordingly, problems owing to reduction of size to minute dimensions can be easily dealt with, and design can be performed more efficiently.

Also, the regions have the wiring patterns provided thereto at a pitch of an integer multiple of a unit pitch, so connection in designing of the integrated circuit can be easily designed following a regular pattern. Accordingly, in cases of using automatic layout wiring tools to connect the regions in particular, programming of the tool can be simplified, and processing for connection with the tool can also be simplified.

Note that of the integrated circuit, a logic circuit is preferably formed at this region. Memory, analog circuits, I/O (input/output) circuits, etc., may be formed at other regions of the integrated circuit.

(22) With this integrated circuit, the unit pitch determined beforehand for each wiring layer may be set to generally the same pitch for each of the adjacent wiring layers forming a pair. FIGS. 45A through 45E illustrate an example of this arrangement.

According to this integrated circuit, electrical connection and the like of wiring patterns between wiring layers can be easily performed, since the unit pitch is generally the same in the adjacent wiring layers.

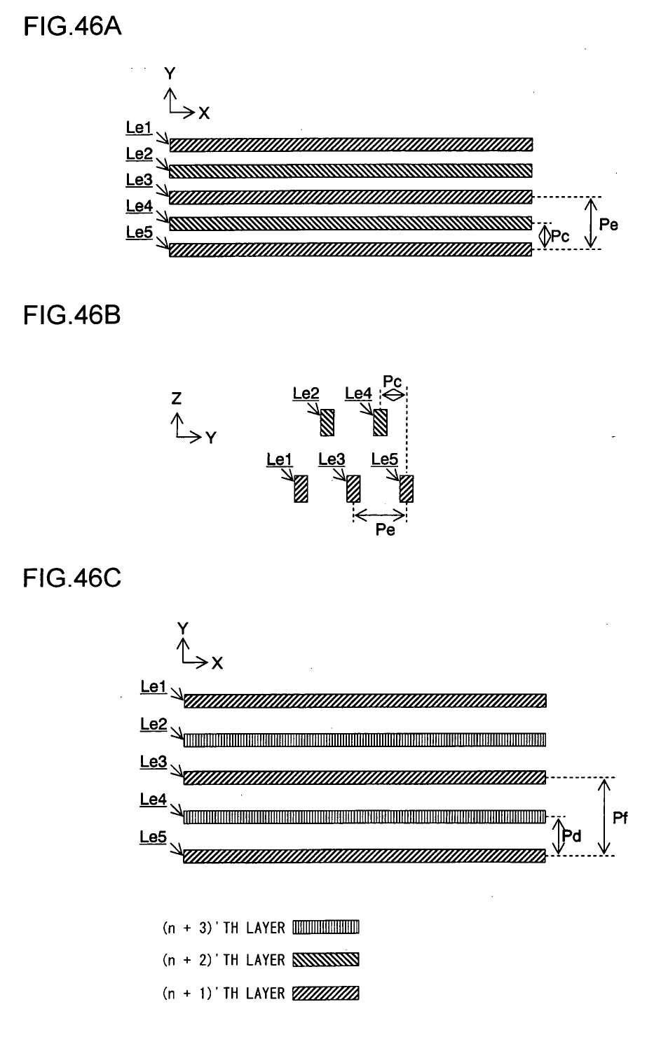

(23) With this integrated circuit, the adjacent wiring layers forming a pair may include multiple wiring patterns provided at intervals twice or more the unit pitch, and the multiple wiring patterns may be provided to the pair of adjacent wiring layers in an offset manner such that the images thereof projected to the substrate do not overlay or overlap one another. FIGS. 46A through 46C illustrate an example of this arrangement.

This means a case such as the wiring patterns of two adjacent layers provided at a, pitch twice the unit pitch being offset by an amount equivalent to the unit pitch, for example. According to this integrated circuit, the interval between adjacent wiring patterns can be increased within the same wiring layer, so capacitance between adjacent wiring patterns is smaller, and cross-talk noise can be suppressed. Also, looking at the wiring pattern on one of the wiring layers, there is no wiring pattern in the wiring layer above or below, so direct connection can be made with a wiring pattern two layers above or two layers below, through a via hole. This allows the time and load necessary for calculating connection paths with the automatic wiring tool to be alleviated.

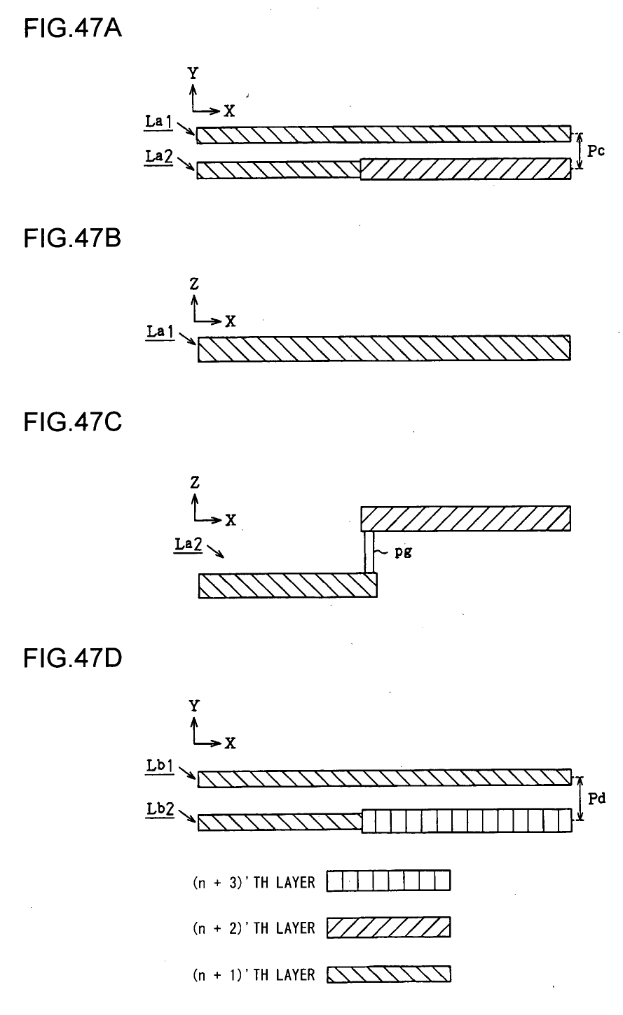

(24) With this integrated circuit, one or the other of the adjacent wiring layers forming a pair includes two wiring pattern adjacent to one another. One or the other of the two adjacent wiring patterns is provided so as to shift to the other of the two adjacent wiring layers, thereby increasing the distance between the two adjacent wiring patterns. FIGS. 47A through 47D illustrate an example of this arrangement.

According to this integrated circuit, portions where the pair of wiring patterns are mutually adjacent in the same wiring layer can be minimized, and the capacitance between this pair of wiring patterns can be suitably reduced. Also, designing the wiring layers adjacently enables electrical interference between the wiring patterns thereof and other wiring patterns to be avoided and suppressed as having an intermediate wiring layer introduced the rebetween.

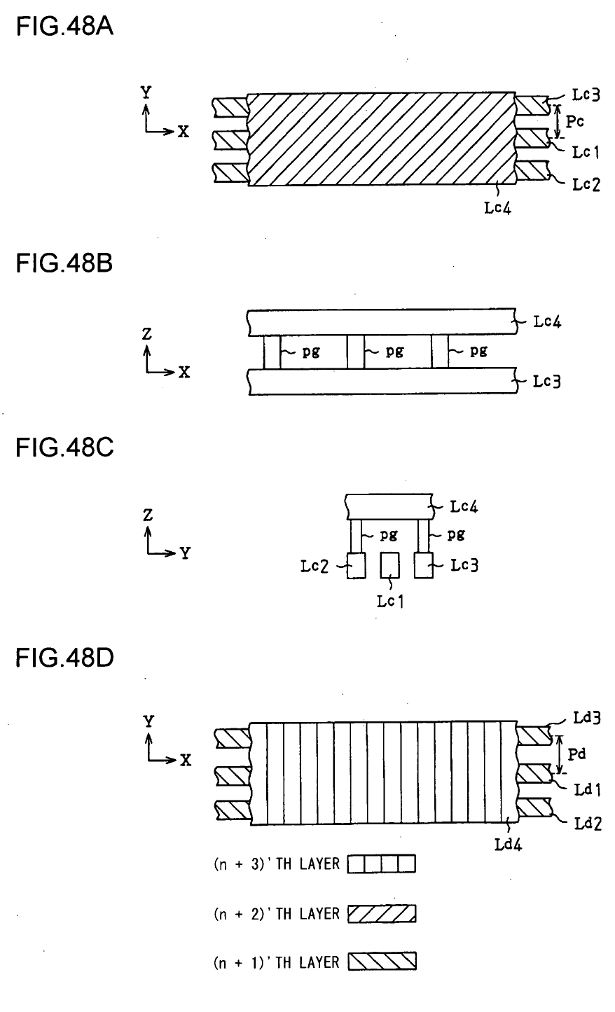

(25) With this integrated circuit, one of the adjacent wiring layers forming a pair includes a signal-transmission wiring pattern and a first wiring structure to be fixed to a certain electric potential, provided adjacent to one another, and the other wiring layer includes a second wiring structure to be fixed to a certain electric potential, which is provided over a region including the image of the signal-transmission wiring layer projected to the other wiring layer, wherein the first and second wiring structures are electrically connected so as to form a shielding wiring structure for shielding the signal-transmission wiring pattern. FIGS. 48A through 48D illustrate an example of this arrangement.

According to this integrated circuit, the signal-transmission wiring pattern and the shielding wiring structure are adjacent, and no other wiring patterns are provided on an intermediate wiring layer therebetween, so there is no major loss of wiring pattern resource, and a shielding wiring structure can be configured, thereby easily and effectively dealing with crosstalk and electromagnetic interference (EMI).

(26) An integrated circuit, serving as one arrangement, has a multi-layer wiring structure formed on a substrate, wherein one of adjacent wiring layers forming a pair includes a signal-transmission wiring pattern and a first wiring structure to be fixed to a certain electric potential, which are provided in parallel with each other and adjacent to one another. The other wiring layer includes a second wiring structure to be fixed to a certain electric potential, which is provided over a region including the image of the signal-transmission wiring pattern projected to the other wiring layer, wherein the first and second wiring structures are electrically connected so as to form a shielding wiring structure for shielding the signal-transmission wiring pattern. FIGS. 48A through 48D illustrate an example of this arrangement.

According to this integrated circuit, the signal-transmission wiring pattern and the shielding wiring structure are adjacent, and no other wiring patterns are provided on an intermediate wiring layer therebetween, so there is no major loss of wiring pattern resource, and a shielding wiring structure can be configured, thereby easily and effectively dealing with crosstalk and electromagnetic interference (EMI).

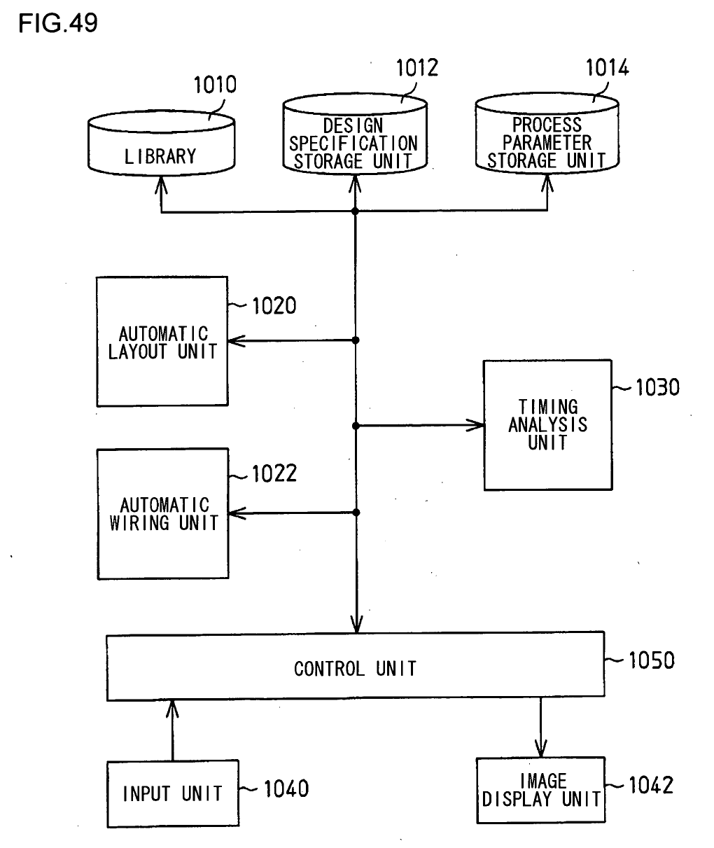

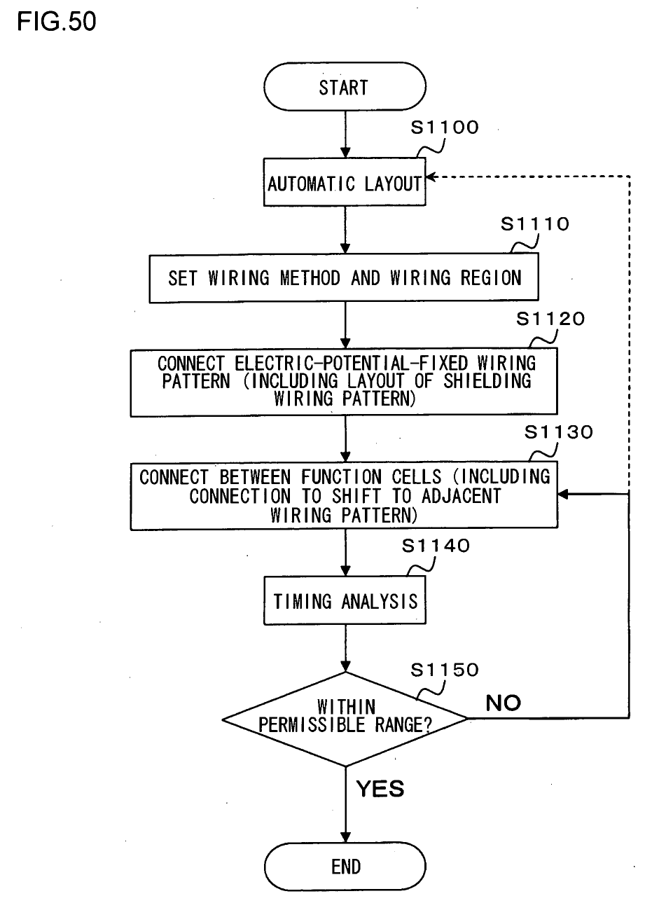

(27) A design method serving as one arrangement for an integrated circuit having a multi-layer wiring structure formed on a substrate, includes a step for providing wiring patterns to multiple wiring layers using an automatic wiring tool so as to connect circuit elements after layout thereof. The automatic wiring tool sets a particular region where wiring patterns are provided in the same direction over adjacent wiring layers, and wiring patterns are provided to the adjacent wiring layers within the region thus set, with intervals of an integer multiple of a predetermined unit pitch. FIGS. 49 and 50 illustrate an example of this arrangement.

According to this design method, a pair of adjacent wiring layers where the wiring patterns are to be provided so as to extend in the same direction is set before wiring connection. Such an arrangement has the advantage as follows. With such an arrangement, generally the same unit pitch can be set for the adjacent wiring layers without particular difficulty. The wiring patterns are provided in parallel with each other at a pitch, which is the interval between center lines of the line width of the wiring patterns provided in parallel, of the integer multiple of the predetermined unit pitch. Thus, electrical connection of the adjacent wiring layers can be easily performed. Also, designing the wiring layers adjacent to each other can avoid and suppress electrical interference between the electrical connection of the wiring patterns thereof and other wiring patterns, unlike an arrangement having an intermediate wiring layer introduced between the aforementioned wiring layers forming a pair. Accordingly, problems owing to reduction of size to minute dimensions can be easily dealt with, and design can be performed more efficiently.

(28) With this design method for an integrated circuit, the automatic wiring tool may provide wring patterns to one of the adjacent wiring layers within the particular region thus set, with a smaller offset in the direction orthogonal to the wiring-extending direction than the interval at which the wiring patterns are provided in the same wiring layer. FIGS. 46A through 46C illustrate an example of this arrangement.

According to this design method, the interval between adjacent wiring patterns in the same wiring layer can be made greater, so capacitance between the adjacent wiring patterns is reduced, and crosstalk noise can be suppressed. Also, looking at the wiring pattern on one of the wiring layers, there is no wiring pattern in the wiring layer above or below, so direct connection can be made with a wiring pattern two layers above or two layers below, through a via hole. This allows the time and load necessary for calculating connection paths with the automatic wiring tool to be alleviated.

(29) With this design method for an integrated circuit, the automatic wiring tool may set a region, where wiring patterns are to be provided so as to extend in the same direction in adjacent wiring layers.

According to this design method, a region is provided where wiring patterns are provided so as to extend in the same direction in adjacent wiring layers. With such an arrangement, generally the same unit pitch can be set for the adjacent wiring layers without particular difficulty. Thus, electrical connection of adjacent wiring layers can be easily performed. Also, designing the wiring layers adjacently enables electrical interference between the wiring patterns thereof and other wiring patterns to be avoided and suppressed as compared to arrangements having an intermediate layer introduced between the aforementioned wiring layers forming a pair. Accordingly, adjustment of the electric properties can be easily performed for the wiring pattern that requires adjustment of the electric properties thereof, and designing can be performed more effectively.

(30) With this design method for an integrated circuit, wherein, in the event of providing a signal-transmission wiring pattern regarding which the electrical property of reduced noise is required to the region, the automatic wiring tool provides a signal-transmission wiring pattern to one wiring layer within the particular region, and further provides a wiring pattern to be fixed to a certain electric potential serving as a shielding wiring pattern, to another wiring layer adjacent to the one wiring layer, in a manner such that the image of the signal-transmission wiring pattern projected to the other wiring layer is included in the wiring pattern serving as a shielding wiring pattern. FIGS. 48A through 48D illustrate an example of this arrangement.

According to this design method, the signal-transmission wiring pattern and the shielding wiring structure are adjacent, so interference with wiring patterns of other wiring layers can be reduced. Accordingly, there is no major loss of wiring pattern resource, and a shielding wiring structure can be configured, thereby easily and effectively dealing with crosstalk and electromagnetic interference (EMI).

It should be noted that all arbitrary combinations of the above components, and arrangements obtained by rereading the expressions of the present invention among method, device, system, and so forth, are valid arrangements of the present invention. More specifically, these integrated circuits are realized by the embodiments described below.

### First Embodiment

Description will be made below regarding a semiconductor integrated circuit and a design method thereof according to a first embodiment of the present invention with reference to the drawings.

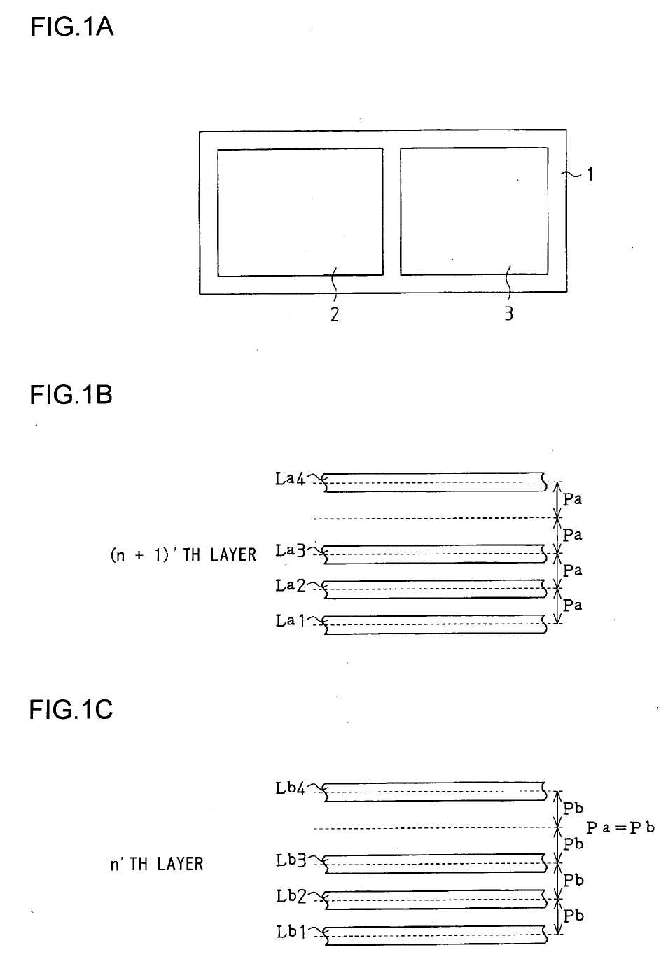

FIGS. 1A through 1C shows a structure of a semiconductor integrated circuit according to the present embodiment. A semiconductor integrated circuit 1 shown in FIG. 1A includes a logic circuit unit 2 and an analog circuit unit 3. With the present embodiment, the logic circuit unit 2 is designed using an automatic layout wiring tool.

First, description will be made regarding a structure of a wiring layer of a semiconductor integrated circuit according to the present invention. The automatic wiring tool provides wiring along a predetermined grid pattern. Accordingly, in general, the wiring pitch thus provided corresponds to the grid pitch. FIG. 1B shows a wiring pattern of the (n+1)'th wiring layer of the logic circuit unit 2. FIG. 1C shows a wiring pattern of the n'th wiring layer of the logic circuit unit 2. As shown in FIG. 1B, the wiring patterns of the (N+1)'th wiring layer are provided in parallel with each other, at a pitch of an integer multiple of a predetermined unit pitch Pa. Furthermore, as shown in FIG. 1C, the wiring patterns of the n'th wiring layer are provided in parallel with each other, at a pitch of an integer multiple of a predetermined unit pitch Pb.

Specifically, in the (N+1)'th wiring layer, for example, the wiring patterns La1, La2, and La3, are provided at the same pitch as the unit pitch Pa. Furthermore, the wiring patterns La3 and La4 are provided with an interval of twice the unit pitch Pa.

Furthermore, the adjacent wiring layers, i.e., the (n+1)'th wiring layer and the n'th wiring layer include the wiring patterns provided in the same direction (i.e., in a case that the wiring patterns serve as signal lines, the signals are transmitted in the same direction). Furthermore, the adjacent wiring layers, i.e., the (n+1)'th wiring layer and the n'th wiring layer include the wiring patterns provided with the same unit pitch (i.e., the aforementioned unit pitch Pa is the same as the unit pitch Pb). Furthermore, the adjacent wiring layers, i.e., the (n+1)'th wiring layer and the n'th wiring layer include the wiring patterns provided such that the image projected from the wiring pattern of one wiring layer onto the other wiring layer matches the wiring-pattern image of the other wiring layer. Specifically, let us say that the wiring pattern La4 of the (n+1)'th wiring layer is perpendicularly projected onto the n'th wiring layer. In this case, the projected image of the wiring pattern La4 of the (n+1)'th wiring layer matches the wiring pattern Lb4 of n'th wiring layer.

With the semiconductor integrated circuit according to the present embodiment, any one of the wiring structures shown in FIGS. 2A through 4E is formed using the adjacent wiring layers, i.e., the (n+1)'th wiring layer and the n'th wiring layer, thereby enabling adjustment of the electric properties of the wiring.

Description will be made below with reference to FIGS. 2A through 2D. FIGS. 2A and 2B show the wiring patterns La4 and Lb4 shown in FIGS. 1B and 1B, for example. Here, the face of each wiring layer is a plane defined by x and y axes. Furthermore, the wiring patterns are provided so as to extend in the x direction. FIG. 2C shows that each wiring pattern La4 of the (n+1)'th wiring layer and the corresponding wiring pattern Lb4 of the n'th wiring layer have a mirror image relation therebetween. Furthermore, as shown in FIG. 2D, these wiring patterns La4 and Lb4 are electrically connected with each other at multiple positions (B1 and B2) through plugs pg1 and pg2 formed within the via holes.

Furthermore, two portions P1 and P2 are provided in the (n−1)'th wiring layer. With such an arrangement, a signal is transmitted from one of these portions P1 and P2 to the other through the wiring patterns La4 and Lb4 electrically connected in parallel with each other. Specifically, a signal is transmitted between: the portion P1 which is a connection portion where a wiring pattern Lc1 of the (n−1)'th wiring layer and the wiring pattern Lb4 are connected with each other through a plug pg3; and the portion P2 which is a connection portion where a wiring pattern Lc2 of the (n−1)'th wiring layer and the wiring pattern Lb4 are connected with each other through a plug pg4, through both the wiring patterns La4 and Lb4.

Such an arrangement has the advantage of reducing the resistance of wiring without increasing the effective wiring width, i.e., the width of the wiring-pattern image perpendicularly projected onto the substrate of the integrated circuit. Specifically, such an arrangement in which the wiring patterns are provided in parallel across the multiple wiring layers increases the overall surface area of the wiring, thereby particularly suppressing an increase in the resistance thereof due to the skin effect. Reduction in the resistance of the wiring can provide a higher-speed integrated circuit, as well as reducing power consumption. Furthermore, such a wiring structure may be applied to a power wiring as a countermeasure against electromigration and IR drop.

Next, description will be made with reference to FIGS. 3A and 3D. FIGS. 3A and 3B show the wiring patterns La3 and Lb3 shown in FIGS. 1B and 1C, for example. Here, the face of each wiring layer is a plane defined by x and y axes. Furthermore, the wiring patterns are provided so as to extend in the x direction. FIG. 3C shows that the wiring pattern La3 of the (n+1)'th wiring layer and the corresponding wiring pattern Lb3 of the n'th wiring layer have a mirror image relation therebetween.

As shown in FIG. 3D, the wiring patterns La3 and Lb3 are connected in serial with each other through a plug pg5 formed within a via hole such that a signal is transmitted therethrough in opposite directions. With such an arrangement, a signal is transmitted in the opposite directions through the wiring patterns connected in serial with each other, thereby enabling the resistance of the wiring to be increased without increasing the effective wiring length (the length of the wiring-pattern image perpendicularly projected onto the substrate of the integrated circuit).

Next, description will be made with reference to FIGS. 4A through 4E. FIGS. 4A and 4B show the wiring patterns La2 and La1 and the wiring patterns Lb2 and Lb1 shown in FIGS. 1B and 1C. Here, the face of each wiring layer is a plane defined by x and y axes. Furthermore, the wiring patterns are provided so as to extend in the x direction. FIG. 4C shows that the wiring pattern La2 and the corresponding wiring pattern Lb2, and the wiring pattern La1 and the corresponding wiring pattern Lb1, have a mirror image relation therebetween.

As shown in FIG. 4D, the wiring patterns La2 provided to the (n+1)'th wiring layer and Lb2 provided to the n'th wiring layer are electrically connected with each other through a plug pg6 formed within a via hole. Furthermore, as shown in FIG. 4E, the wiring patterns La1 provided to the (n+1)'th wiring layer and Lb1 provided to the n'th wiring layer are connected with each other through a plug pg7 formed within a via hole.

Note that either of the wiring patterns La2 or Lb2 serves as a dummy wiring pattern of which one end is opened. The same can be said of the combination of the wiring patterns La1 and Lb1. Specifically, with regard to each of these dummy wiring patterns, while one end thereof is connected to the other wiring pattern plug pg6 or pg7, the other end thereof is opened. Accordingly, even if the other wiring pattern is used for signal transmission, the dummy wiring pattern does not serve as a signal transmission path. Also, even if the other wiring pattern is used for power supply, the dummy wiring pattern does not serve as a power supply path.

Such a structure provides the capacitance due to the wiring patterns Lb2 and Lb1 provided with a layout having a mirror image relation with the layout of the adjacent wiring patterns La2 and La1 provided to the (n+1)'th wiring layer, in addition to the capacitance due to the wiring patterns La2 and La1. This enables the capacitance due to the adjacent wiring patterns to be increased. Furthermore, such a structure allows the capacitance to be increased without reducing the interval between the adjacent wiring patterns, or increasing the wiring-pattern length. Thus, such a structure allows adjustment of the capacitance thereof without involving the limitation of the design rule, as well as without increasing the resistance thereof.

Let us say that these wiring patterns La2 and La1 are used for a line fixed to the power-supply voltage and a grounded line. In this case, such a wiring structure is effective for stabilizing the power supply. Specifically, the aforementioned structure suitably prevents noise from entering the wiring, thereby suitably suppressing electromagnetic interference.

As described above, the wiring structures shown in FIGS. 2A through 4E enable adjustment of the resistance of the wiring pattern and adjustment of the capacitance between the wiring patterns. This allows a designer to easily handle various problems due to the improved fine processing technology without involving development of new materials.

Furthermore, the wiring structures shown in FIGS. 2A through 4E can be easily realized by designing wiring patterns using an automatic wiring tool. Specifically, a wiring pattern (temporary physical wiring layer) in a predetermined format is converted into multiple wiring layers (actual wiring layers) having the same wiring pattern, thereby easily realizing the aforementioned wiring structure. Furthermore, with such a design method, the aforementioned wiring structure allows the designer to perform inverse-conversion of the multiple actual wiring layers into the original signal-layer temporary physical wiring layer. That is to say, the aforementioned wiring structure allows the designer to covert a single wiring layer into multiple actual wiring layers, as well as to convert the multiple actual wiring layers into the single wiring layer. In other words, this wiring structure allows the designer to perform reversible-conversion thereof. In general, the aforementioned conversion and inverse-conversion need to be performed so as to determine the wiring structure with the trial and error method. The wiring structure according to the present embodiment allows the designer to perform inverse-conversion of the multiple wiring layers into the original temporary physical wiring layer without restriction without using history information regarding the relation therebetween before and after conversion.

Detailed description will be made regarding a design procedure for an integrated circuit having such a wiring structure.

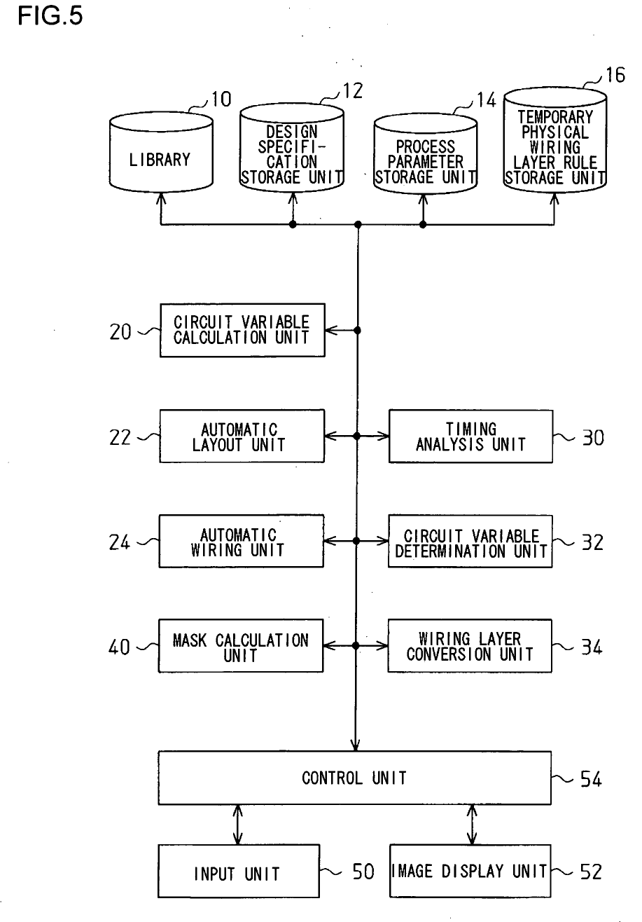

FIG. 5 is a block diagram which shows a configuration of a design support apparatus for an integrated circuit according to the present invention. Note that this design support apparatus has a configuration for supporting layout design using the standard cell method.

First, description will be made regarding the functions of the components forming the design support apparatus.

A library 10 is a unit for storing cell information regarding various kinds of function cells forming an integrated circuit, and performance information regarding these function cells such as delay information regarding these function cells, limitation information regarding setup and hold time, and so forth. Here, examples of the function cells include: logic computation elements (AND, OR, exclusive OR, exclusive-AND, NOT, and so forth), a flip-flop, memory such as RAM and so forth, analog elements such as A/D and so forth, and a circuit formed of these components. Furthermore, the library 10 stores information regarding the layout of the function cells such as information regarding the area thereof, and so forth.

On the other hand, a design specification storage unit 12 stores information regarding the functions and the structure of an integrated circuit described by the hardware description language (HDL), for example. Specifically, the design specification storage unit 12 stores circuit information represented by an RTL (resistor transfer level), a gate level, and so forth, timing information such as the operation frequency and so forth, power-supply information, and so forth. Here, the gate-level circuit information is represented by a net list formed of the information regarding the kinds of cells, the number thereof, and logical connection therebetween. Note that these cells are defined in and selected from the aforementioned library 10.

On the other hand, a process parameter storage unit 14 stores information regarding element properties, the wiring properties for each material, and so forth, corresponding to a specified design rule (rule with respect to the highest processing accuracy, the element size, the minimum wiring interval, and so forth).

A temporary physical wiring layer rule storage unit 16 stores a rule for converting the wiring pattern of a temporary physical wiring layer, in which connection has been made using an automatic wiring tool, into the wiring patterns of the aforementioned actual wiring layers. Specifically, the temporary physical wiring layer rule storage unit 16 stores a rule for converting a predetermined wiring pattern into the wiring patterns having the wiring structure shown in FIGS. 2A-2D and 3A-3D, a rule for converting a pair of adjacent wiring patterns into the wiring patterns having a structure shown in FIG. 4A-4E, and so forth.

Note that the library 10, the design specification storage unit 12, the process parameter storage unit 14, and the temporary physical wiring layer rule storage unit 16 are realized by storage devices such as hard disks and so forth.

On the other hand, a circuit variable calculation unit 20 calculates the circuit variables of the wiring pattern converted based upon the input data received from an output component according to a rule stored in the aforementioned temporary physical wiring layer rule storage unit.

On the other hand, an automatic layout unit 22 and an automatic wiring unit 24, each of which is a component of an automatic layout wiring tool, performs layout design. Specifically, the automatic layout unit 22 performs automatic layout of the aforementioned function cells. The automatic wiring unit 24 makes connection between the function cells thus arranged. The automatic layout of the aforementioned function cells and connection between the function cells thus arranged are performed using layout data corresponding to the function cells stored in the library 10.

The net list of the circuit which represents a wiring path and which has been created by the automatic wiring unit 24 is supplied to a timing analysis unit 30. The net list has a layered structure formed of: a net list which represents the inside of each function block which comprises the function cells; and a net list which represents connection between the function blocks.

The timing analysis unit 30 performs timing analysis based upon the aforementioned net list, the information stored in the process parameter storage unit 14, and the temporary physical wiring layer rule storage unit 16. A circuit variable determination unit 32 determines the circuit variables of the wiring pattern on the temporary physical wiring layer based upon the aforementioned timing analysis. On the other hand, a wiring layer conversion unit 34 converts the temporary physical wiring layer into the actual wiring layers of the integrated circuit based upon the aforementioned circuit variables thus determined.

The mask calculation unit 40 creates data (mask data) which is used for a mask pattern for manufacturing an integrated circuit based upon the data representing the final layout pattern (layout data).

Note that the aforementioned automatic layout unit 22, automatic wiring unit 24, timing analysis unit 30, circuit variable determination unit 32, wiring layer conversion unit 34, mask calculation unit 40 are realized by storage devices such as semiconductor memory, hard disk devices, and so forth, for storing a program for executing the aforementioned processing, and a computer.

On the other hand, an input unit 50 is realized by input devices such as a touch pen, keyboard, mouse, and so forth, which allows the designer to input various information and instructions for layout design. An image display unit 52 visually displays the aforementioned input information, layout view, and so forth. On the other hand, a control unit 54 centrally controls the operation of the image display unit 52, automatic layout unit 22, automatic wiring unit 24, timing analysis unit 30, circuit variable determination unit 32, wiring layer conversion unit 32, mask calculation unit 40, and so forth.

Next, description will be made regarding a design procedure for an integrated circuit according to the present embodiment. Note that the design procedure is performed using the design support apparatus having the aforementioned configuration. FIG. 6 shows a design procedure for an integrated circuit according to the present embodiment.

With a series of processing, first, temporary physical wiring layers are defined in Step S100. Note that automatic layout of cells and automatic connection between these cells thus arranged are performed on each of the temporary physical wiring layers in the following Step. Specifically, the number of the temporary physical wiring layers is determined based upon the limitation and so forth for manufacturing the integrated circuit, received through the aforementioned input unit 50. Note that the number of the wiring layers is determined to be a number equal to or less than the maximum number of the actual wiring layers determined by the aforementioned limitation and so forth for manufacturing.

In the following Step S110, layout design is performed using the temporary physical wiring layer thus defined in the aforementioned Step S100. In this Step, the layout information regarding the function cells stored in the library 10 and the gate-level circuit information stored in the design specification storage unit 12 are input to the automatic layout unit 22. Then, the automatic layout unit 22 performs automatic layout of the function cells based upon the gate-level circuit information. Next, the automatic wiring unit 24 makes connection between the function cells thus arranged based upon the connection information regarding the function cells stored in the design specification storage unit 12.

Then, in Step S120, the circuit variable determination unit 32 determines the circuit variables of the wiring patterns for each connection of the integrated circuit subjected to connection design. In this Step, the circuit variables are determined such that the wiring pattern of each temporary physical wiring layer is converted into the smallest number of wiring layers (actual wiring layers) having the same wiring pattern while satisfying the design limitation such as timing and so forth.

Specifically, first, each temporary physical wiring layer is subjected to timing analysis by the timing analysis unit 30 before conversion into the actual wiring patterns, thereby analyzing whether or not timing violation has occurred, for example.

In a case of detecting the timing violation due to any of the aforementioned circuit variables, timing analysis is performed again for the circuit variables of a wiring structure formed of the actual wiring layers converted from the temporary physical wiring layer. Specifically, first, the circuit variables are calculated for the wiring structure formed of the multiple actual wiring layers having the same wiring patterns. More specifically, the temporary physical wiring layer is converted into two actual wiring layers using connection structures shown in FIGS. 2A-2D through 4A-4E, for example. Then, the aforementioned circuit variables are calculated for the wiring structure thus converted.

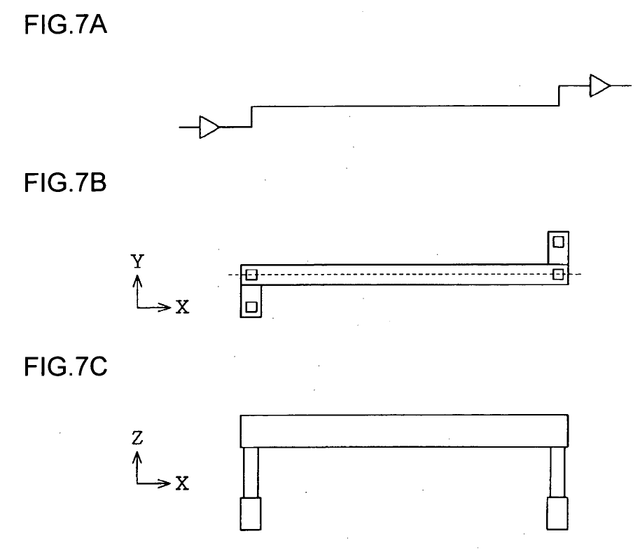

For example, let us say that the temporary physical wiring layer shown in FIGS. 7B and 7C is designed based upon the circuit information shown in FIG. 7A. Furthermore, let us say that the resistance thereof is determined to be R based upon the information stored in the process parameter storage unit 14. In this case, in a case of converting the aforementioned temporary physical wiring layer into two actual wiring layers having the wiring structure shown in FIG. 2A-2D, the resistance thereof becomes R/2. On the other hand, in a case of converting the aforementioned temporary physical wiring layer into two actual wiring layers having the wiring structure shown in FIG. 3A-3D, the resistance thereof becomes 2R. Accordingly, in a case of converting the layout pattern of the temporary physical wiring layer into the layout patterns of the layout patterns of two actual wiring layers having the wiring structure shown in FIG. 2A-2D (FIG. 3A-3D), the resistance of the wiring pattern serving -as the circuit variable becomes R/2 (2R). Furthermore, such conversion (conversion of the wiring pattern of the temporary physical wiring layer into the patterns of the actual wiring layers in the form shown in FIG. 2A-2D or 3A-3D) may be performed for a part of the wiring pattern of the temporary physical wiring layer shown in FIGS. 7B and 7C, as well as for the entire wiring pattern thereof as described above. Thus, such conversion allows adjustment of the resistance serving as a circuit variable in a range between R/2 to R, and R to 2R.

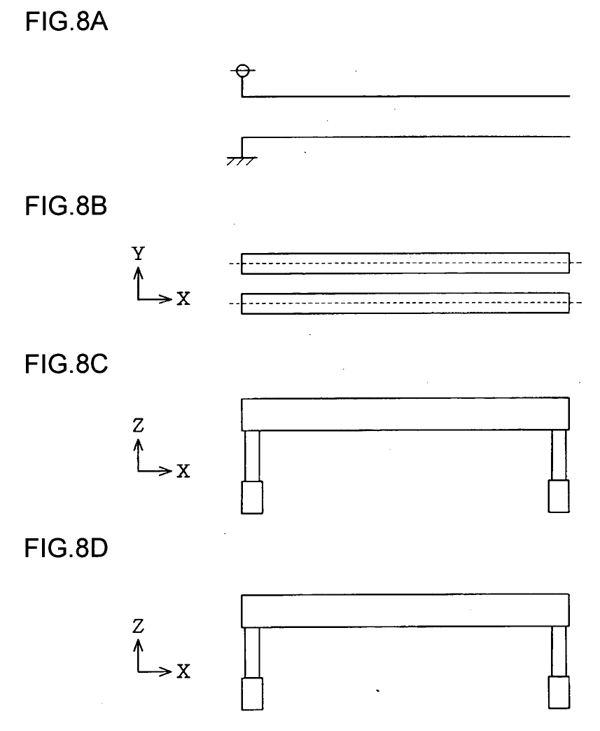

Also, let us say that the layout of the temporary physical wiring layer shown in the plan view in FIG. 8B is designed based upon the circuit information shown in FIG. 8A. Here, FIGS. 8C and 8D are cross-sectional diagrams thereof. In this case, in a case of converting the wiring pattern of the temporary physical wiring layer into wiring patterns having a structure shown in FIG. 4A-4E, the capacitance between the pair of wiring patterns becomes generally twice.

The number of the actual wiring layers available for this conversion is determined based upon the maximum number of the actual wiring layers determined based upon the aforementioned limitation of manufacturing, and the number of the aforementioned temporary physical wiring layers. For example, let us say that the aforementioned maximum number of the actual wiring layers is six, and the integrated circuit is designed using five temporary physical wiring layers. In this case, any one of these five temporary physical wiring layers can be converted into two actual wiring layers.

Note that the aforementioned circuit variables are calculated by the circuit variable calculation unit 20 based upon the maximum number of the wiring layers and the number of the temporary wiring layers input from the input unit 50. Then, the circuit variables of the temporary physical wiring layers are stored in the temporary physical wiring layer rule storage unit 16. Here, in order to increase the range of adjustment of the aforementioned circuit variables, the number of the temporary physical wiring layers is preferably minimized.

Conversion of each temporary physical layer into the actual wiring layers is preferably repeated with the number of the actual wiring layers, into which the temporary physical layer is converted, being increased to two, three, and the like, in a stepped manner for each conversion, while confirming the presence or absence of the timing violation. Then, upon detecting no timing violation, the actual wiring layers in this conversion stage used for realizing the circuit variables are determined as the actual wiring layers used in the final stage.

Description has been made regarding an arrangement in which the number of the actual wiring layers is increased in a stepped manner. Also, an arrangement may be made in which timing analysis is performed for all the numbers of the actual wiring layers, which can be prepared for the conversion, based upon the circuit variables corresponding to the actual wiring layers, and the circuit variables in the final stage are determined based upon the analysis results.

In the following Step S130, the wiring pattern of each temporary physical wiring layer is converted into the wiring patterns of the actual wiring layers for realizing the circuit variables. Note that the number of the actual wiring layers is determined in the above Step S120. Specifically, the wiring pattern shown in FIGS. 7B and 7C is converted into the wiring patterns on the two actual wiring layers shown in FIG. 2A-2D or 3A-3D, for example. Alternatively, a pair of wiring patterns shown in FIGS. 8B through 8D is converted into two pairs of the wiring patterns shown in FIG. 4A-4E, for example.

Next, in Step S140, the properness of the layout of the integrated circuit is confirmed. Note that the layout of the integrated circuit has been subjected to connection using the temporary physical wiring layers in Step S110, and a part of the temporary physical wiring layers has been converted into the multiple actual wiring layers in Step S130. In Step S140, confirmation is preferably made giving consideration to some limitations of manufacturing, in addition to the aforementioned timing limitation. Examples of such limitations include an antenna rule for preventing damage of a gate insulating film due to charge accumulated in a gate of a transistor through the wiring in the manufacturing process for an integrated circuit. Specifically, the antenna rule restricts the overall length of the wiring pattern connected to the gate within a predetermined wiring length in the manufacturing process, for example.

Note that processing in Step S110 or S120 may be performed giving consideration to the antenna rule. In this case, the wiring pattern of the temporary physical wiring layer is converted into the actual wiring layers giving consideration to the antenna rule. For example, let us say that the temporary physical wiring pattern shown in FIGS. 7A through 7C is converted into the wiring patterns having a wiring structure shown in FIG. 2A through 2D. Furthermore, let us say that the wiring pattern Lb4 formed on the n'th wiring layer leads to insulation breakdown of the gate insulating film of a transistor connected to the wiring pattern LC2. With such an arrangement, the wiring pattern Lb4 is formed with a reduced length so as to not connect the wiring patterns LC2 and Lb4 in the manufacturing step for the n'th wiring layer. Then, the (n+1)'th wiring layer is formed such that the wiring patterns Lb4 and La4 are connected with each other, and the wiring patterns La4 and LC2 are connected with each other. Such layout design allows insulation breakdown to be avoided even in a case that the wiring pattern Lb4 is connected to the drain or source of the transistor in the manufacturing step for the (n+1)'th wiring layer.

Then, in Step S140, in a case that determination has been made that the integrated circuit is proper, the mask calculation unit 40 creates data (mask data) used for a mask pattern, based upon the data (layout data) representing a layout pattern.

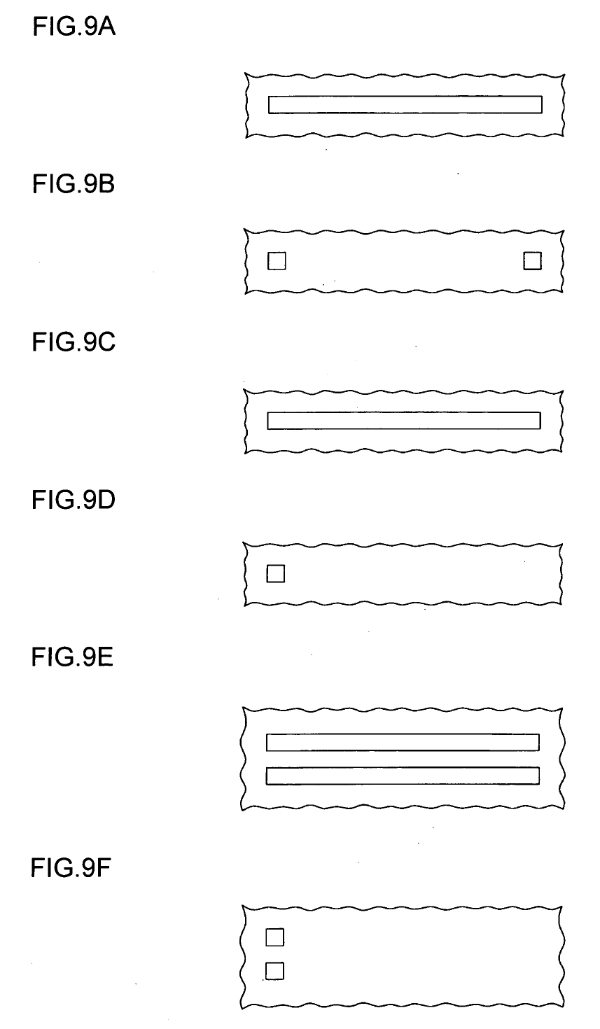

That is to say, the masks for the wiring pattern La4 of the (n+1)'th wiring layer and the wiring pattern Lb4 of the n'th wiring layer shown in FIG. 2A-2D are represented by a single mask data set shown in FIG. 9A. On the other hand, the mask for a via hole for connecting the wiring pattern La4 of the (n+1)'th wiring layer and the wiring pattern Lb4 of the n'th wiring layer shown in FIG. 2A-2D is represented as shown in FIG. 9B.

Also, the masks for the wiring pattern La3 of the (n+1)'th wiring layer and the wiring pattern Lb3 of the n'th wiring layer shown in FIG. 3A-3D are represented by a single mask data set shown in FIG. 9C. On the other hand, the mask for a via hole for connecting the wiring pattern La3 of the (n+1)'th wiring layer and the wiring pattern Lb3 of the n'th wiring layer shown in FIG. 3A-3D is represented as shown in FIG. 9D.

Also, the masks for a pair of the wiring patterns La2 and La1 of the (n+1)'th wiring layer and a pair of the wiring patterns Lb2 and Lb1 of the n'th wiring layer shown in FIG. 4A-4E are represented by a single mask data set shown in FIG. 9E. On the other hand, the mask for via holes for connecting the pair of the wiring patterns La2 and La1 of the (n+1)'th wiring layer and the pair of the wiring patterns Lb2 and Lb1 of the n'th wiring layer shown in FIG. 4A-4E is represented as shown in FIG. 9F.

Note that these mask data sets are created giving consideration to the limitation from the perspective of the manufacturing process for the integrated circuit. Specifically, in manufacturing of the wiring pattern of the integrated circuit with a certain wiring width or wiring interval, the wiring width or the wiring interval on the mask is adjusted corresponding to the manufacturing step, and the manufacturing is performed using the mask with the wiring width or wiring interval thus adjusted. Accordingly, in some cases, the mask pattern shown in FIGS. 9A through 9F is different in the wiring width, wiring interval, and so forth, from the layout data designed up to Step 140.

As described above, the present embodiment has the advantage that the mask of the (n+1)'th wiring layer and the mask of the n'th wiring layer are represented by a single mask.

Furthermore, with the present embodiment, after the layout/wiring step using the temporary physical wiring layers, the wiring pattern of the temporary physical wiring layer is converted into the wiring patterns of the actual wiring layers, and the wiring patterns thus converted are electrically connected. This allows the designer to adjust the circuit variables so as to satisfy the design limitations without changing design of the layout of the wiring pattern. This reduces the load of the trial-and-error processing performed by the automatic wiring unit 24, thereby reducing the computation load on the automatic wiring tool.

The present embodiment described above has the following advantages.

(1) The wiring pattern used for transmitting a signal is converted into multiple wiring patterns, e.g., the wiring patterns La4 and Lb4, provided to the multiple wiring layers in parallel with each other. Furthermore, these multiple wiring patterns are electrically connected with each other through via holes provided at multiple positions. This allows the resistance of the wiring to be reduced without increasing the effective wiring width, i.e., the wiring width taken up on the substrate of the integrated circuit.

(2) The wiring pattern is converted into multiple wiring patterns, e.g., the wiring patterns La3 and Lb3, connected in serial such that the signals are transmitted through these wiring patterns in the opposite directions to each other. This allows the designer to adjust so as to increase the resistor, thereby facilitating adjustment of a delay of a signal and creation of a reference voltage in the integrated circuit.

(3) A pair of the wiring patterns is converted into multiple pair of wiring patterns, e.g., a pair of the wiring patterns La2 and La1, and a pair of the wiring patterns Lb2 and Lb1 which has the mirror image relation with the pair of the wiring patterns La2 and La1, provided to separate wiring layers. These pairs of the wiring patterns are connected through via holes. This allows the capacitance between the adjacent wiring patterns to be increased.

(4) With the present embodiment, the wiring pattern of a temporary physical wiring layer is converted into multiple wiring patterns in the actual wiring layers, e.g., two wiring patterns on the (n+1)'th wiring layer and n'th wiring layer. These two wiring patterns are provided so as to extend in the same direction. Furthermore, these two wiring patterns has the mirror image relation with each other. Accordingly, the adjacent two wiring layers can be manufactured using a single mask.

(5) With the present embodiment, after the layout/wiring step using the temporary physical wiring layers, each of the temporary physical wiring layers is converted into the multiple actual wiring layers as necessary, and the wiring patterns of the multiple actual wiring layers thus converted are electrically connected with each other. Such a technique enables adjustment of the circuit properties which cannot be performed by conventional techniques having no function of such conversion. This facilitates adjustment of the circuit properties.

### Second Embodiment

Description will be made below regarding a semiconductor integrated circuit and a design method thereof according to a second embodiment of the present invention, primarily regarding the difference as to the first embodiment as described above, with reference to the drawings.

With regard to the logic circuit unit 2 according to the present embodiment, the wiring patterns are provided to each of the (n+1)'th wiring layer and the n'th wiring layer at a pitch of an integer multiple of a predetermined unit pitch Pa in the same way. Furthermore, with the present embodiment, a certain wiring pattern of the (n+1)'th wiring layer has a mirror image relation with the corresponding wiring pattern of the n'th wiring layer in the same way. However, the wiring pattern on the one layer does not always have the corresponding wiring pattern on the other layer having a mirror image relation therewith. The reason is that a pair of wiring patterns having a structure shown in FIGS. 10A through 10C or 11A through 11D is further provided across the (n+1)'th wiring layer and the n'th wiring layer.

Description will be made below with reference to FIGS. 10A through 10C. FIGS. 10A and 10B show the wiring patterns on the (n+1)'th wiring layer and the n'th wiring layer, respectively. With these wiring layers, the face thereof is a plane defined by x and y axes. Furthermore, the wiring patterns are provided so as to extend in the x direction. More specifically, FIG. 10A shows a wiring pattern Lc1 provided to the (n+1)'th wiring layer. FIG. 10B shows a wiring pattern Lc2 provided to the n'th wiring layer. These wiring patterns Lc1 and Lc2 are provided so as to extend in parallel, with an interval of the aforementioned unit pitch Pa in the direction orthogonal to the wiring-pattern-extending direction. FIG. 10C is a yz cross-sectional view of the wiring patterns Lc1 and Lc2 with the perpendicular direction as the z direction.

With such an arrangement, a pair of the wiring patterns Lc1 and Lc2, in which the wiring-pattern images thereof projected onto the substrate of the integrated circuit are positioned with a minimum interval, are provided to separate wiring layers. This allows the capacitance between the wiring patterns Lc1 and Lc2 to be suitably reduced, without increasing the interval therebetween in the horizontal direction.

Next, description will be made with reference to FIGS. 11A through 11D. FIGS. 11A and 11B show the wiring patterns on the (n+1)'th wiring layer and the n'th wiring layer, respectively. With these wiring layers, the face thereof is a plane defined by x and y axes. Furthermore, the wiring patterns are provided so as to extend in the x direction. More specifically, FIG. 11A shows wiring patterns Ld1 and Ld2 provided across the (n+1)'th wiring layer and the n'th wiring layer so as to extend in parallel with each other with an interval of the aforementioned unit pitch Pa.

FIG. 11C is an xz cross-sectional view of the wiring pattern Ld1 with the perpendicular direction of each wiring layer as the z direction. That is to say, the wiring pattern Ld1 is provided across the (n+1)'th wiring layer and the n'th wiring layer. Furthermore, the parts of the wiring pattern Ld1 are electrically connected with each other in serial through plugs pg8 formed within via holes provided between these wiring layers.

FIG. 11D is an xz cross-sectional view of the wiring pattern Ld2 with the perpendicular direction of each wiring layer as the z direction. That is to say, the wiring pattern Ld2 is provided across the (n+1)'th wiring layer and the n'th wiring layer. Furthermore, the parts of the wiring pattern Ld1 are electrically connected with each other in serial through plugs pg9 formed within via holes provided between these wiring layers.

With such an arrangement, each of these wiring patterns Ld1 and Ld2 is provided so as to alternately switch between the (n+1)'th wiring layer and the n'th wiring layer. Such a wiring structure markedly reduces overlapping parts of the wiring patterns Ld1 and Ld2 adjacent to one another in the same wiring layer. This suitably reduces the capacitance between the wiring patterns Ld1 and Ld2. Furthermore, each of the wiring patterns Ld1 and Ld2 is provided across the wiring layers. Such a wiring structure has the advantage of reducing adverse effects on the wiring patterns Ld1 and Ld2 due to electric connection thereof with other components.

Note that with regard to the wiring pattern according to the present embodiment as shown in FIGS. 10A-10C and 11A-11D, the separate mask data sets, i.e., the mask data set for the (n+1)'th wiring layer and the mask data set for the n'th wiring layer are created in the processing in Step S150 shown in FIG. 6.

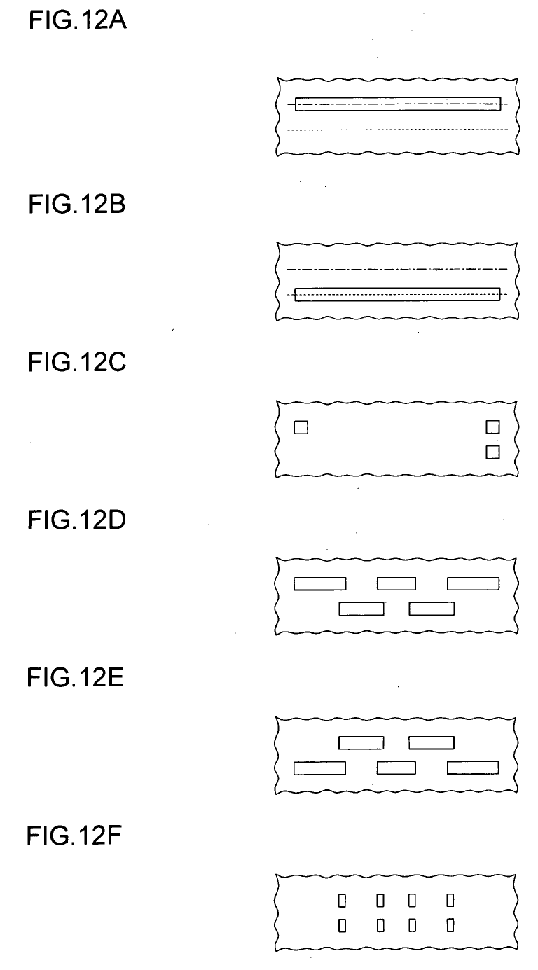

FIG. 12A shows a mask corresponding to the wiring pattern Lc1 shown in FIGS. 10A through 10C. FIG. 12B shows a mask corresponding to the wiring pattern Lc2 shown in FIG. 10A-10C. FIG. 12C shows an example of a mask of via holes for connecting these wiring patterns Lc1 and Lc2 to other wiring patterns. On the other hand, FIG. 12D shows a mask of a part of the wiring patterns Ld1 and Ld2 shown in FIGS. 11A through 1D, provided to the (n+1)'th wiring layer. FIG. 12E shows a mask of another part of the wiring patterns Ld1 and Ld2 provided to the n'th wiring layer. On the other hand, FIG. 12F shows a mask of the via holes for connecting the part of the wiring patterns Ld1 (Ld2) provided to the (n+1)'th wiring layer and the other part of the wiring patterns Ld1 (Ld2) provided to the n'th wiring layer.

As described above, the present embodiment further includes the wiring patterns having such a structure shown in FIGS. 10A-10C and 11A-11D, as well as the wiring structure shown in FIGS. 2A-2D through 4A-4E, thereby enabling the capacitance between the wiring patterns to be reduced. In particular, the present embodiment has the advantage of allowing the capacitance between the wiring patterns to be reduced. This suitably reduces crosstalk noise, as well as allowing the designer to design a higher-speed and low-power-consumption integrated circuit.

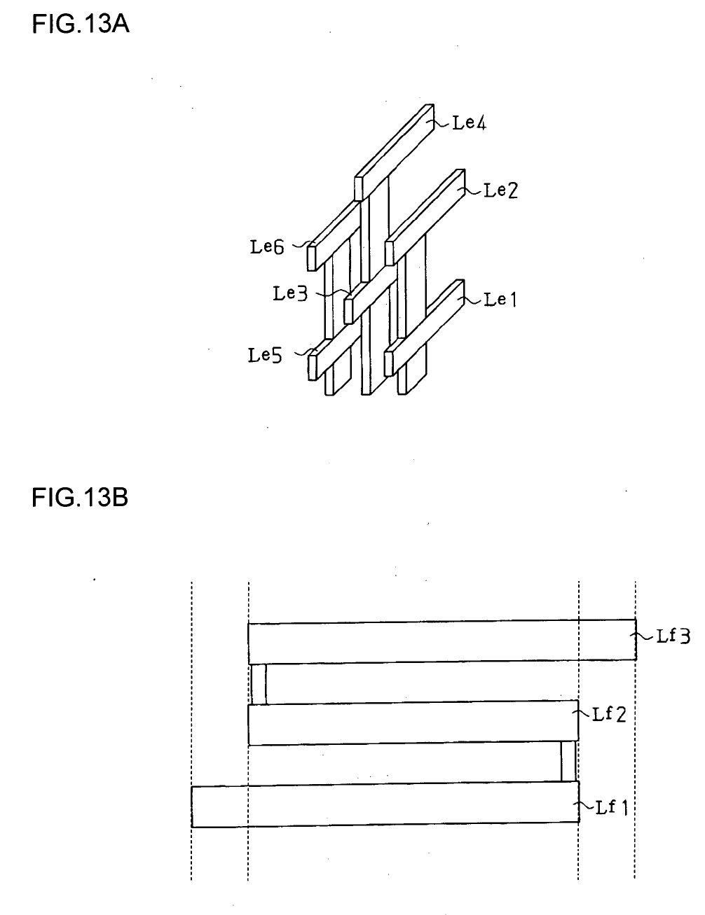

While description has been made regarding an arrangement in which the temporary physical wiring layer is converted into two actual wiring layers, with reference to FIGS. 1A-1C through 4A-4E, and FIGS. 10A-10C and 11A-1D, the present invention is not restricted to such an arrangement. Also, the temporary physical layer may be converted into four actual wiring layers as shown in FIG. 13A. In FIG. 13A, wiring patterns Le1 and Le5 are formed in the first actual wiring layer, a wiring pattern Le3 is formed in the second actual wiring layer, wiring patterns Le2 and Le6 are formed in the third actual wiring layer, and a wiring pattern Le4 is formed in the fourth actual wiring layer. With this wiring structure, the images of the wiring patterns Le1 and Le2 projected onto the substrate are generally the same with each other. Furthermore, the wiring patterns Le1 and Le2 are connected with each other through via holes. Also, the images of the wiring patterns Le3 and Le4 projected onto the substrate are generally the same with each other. Furthermore, the wiring patterns Le3 and Le4 are connected with each other through via holes. Also, the images of the wiring patterns Le5 and Le6 projected onto the substrate are generally the same with each other. Furthermore, the wiring patterns Le5 and Le6 are connected with each other through via holes.

With this wiring structure, the wiring patterns, to which the distance from the wiring pattern Le4 is the smallest in the wiring-width direction, other than the wiring patterns directly thereunder, are the wiring patterns Le2 and Le6 provided to the wiring layer immediately blow. Also, the wiring patterns, to which the distance from the wiring pattern Le3 is the smallest in the wiring-width direction, other than the wiring patterns directly thereunder, are the wiring patterns Le1 and Le5 provided to the bottom wiring layer. Thus, the wiring pattern Le4 (Le3) is designed so as to reduce the capacitance between: the wiring pattern Le4 (Le3) and the wiring patterns, to which the distance from the wiring pattern Le4 (Le3) is the smallest in the wiring-width direction, i.e., Le2 and Le6 (Le1 and Le5).

On the other hand, FIG. 13B shows an example in which the wiring pattern of the temporary physical wiring layer is converted to the wiring patterns of three actual wiring layers. With such a wiring structure, the wiring patterns Lf1, Lf2, and Lf3, are connected in serial with each other, so that a signal passes through the wiring patterns Lf1 and Lf2 in the opposite transmission directions, and so that the signal passes through the wiring patterns Lf2 and Lf3 in the opposite transmission directions.

The present embodiment described above further provides the following advantages, in addition to the aforementioned advantages (1) through (3), and (5) described in the aforementioned first embodiment.

(6) The two wiring patterns Lc1 and Lc2, in which the images thereof projected onto the substrate of the integrated circuit are the closest to each other, are provided so as to pass through separate wiring layers. Such a wiring structure enables the capacitance between the wiring patterns Lc1 and Lc2 to be suitably reduced without increasing the interval between the wiring patterns Lc1 and Lc2 in the horizontal direction.

(7) The wiring patterns Ld1 and Ld2 are provided across the (n+1)'th wiring layer and n'th wiring layer so as to alternately switch between the (n+1)'th wiring layer and the n'th wiring layer through via holes. Such a wiring structure markedly reduces the overlapping parts of the wiring layers Ld1 and Ld2 adjacent to one another in the horizontal direction, i.e., in the same wiring layer. This suitably reduces the capacitance between the wiring patterns Ld1 and Ld2.

### Third Embodiment

Description will be made below regarding a semiconductor integrated circuit and a design method thereof according to a third embodiment of the present invention, primarily regarding the difference as to the second embodiment as described above, with reference to the drawings.

With the aforementioned second embodiment, layout design is performed giving consideration to the layout/wiring step on the temporary physical wiring layers using an automatic layout wiring tool, and the following step in which the wiring pattern of a certain temporary physical wiring layer is converted into the wiring patterns while maintaining electric connection realized by wiring on the temporary physical wiring layer.

On the other hand, the present embodiment relates to layout modification for an integrated circuit in which the layout has been already designed (integrated circuit in which the layout data, mask data, and so forth have been already designed) in order to improve the performance thereof. Examples of cases for performing such layout modification include: i) a case that it has become clear that the integrated circuits are manufactured with irregularities in the properties, leading to low yield; ii) a case that change in the performance such as the operation frequency and forth is requested for an integrated circuit in which the layout has already been designed or an existing integrated circuit on a manufacturing line; iii) a case of performing timing adjustment of a reduced integrated circuit similar to an existing integrated circuit in order to design an integrated circuit according to a modified design rule, such as a case of designing an integrated circuit according to the 0.18 μm design rule based upon an existing integrated circuit designed according to the 0.35 μm design rule.

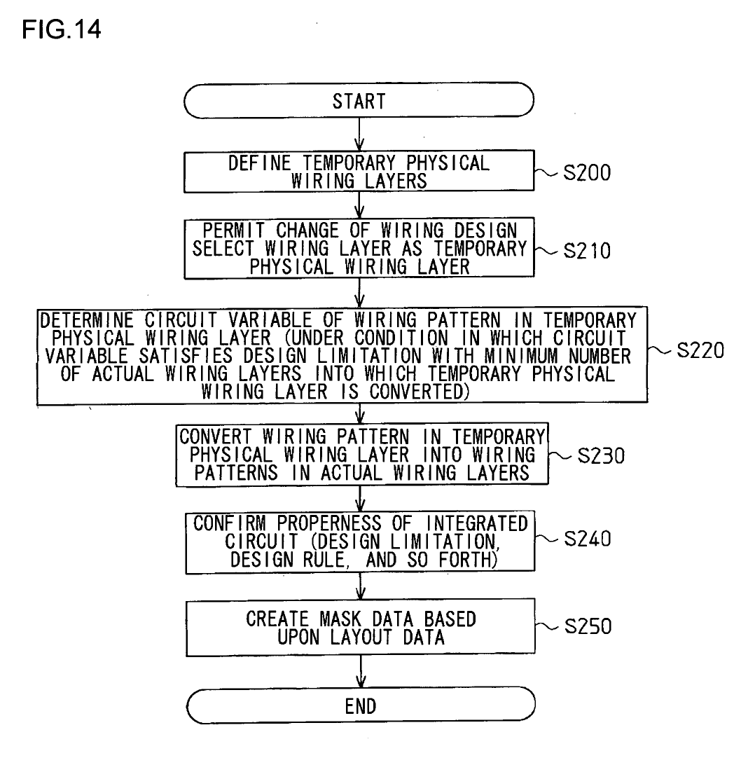

FIG. 14 shows a procedure of the processing for modifying a layout of an integrated circuit according to the present invention. Note that the processing shown in FIG. 14 is performed using the design support apparatus shown in FIG. 5. However, this processing does not require all the components of the support apparatus shown in FIG. 5. Furthermore, each function block is used in a different manner. Description thereof will be made along with description of the processing procedure shown in FIG. 14.

With a series of the processing, first, in Step S200, a temporary physical wiring layer rule, i.e., a rule for converting the wiring pattern of a single wiring layer (temporary physical wiring layer) into the wiring patterns of multiple actual wiring layers, is defined.

First, the design support apparatus receives: the maximum number of the wiring layers determined based upon the limitation of manufacturing of the integrated circuit and so forth; and the number of the wiring layers of the integrated circuit in which the layout design has been completed, through the input unit 50 shown in FIG. 5. Then, the circuit variable calculation unit 20 shown in FIG. 5 determines the number of the actual wiring layers into which the wiring layer can be converted, based upon the difference between the aforementioned maximum number of the wiring layers and the number of the wiring layers thus designed. For example, let us say that the aforementioned maximum wiring layers is six, and the number of the wiring layers of the integrated circuit thus designed is five. In this case, any one of the wiring layers can be converted into two actual wiring layers. On the other hand, let us say that the aforementioned maximum wiring layers is six, and the number of the wiring layers of the integrated circuit thus designed is four. In this case, any two of the wiring layers can be converted into two actual wiring layers, respectively. Alternatively, any one of the wiring layers can be converted into three actual wiring layers. Such determination of the actual wiring layers into which the wiring layer is converted, also determines limitation of converting a predetermined wiring pattern into a wiring pattern having a structure shown in FIGS. 2A-2D through 4A-4E, and FIGS. 10A-10C, 11A-11D, and 13A, 13B.

Then, the circuit variable calculation unit 20 calculates the circuit variables based upon the number of the actual wiring layers into which the wiring layer can be converted.

In the following Step S210, a wiring layer, in which the wiring pattern thereof is to be adjusted, is selected as a temporary physical wiring layer. Note that the design support apparatus receives instructions to set the specified wiring layer to a temporary physical layer through the input unit 50 shown in FIG. 5.

In the following Step S220, the circuit variable determination unit 32 shown in FIG. 5 determines the circuit variables of the wiring pattern of the aforementioned physical temporary wiring layer. In this step, the circuit variables are determined such that the design limitations such as timing and so forth are satisfied with the minimum number of the actual wiring layers into which the temporary physical wiring layer is converted.

Specifically, timing analysis is performed while increasing the number of the actual wiring layers into which the temporary physical wiring layer is converted, in a stepped manner, e.g., the temporary physical wiring layer is converted into two actual wiring layers in the first stage, and converted into three actual wiring layers in the next stage. Upon detecting no timing violation, the actual wiring layers used for realizing the circuit variables in this stage is determined as the final actual wiring layers.

Description has been made regarding an arrangement in which the number of the actual wiring layers is increased in a stepped manner. Also, an arrangement may be made in which timing analysis is performed for all the numbers of the actual wiring layers, which can be prepared for the conversion, based upon the circuit variables corresponding to the actual wiring layers, and the circuit variables in the final stage are determined based upon the analysis results.

In the following Step S230, the wiring layer conversion unit 34 shown in FIG. 5 converts the wiring pattern of the temporary physical wiring layer into the wiring patterns of the actual wiring layers for realizing the circuit variables determined in the aforementioned Step S220.

Next, in Step S240, the properness of the layout of the integrated circuit having a part modified in Step S230 is confirmed. In this step, such confirmation is preferably made giving consideration to the several limitations of manufacturing and so forth, in addition to the aforementioned timing limitation, for example.

Note that the processing in Step S210 or S220 may be also performed giving consideration to such design limitations.

In a case that the properness of the integrated circuit has been confirmed in Step S240, the aforementioned mask calculation unit 40 creates mask data in Step S250 based upon the layout data.

The present embodiment has a function of performing inverse-conversion of the wiring patterns thus converted, into the original wiring pattern. This enables timing modification to be further performed for the layout data obtained by converting the temporary physical wiring layer into the multiple actual wiring layers. That is to say, the present embodiment has a function of converting the actual wiring layers into a reduced number of actual wiring layers, as well as into an increased number of actual wiring layers.

The present embodiment described above further provides the following advantages, in addition to the aforementioned advantages (1) through (3), and (6) and (7) described in the aforementioned second embodiment.

(8) With regard to the integrated circuit in which the layout has already been designed, a wiring layer is selected as a temporary physical wiring layer so as to allow the designer to adjust the wiring pattern provided thereto. Then, the wiring pattern of the temporary physical wiring layer is converted into multiple actual wiring layers while maintaining the electric connection state designed on the temporary physical wiring layer. This facilitates adjustment of the circuit properties of the integrated circuit in which the layout thereof has already been designed.

### Fourth Embodiment

Description will be made below regarding a semiconductor integrated circuit and a design method thereof according to a fourth embodiment of the present invention, primarily regarding the difference as to the first and second embodiments as described above, with reference to the drawings.

With the aforementioned first and second embodiments, following layout design using the temporary physical wiring layers, a certain temporary physical wiring layer is converted into actual wiring layers. Note that this conversion is performed for the entire area of the logic circuit unit 2. On the other hand, with the present embodiment, following layout design on the temporary physical wiring layers using an automatic layout wiring tool, the area (corresponding to the logic circuit unit 2 shown in FIG. 1) subjected to layout design using the automatic layout wiring tool is divided into multiple sub-regions. With the present embodiment, conversion of the temporary physical wiring layer into the actual wiring layers can be performed for each sub-region thus divided.

With an arrangement in which the aforementioned conversion is performed for the entire region of the logic circuit unit 2, in some cases, some areas have no wiring patterns in the actual wiring layers thus converted, since the wiring patterns is not always provided over each temporary physical wiring layer with sufficient uniformity. On the other hand, with the present embodiment, each temporary physical wiring layer is converted for each sub-region into multiple actual wiring layers while maintaining electric connection designed on the temporary physical wiring layer. Such conversion is performed so as to minimize creation of the actual wiring layers having no wiring pattern as much as possible. Thus, the present embodiment enables the circuit properties of the layout using the temporary physical wiring layers to be improved while reducing the redundancy occurred in layout design.

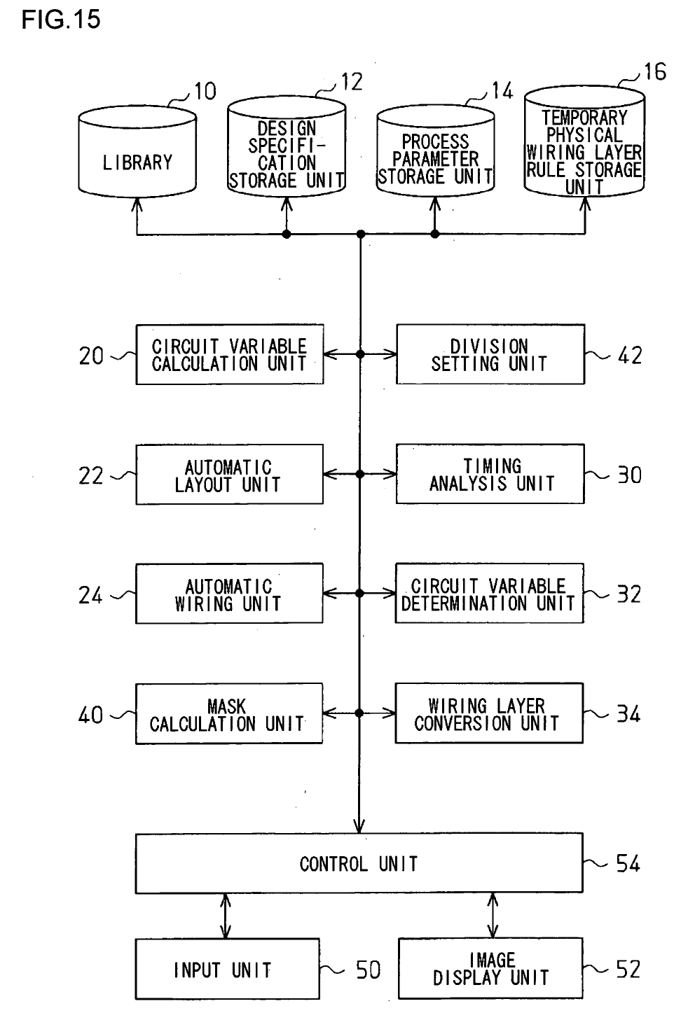

FIG. 15 shows an overall configuration of a design support apparatus employed in the present embodiment. In FIG. 15, the components having the same function as with the design support apparatus shown in FIG. 5 are denoted by the same reference numerals for convenience.

As shown in FIG. 15, the design support apparatus includes a division setting unit 42. The division setting unit 42 has a function of dividing a region into sub-regions. Furthermore, the division setting unit 42 has a function of setting a connection region between the adjacent sub-regions subjected to the actual-layer conversion in different manners, so as to electrically connect these adjacent sub-regions. The division setting unit 42 is also realized by a combination of storage devices for storing a program used for executing the aforementioned processing, such as semiconductor memory, a hard disk device, and so forth, and a computer.

Now, detailed description will be made regarding a processing procedure for layout design performed by such a design support apparatus according to the present embodiment with reference to FIG. 16.

With a series of the processing, first, in Step S300, the temporary physical wiring layers, i.e., the wiring layers on which cells are automatically arranged and connected using an automatic wiring tool, are defined in the same way as in Step S100 shown in FIG. 6. Note that with the present embodiment, the number of the actual wiring layers, into which the temporary physical wiring layer can be converted, is determined based upon the maximum number of the wiring layers determined based upon the aforementioned limitations of manufacturing and so forth, in the same way as with the previous embodiments. The difference is that the aforementioned number of the actual wiring layers is not always determined corresponding to the difference between the maximum number of the wiring layers and the number of the temporary physical wiring layers. Rather, the aforementioned number of the actual wiring layers is preferably set to a number greater than the aforementioned difference.

In the following Step 310, layout design is performed using the temporary physical wiring layers defined in the aforementioned Step S300.

Following this layout design, the division setting unit 42 shown in FIG. 15 divides the region, subjected to layout design using the automatic layout wiring tool, into sub-regions in Step S320. Specifically, FIG. 17A shows an example in which the entire region of the logic circuit unit 2 is divided into multiple rectangular sub-regions (denoted by reference characters a through t in the drawing).

In the following Step S330, after the aforementioned connection design for the integrated circuit, the aforementioned circuit variable determination unit 32 determines the circuit variables of the wiring pattern for realizing connection for each sub-region. In this step, the circuit variables are determined so as to satisfy design limitations such as timing and so forth with the minimum number of the actual wiring layers into which the temporary physical wiring layer is converted.

With the present embodiment, in this stage, the aforementioned circuit variable determination unit 32 detects the number of the wiring layers having no wiring pattern, for each sub-region. Then, a sub-region including a great number of the wiring layers having no wiring pattern is set to a sub-region where conversion into the actual wiring layers is to be performed using a corresponding great number of actual wiring layers. Specifically, let us say that the number of the temporary physical wiring layers is five. Furthermore, let us say that the sub-region a shown in FIGS. 17A, 17B has three wiring layers having wiring patterns, and the sub-region c has five wiring layers having wiring patterns. In this case, conversion into the actual wiring layers is performed for the sub-region a with a greater number of actual wiring layers than that of the sub-region c. More specifically, in this case, the sub-region a includes two wiring layers having no wiring pattern, and accordingly, the two wiring layers serve as redundant wiring layers after the end of layout design in Step S310. With the present embodiment, such redundant wiring layers are effectively used for adjusting the circuit properties of the overall integrated circuit. This enables adjustment of the circuit properties of the integrated circuit while suppressing an increase in the number of the wiring layers thereof.

Specifically, first, the timing analysis unit 30 performs timing analysis based upon the circuit variables before each temporary physical wiring layer is converted into the actual wiring layers, and analyzes whether or not timing violation has occurred. Then, in a case of detecting the timing violation for the aforementioned circuit variables, timing analysis is performed for each sub-region, again, based upon the circuit variables obtained from the wiring patterns of a certain number of actual wiring layers into which a certain temporary physical wiring layer is converted. In this step, the number of the sub-regions to be converted is preferably increased in a stepped manner. Furthermore, the number of the actual wiring layers, into which the temporary physical wiring layer is converted, is preferably increased in a stepped manner, e.g., the temporary physical wiring layer is converted into two actual wiring layers in the first stage, and converted into three actual wiring layers in the next stage.

Then, in a case of detecting no timing violation in this analysis, the actual wiring layers used for obtaining the circuit variables in this stage are determined as the actual wiring layers in the final stage.

In the following Step S340, the aforementioned wiring layer conversion unit 34 converts the wiring pattern of the temporary physical wiring layer into the wiring patterns of the actual wiring layers for each sub-region based upon the circuit variables thus determined as described above.

Next, in Step S350, the division setting unit 42 sets a connection region between the adjacent regions where the conversion into the actual wiring layers has been performed in different manners. The reason why such processing is performed is that the adjacent regions where the conversion into the actual wiring layers has been performed in different manners cannot directly be connected with each other while maintaining the connection state realized by the layout design performed in the aforementioned Step S310. Accordingly, such a connection region is created between such adjacent regions.

Specifically, first, as shown in FIG. 17B, the division setting unit 42 extracts the boundary between the adjacent regions where the conversion into the actual wiring layers has been performed in different manners. This means that the division setting unit 42 classifies the sub-regions into new region groups each of which is formed of the sub-regions where the conversion into the actual wiring layers has been performed in the same manner. FIG. 17B shows an example in which the sub-regions a, b, f and g shown in FIG. 17A form a new region group D, the sub-regions c, d, e, h, i, j, m, n and o form a new region group C, the sub-regions k, l, p and g form a new region group A, and the sub-regions r, s and t form a new region group B.

As shown in FIGS. 18A and 18B, conversion into the actual wiring layers is performed in the same manner for each new region group in the aforementioned Step S340. Specifically, in the new region group A shown in FIG. 18B, a temporary physical wiring layer K is converted into actual wiring layers K(1) and K(2), a temporary physical wiring layer K+1 is converted into actual wiring layers K+1(1) and K+1(2), and a temporary physical wiring layer K+2 is converted into actual wiring layers K+2(1) and K+2(2). On the other hand, in the new region group B the temporary physical wiring layer K+2 is converted into the actual wiring layers K+2(1) and K+2(2). Here, in FIGS. 18A through 18D, the X direction represents the horizontal direction, and the Z direction represents the depth direction. Also, in the drawings, reference characters X and Y in parentheses represent that the wiring pattern is provided so as to extend in the X direction and the Y direction, respectively. Also, the same actual wiring layers are hatched with the same patterns.

In Step S350, as shown in FIG. 18C, a connection region is determined around the boundary between the aforementioned adjacent region group thus newly created. In the connection region, wiring is formed so as to maintain the connection region realized by the layout design performed in the aforementioned Step S310. Note that, while the wiring layer is designed in a manner for maintaining the connection state realized by a certain temporary physical wiring layer, such s wiring layer and the corresponding temporary physical wiring layer are hatched with the same pattern in FIG. 18C.

In the temporary physical wiring layers K and (k+2) shown in FIG. 18A, the wiring pattern is provided so as to pass through the boundary between the aforementioned new region groups A and B. On the other hand, in the temporary physical wiring layer K+1, the wiring pattern is provided so as to extend in the Y direction, i.e., in the direction parallel to the boundary between the new region groups A and B. Accordingly, in the connection region, connection is provided so as to connect the new region groups A and B with each other while maintaining connection state of the temporary physical wiring layers K and (K+2) over the new region groups A and B. In other words, the wiring patterns of the actual wiring layers K(1) and K(2) in the new region group A are connected to the wiring pattern of the actual wiring layer K in the new region group B, thereby connecting the new region groups A and B with each other. Furthermore, the wiring patterns of the actual wiring layers K+2(1) and K+2(2) in the new region group A are connected to the wiring patterns of the actual wiring layers K+2(1) and K+2(2) in the new region group B, thereby connecting the new region groups A and B with each other.

With the present embodiment, a connection structure is employed in which the actual wiring layers into which the same temporary physical wiring layer is continuously connected with each other between the adjacent region groups while maintaining the connection state of the wiring patterns of the temporary physical wiring layers. Specifically, as shown in FIG. 18C, in order to continuously connect the actual wiring layers K(1) and K(2) in the new region group A to the actual wiring layer K in the new region group B, a wiring layer (the first layer in the drawing) is provided so as to extend in the X direction in the connection region. Furthermore, in order to continuously connect the actual wiring layers K+1(1) and K+1(2) in the new region group A to the actual wiring layer K+1 in the new region group B, wiring layers (the second and third layers in the drawing) are provided so as to extend in the Y direction in the connection region. Furthermore, in order to continuously connect the actual wiring layers K+2(1) and K+2(2) in the new region group A to the actual wiring layers K+2(1) and K+2(2) in the new region group B, wiring layers (the fourth and fifth layers in the drawing) are provided so as to extend in the X direction in the connection region.

Note that, in FIG. 18C, cross marks are put on the regions where the adjacent region groups are not to be connected through the connection regions. Note that the division setting unit 42 sets such regions where connection is not to be performed at the time of setting the connection region.

Also, an connection-region setting arrangement may be made in which only the actual wiring patterns, converted from the temporary physical wiring layer having the wiring pattern provided so as to pass across the boundary between the adjacent region groups, are continuously connected between the adjacent region groups. Specifically, with such an arrangement, in the aforementioned example shown in FIG. 18A-18D, the wiring pattern of the temporary physical wiring layer K+1 is not provided in the X direction so as to pass across the boundary between the adjacent region groups, and accordingly, the connection region is created without giving consideration to continuous connection between the actual wiring layers K+1(1) and K+2(2) in the new region group A and the actual wiring layer K+1 in the new region group B. With such an arrangement, the wiring structure of the connection region is determined giving consideration to the presence or absence of the wiring pattern provided so as to pass across the boundary between the adjacent region groups. This increases the degree of freedom of the wiring structure which can be formed in the connection region. Thus, such an arrangement reduces the limitation due to the structure of the connection region, which are a part of the limitations of wiring layout, thereby allowing the designer to easily realize the requested circuit properties of the wiring.

In the following Step S360, the aforementioned new region groups are electrically connected while maintaining the electric connection obtained in layout design in Step S310. FIG. 18D shows an example in which the aforementioned new region groups are electrically connected using the connection region. As shown in FIG. 18D, the two actual wiring layers K(1) and K(2) thus converted in the new region group A are connected to the actual wiring layer K in the new region group B through the connection region. Furthermore, the two actual wiring layers K+2(1) and K+2(2) thus converted in the new region group A are connected to the two actual wiring layers K+2(1) and K+2(2) thus converted in the new region group B through the connection region.

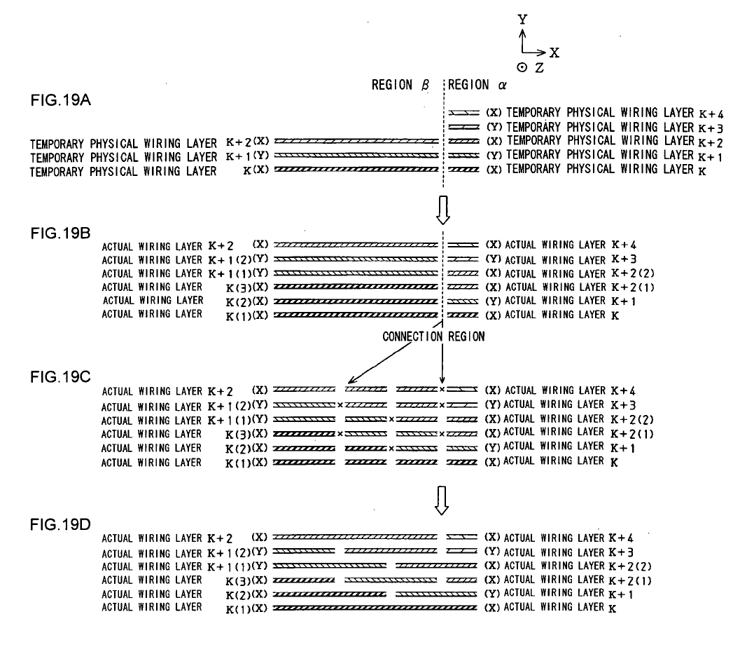

Description has been made regarding an arrangement in which a single wiring-layer structure is formed in the connection region, with reference to FIGS. 18A through 18D. Also, an arrangement may be made in which multiple wiring-layer structures are formed in the connection region in a case that a single-connection structure cannot maintain the connection state of the wiring pattern of any temporary physical wiring layer between the adjacent regions, or from the perspective of the circuit properties. Specifically, let us say that the wiring patterns of the temporary physical wiring layers shown in FIG. 19A are converted into the wiring patterns of the actual wiring layers shown in FIG. 19B. In this case, the connection region may be designed as shown in FIG. 19C. With such a connection region, the wiring patterns of actual wiring layers K(1), K(2), and K(3) in a new region group α are connected to the wiring pattern of the actual wiring layer K in a new region group β as shown in FIG. 19D. Furthermore, the wiring pattern of the actual wiring layer K+2 in the new region group α is connected to the wiring patterns of the actual wiring layers K+2(1), K+2(2) in the new region group β.

In either case, such a connection region allows connection of the wiring patterns between the adjacent regions. With the present embodiment, in the adjacent regions, the temporary physical pattern is converted into the patterns of the multiple wiring layers such that the image thereof projected to the substrate of the integrated circuit matches one another in a single line. Furthermore, such conversion can be performed in different manners for each region. Thus, such connection region enables suitable connection between the adjacent regions.

Following connection between the regions using the connection region described above, in Step S370 shown in FIG. 16, the properness of the integrated circuit is confirmed in the same way as in Step S140 shown in FIG. 6. Furthermore, in Step S380, mask data is created in the same way as in Step S150 described with reference to FIG. 16, whereby the series of processing ends.

The present embodiment described above further provides the following advantages, in addition to the aforementioned advantages (1) through (3), and (5) through (7) described in the aforementioned first and second embodiments.

(9) Following layout of the wiring using the temporary physical wiring layers, the temporary physical wiring layers having no wiring pattern are eliminated for each sub-region, thereby reducing the redundant space. Furthermore, the wiring pattern of each temporary physical wiring layer is converted into the wiring patterns of multiple actual wiring layers for each sub-region while maintaining electric connection in each temporary physical wiring layer. Such an arrangement enables a suitable wiring structure with reduced redundancy as compared with an arrangement in which the wiring pattern of each temporary physical wiring layer is converted into the wiring patterns of actual wiring patterns in the same manner throughout the entire area of the logic circuit unit 2.

(10) The present embodiment provides a connection region having a wiring structure in which each pair of the actual wiring patterns to be connected is provided such that the images thereof projected onto the substrate form a single line, and which enables connection between different actual wiring layers. Such an arrangement provides suitable connection between the adjacent regions.

### Fifth Embodiment

Description will be made below regarding a semiconductor integrated circuit and a design method thereof according to a fifth embodiment of the present invention, primarily regarding the difference as to the fourth embodiment as described above, with reference to the drawings.

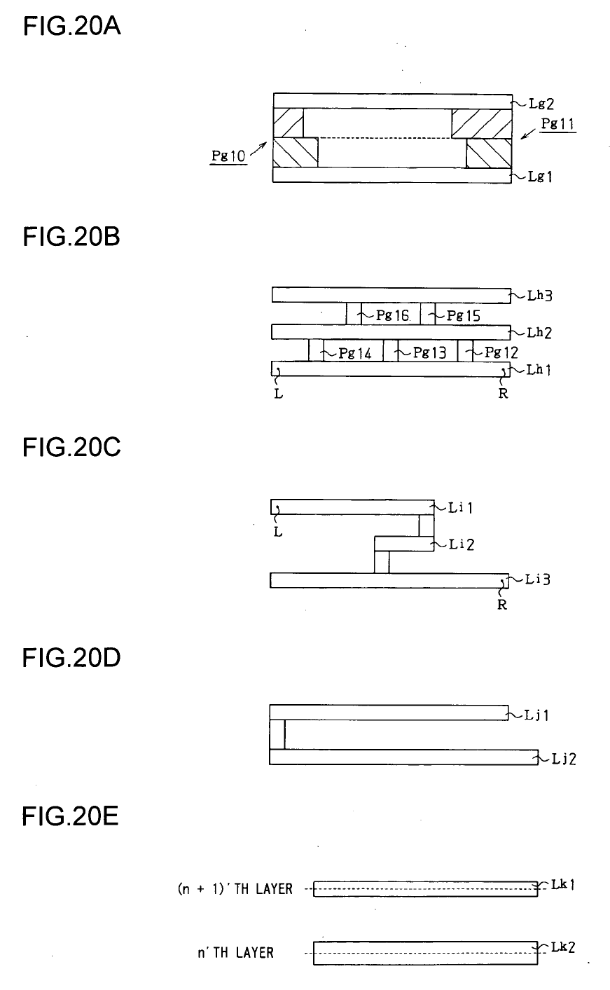

With the present embodiment, conversion of the wiring patterns of the temporary physical wiring layers into the wiring patterns of the actual wiring layers is not restricted to arrangements shown in FIGS. 2A-2D through 4A-4E, and FIGS. 10A-10C and 11A-11D. Also, an arrangement may be made using a wiring structure shown in FIGS. 20A through 20E, for example.

FIG. 20A shows an example of conversion of a first temporary physical wiring layer into three actual wiring layers. Of these actual wiring layers, the first and third actual wiring layers have wiring patterns Lg1 and Lg2, respectively. On the other hand, the intermediate layer, i.e., the second actual wiring layer has no wiring pattern. FIG. 20A shows an example in which plugs are formed in desired shapes within via holes for electrically connecting the actual wiring layers, i.e., plugs pg10 and pg11 are provided so as to connect the wiring patterns Lg1 and Lg2.

FIG. 20B shows an example of the layout of via holes provided to wiring patterns Lh1 through Lh3 of the actual wiring layers adjacent one another. With this example, these wiring patterns Lh1 through Lh3 are provided in parallel with each other, and are electrically connected with multiple plugs pg12 through pg16 formed within the via holes. Let us say that a signal is transmitted from the end L up to the end R of the wiring pattern Lh1 shown in FIG. 20B. In this case, the signal is transmitted through the wiring patterns Lh1 and Lh2 from the connection portion of the wiring patterns Lh1 and Lh2 connected by the plug pg14 up to the connection portion of the wiring patterns Lh1 and Lh2 connected by the plug pg12. Furthermore, the signal is also transmitted through the wiring pattern Lh3 from the connection portion of the wiring patterns Lh2 and Lh3 connected by the plug pg16 up to the connection portion of the wiring patterns Lh2 and Lh3 connected by the plug pg15. Thus, such an arrangement allows adjustment of the resistance of the transmission path for transmitting a signal from the end L to the end R by adjusting the connection portions connected by plugs provided to the wiring patterns Lh1 through Lh3.

FIG. 20C shows an example in which wiring patterns Li1 through Li3 provided to the actual wiring layers adjacent one another are electrically connected in serial with each other. With such an arrangement, a signal is transmitted from the end L of the wiring pattern Li1 up to the end R of the wiring pattern Li3 through the signal transmission path of the wiring patterns Li1 through Li3 thus connected in serial with each other. Here, in design of the layout on the temporary physical wiring layers, the signal transmission path from the end L up to the end R is designed with the wiring length of the wiring pattern of Li3. With the present embodiment, the conversion into the actual wiring layers allows adjustment of the signal transmission path, e.g., from the wiring path formed of only the wiring pattern Li3 of the temporary physical wiring layer to the wiring path including the wiring lengths of the wiring patterns Li1 and Li2 of the actual wiring layers. Accordingly, the overall length of the wiring structure converted and provided to the actual wiring layer is different from the overall length of the original wiring pattern in the temporary physical wiring layer. Such adjustment of the wiring length enables adjustment of the resistance of the signal transmission path for transmitting a signal from the end L to the end R.

FIG. 20D shows an arrangement having the same wiring structure as that shown in FIG. 4A-4E, except that a wiring pattern Lj1 fixed to a predetermined electric potential and a wiring pattern Lj2 connected to the wiring pattern Lj1 through a contact hole are designed with different wiring lengths. The wiring patterns having such a structure are arranged adjacent one another as shown in FIG. 4A-4E, thereby allowing adjustment of the capacitance between these adjacent wiring patterns.

FIG. 20E shows an arrangement in which a wiring pattern of a temporary physical wiring layer is converted into wiring patterns Lk1 and Lk2 with different wiring widths, provided to multiple wiring layers. Note that such wiring patterns Lk1 and Lk2 may be employed as the wiring patterns provided to the (n+1)'th wiring pattern and the n'th wiring pattern shown in FIGS. 2A-2D through 4A-4E, and FIGS. 10A-10C, 11A-11D, and 13A, 13B, for example.

Furthermore, with the present embodiment, temporary connection is made based upon the temporary physical wiring layers. Note that the temporary connection is made with a smaller computation load than that of detailed wiring in which all the connections are designed. Then, the optimum layout and the optimum wiring paths are designed based upon the temporary connections. Subsequently, each temporary physical wiring layer is converted into the actual wiring layers. With the present embodiment, the aforementioned temporary connection is made based upon the circuit properties giving consideration to the following processing in which the wiring pattern of a certain temporary physical wiring layer is converted into the wiring patterns which generally have a mirror image relation therebetween, and which are provided to multiple wiring layers, for at least one region.

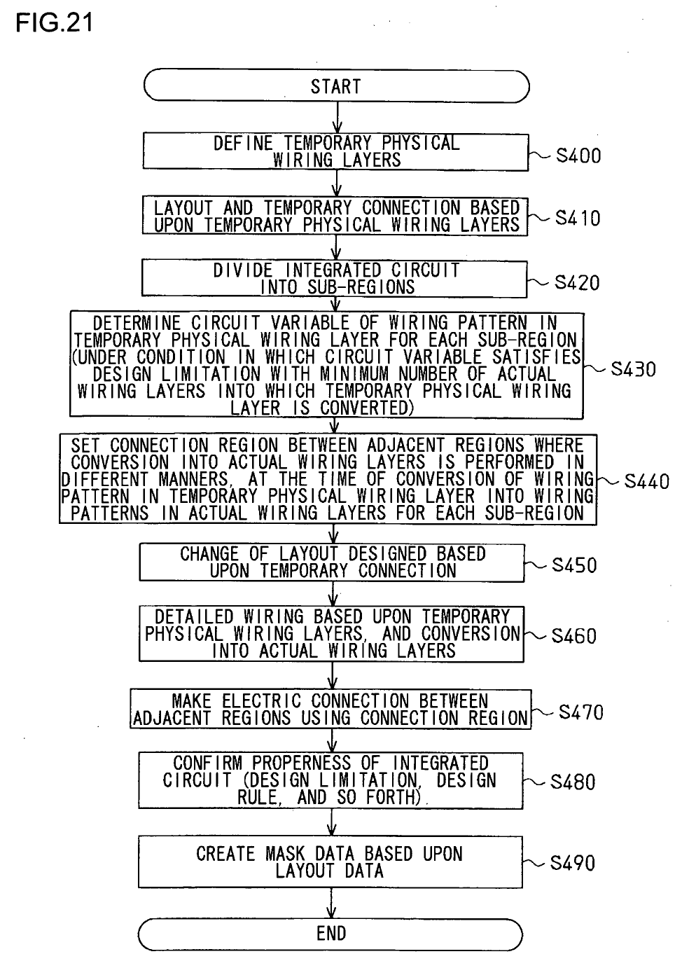

Detailed description will be made below regarding a design procedure for an integrated circuit according to the present embodiment with reference to FIG. 21.

With a series of the processing, first, in Step S400, the temporary physical wiring layers are defined in the same way as in Step S300 shown in FIG. 16.

Subsequently, in Step S410, the aforementioned automatic layout unit 22 performs automatic layout of the function cells based upon the temporary physical wiring layers. Furthermore, the automatic wiring unit 24 performs temporary connection. Examples of the temporary connection includes: Steiner wiring which connects two desired points with a straight line; and global connection performed using the trial and error method with a time limit. Such temporary connection is performed with a smaller computation load than that of the aforementioned detailed connection. Note that, in such temporary connection, short-circuits in the wiring may be permitted in this stage. Furthermore, in this processing, the circuit variables are estimated giving consideration to the following processing in which the wiring pattern of a certain temporary physical wiring layer is converted into the wiring patterns which generally have a mirror image relation therebetween, and which are provided to multiple wiring layers, for at least one region.

In the following Step S420, the division setting unit 42 shown in FIG. 15 divides the region in the integrated circuit, where the layout design has been performed by the aforementioned automatic layout wiring tool, into sub-regions in the same way as in Step S320 shown in FIG. 16.

In the following Step S430, the circuit variable determination unit 32 determines the upper limits and the lower limits of the circuit variables of the wiring for connecting the connections for each sub-region of the integrated circuit in which the aforementioned connection has been performed. That is to say, with the present embodiment, each circuit variable is not fixed to a single value, and the upper limit and the lower limit thereof are determined after determination of the number of the actual wiring layers. In this step, the circuit variables are determined so as to satisfy the design limits such as timing and so forth with the minimum number of the actual wiring layers into which the temporary physical wiring layer is converted.

Note that the aforementioned confirmation of whether or not timing thus obtained satisfies the design limitations is made by the timing analysis unit 30 based upon the layout data created on a temporary-connection basis at the time of timing analysis, giving consideration to the following points.

Specifically, in the aforementioned global wiring, short-circuits are permitted in the wiring as described above, for example. Let us say that timing analysis is performed for such an arrangement giving consideration to the coupling capacitance between the adjacent wiring patterns. In this case, the timing analysis is performed with the interval of the short-circuited patterns as the minimum permissible interval (unit pitch) at which the wiring patterns can be provided.

On the other hand, with the Steiner wiring, two desired portions are connected with a straight line, and accordingly, the wiring pattern does not matches the actual wiring pattern. Accordingly, timing analysis is performed with certain correction corresponding to the connection state after the Steiner wiring, for example. For example, the higher the density of the wiring is, the greater the coupling capacity between the adjacent wiring patterns, which is to be set.

Upon determination of the circuit variables in Step S430, the flow proceeds to Step 440. In Step S440, the division setting unit 42 extracts the boundary of the sub-regions where the conversion into the actual wiring patterns is performed in different manners, and determines the connection region for connecting these sub-regions, at the time of the conversion of the temporary physical wiring layer into the actual wiring layers for each sub-region.

In the following Step S450, the automatic layout unit 22 performs fine adjustment of the layout based upon information obtained from estimation calculated by the processing in the aforementioned Steps S430 and S440. Specifically, in Step S430, the number of the temporary physical wiring layers, which can be used for providing the wiring pattern, has been determined for each sub-region. Furthermore, in Step S440, the connection structure is determined for connecting the adjacent regions where conversion into the actual wiring layers is performed in different manners. Accordingly, the layout obtained in Step S410 is further subjected to fine adjustment based upon this information. Note that, in this step, fine adjustment is performed so as to realize the optimum layout while maintaining each circuit variable within a range between the lower limit and the upper limit determined in Step S430.

In the following Step S460, detailed wiring is performed, in which all the connection portions in the integrated circuit are connected based upon the temporary physical wiring layers. Furthermore, each of the wiring patterns obtained in this detailed wiring is converted into multiple wiring patterns provided to the actual wiring layers. In this step, detailed wiring is performed based upon the circuit properties estimated giving consideration to the following processing in which the wiring pattern of a certain temporary physical wiring layer is converted into the wiring patterns which generally have a mirror image relation therebetween, and which are provided to multiple wiring layers, for at least one region. Note that, in a case of employing global wiring as temporary wiring in the aforementioned Step S410, the detailed wiring is preferably performed using the wiring results thus obtained. Also, adjustment of the circuit variables may be made while estimating the temporary connections, again, instead of the aforementioned method. In this case, adjustment of the circuit variables is preferably made while maintaining each circuit variable within a range between the lower limit and the upper limit obtained in the aforementioned Step S430. Following this detailed wiring, the timing analysis unit 30 performs timing analysis, thereby determining the circuit variables in the final stage.

Following determination of the final circuit variables, the wiring layer conversion unit 34 converts the wiring pattern of the temporary physical wiring layer into the wiring patterns of the actual wiring layers based upon the final circuit variables. In other words, the wiring pattern of the temporary physical wiring layer is converted into the wiring patterns which generally have a mirror image relation therebetween, and which are provided to multiple wiring layers, for at least one region. Note that, in this step of conversion of the temporary physical wiring layer into the actual wiring layers, in order to allow wiring structures such as those shown in FIGS. 20A through 20E to be employed, the wiring pattern of the temporary physical wiring layer does not need to be converted into the wiring patterns having a strict mirror image relation therebetween.

Then, in Step S470, the regions are electrically connected using the connection region while maintaining the electric connection designed on the temporary physical wiring layers performed in the aforementioned Step S460 where detailed wiring has been performed.

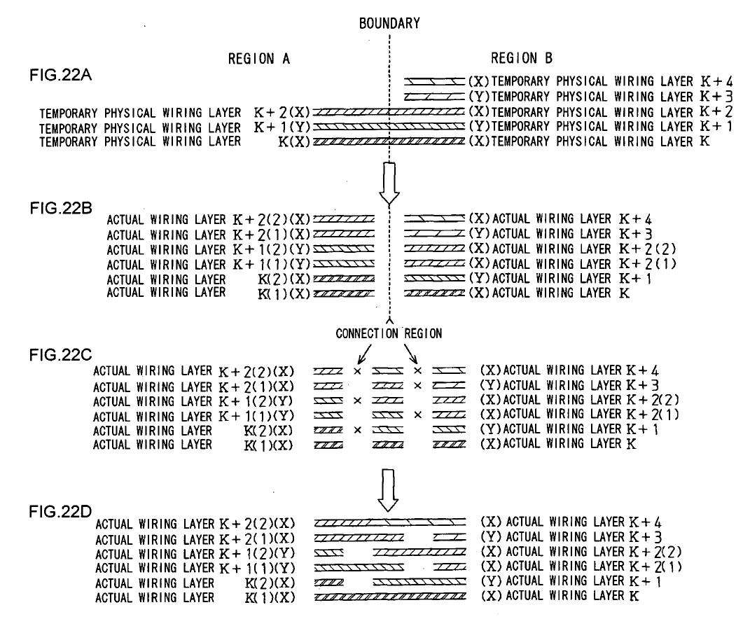

Specifically, setting of the connection region in the aforementioned Step S440 and the processing in Step S470 based upon the setting results are preferably performed according to a procedure shown in FIGS. 22A through 22D.

FIG. 22A shows adjacent regions A and B which include different numbers of the temporary physical wiring layers having wiring patterns. FIG. 22B shows conversion of the wiring patterns of the temporary physical wiring layers. In the step shown in FIG. 22C, in addition to the processing using the connection method for connecting the regions shown in FIGS. 18A through 18D, determination is made whether or not the wiring-extending direction of the actual wiring layer in the region A matches that of the corresponding one in the region B. In a case that these wiring-extending directions matches one another, determination is made whether or not the wiring patterns of the temporary physical wiring layers, from which these actual wiring layers have been converted, are connected with each other. Thus, determination is made whether or not these actual wiring layers in the regions A and B can be directly connected. Furthermore, in the processing in the aforementioned Step S470, the temporary physical wiring layer having a wiring pattern extending so as to pass across the boundary between the adjacent regions, which has been designed in Step S460, is converted into the wiring patterns provided to the actual wiring layers so as to maintain the connection relation. Thus, with the processing in Step S470, connection is made between the adjacent regions A and B using the aforementioned connection region, as shown in FIG. 22D.

As described above, with the present embodiment, in a case that the wiring-extending direction of an actual wiring layer in a region matches that of the corresponding actual wiring layer in the adjacent region, determination is made whether or not the actual wiring layers can be directly connected with each other. This reduces connections through different actual wiring layers. Specifically, let us consider an arrangement shown in FIG. 22A. In this arrangement, the region A includes only the temporary physical wiring layers K through K+2. On the other hand, the region B includes a greater number of the temporary physical wiring layers K through K+4. Accordingly, in a case that the temporary physical wiring layer K+2 in the region A and temporary physical wiring layer K+4 are to be electrically connected with each other, in design of the layout using the temporary physical wiring layers, these wiring layers are connected with each other through other wiring layers and intermediate insulating films. On the other hand, in design of the layout using the actual wiring layers, as shown in FIG. 22D, the actual wiring layer K+2(2) corresponding to the temporary physical wiring layer K+2 in the region A and the actual wiring layer K+4 corresponding to the temporary physical wiring layer K+4 in the region B are directly connected so as to create a single layer.

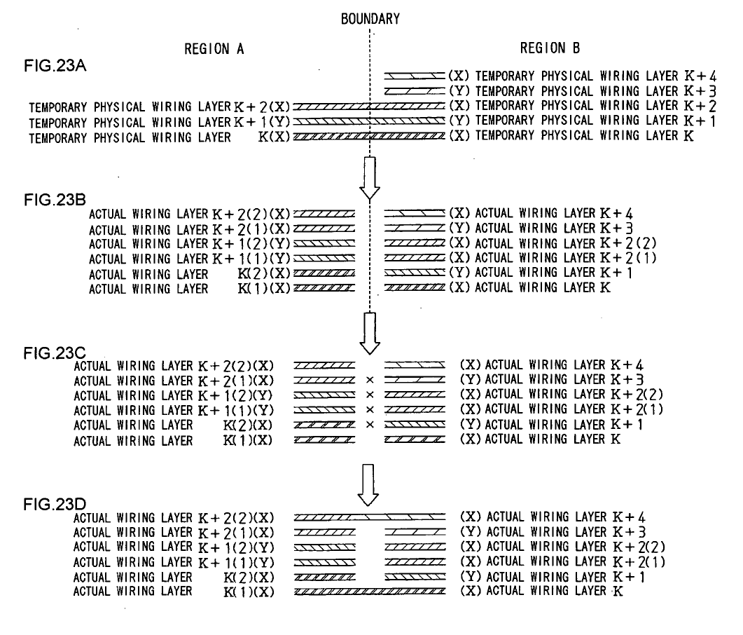

With the aforementioned connection between the regions A and B using such a connection region, each temporary wiring layer having a wiring pattern extending so as to pass across the boundary between these adjacent regions may be converted into the wiring patterns provided to multiple actual wiring layers without the condition of maintaining the connection relation designed on the temporary physical wiring layers. Description will be made below regarding such processing with reference to FIGS. 23A through 23D.

FIGS. 23A and 23B show the same states as shown in FIGS. 22A and 22B. In FIG. 23C, in a case that the actual wiring layer in the region A and the actual wiring layer in the region B are provided so as to extend in the same direction orthogonal to the boundary between the regions A and B, determination is made whether or not the actual wiring layers can be directly connected with each other. Then, in the processing in Step S470, as shown in FIG. 23D, the adjacent regions A and B are connected with each other. Note that, in this step, connection is made without maintaining the connection between the temporary physical wiring layers K+2 in the regions A and B, unlike a wiring structure shown in FIG. 23A.

Following connection between the adjacent region, the flow proceeds to Steps S480 and S490. In these Steps, the same processing is performed as in Steps S370 and S380, whereby the series of processing ends.

The present embodiment described above provides the following advantages, in addition to the aforementioned advantages of the aforementioned fourth embodiment.

(11) For example, let us consider a wiring structure in which the wiring patterns Lh1 through Lh3 are provided in parallel with each other, and are electrically connected with each other using the plugs pg12 through pg16 formed within via holes provided to multiple positions. In such a case, the present embodiment allows a desired layout of the via holes. This allows adjustment of the resistance of the signal-transmission path for transmitting a signal from the end L up to the end R.

(12) The present embodiment permits conversion of the wiring pattern of the temporary physical wiring layer into the wiring patterns of the actual wiring layer with different wiring lengths from one another. This allows adjustment of the resistance or the capacitance between the wiring patterns by adjusting the wiring lengths.

(13) The present embodiment permits conversion of the wiring pattern of the temporary physical wiring layer into the wiring patterns of the actual wiring layer with different wiring widths from one another. This allows adjustment of the resistance or the capacitance between the wiring patterns by adjusting the wiring widths.

(14) Layout/wiring is performed based upon the temporary physical wiring layer giving consideration to the following processing in which the wiring pattern of a certain temporary physical wiring layer is converted into the wiring patterns which generally have a mirror image relation therebetween, and which are provided to multiple wiring layers, for at least one region. This enables suitable layout design with respect to the layout of the cells and wiring paths.

### Sixth Embodiment

Description will be made below regarding a semiconductor integrated circuit and a design method thereof according to a sixth embodiment of the present invention, primarily regarding the difference as to the fourth embodiment as described above, with reference to the drawings.

With the aforementioned fourth embodiment, following layout and connection using the temporary physical wiring layers, the physical wiring layer is converted into the actual wiring layers in which the images thereof projected onto the substrate of the integrated circuit matches one another, for each sub-region. That is to say, the integrated circuit is two-dimensionally divided into sub-regions. Then, conversion into the actual wiring layers is performed for each sub-region thus obtained.

On the other hand, with the present embodiment, the integrated circuit is three-dimensionally divided into sub-regions with a certain number of temporary physical wiring layers as a unit depth in the depth direction. FIGS. 24A through 24F shows an example of division of the integrated circuit into sub-regions according to the present invention. Specifically, FIGS. 24A through 24F shows an example of division of the logic circuit unit 2 having temporary physical wiring layers K through K+7.

Here, FIG. 24A shows division of the temporary physical wiring layers K through K+4 in the logic circuit 2. On the other hand, the remaining temporary physical wiring layers of the logic circuit unit 2, K+5 through K+7 are converted into a region u shown in FIG. 24B, a region v shown in FIG. 24C and a region w shown in FIG. 24D, respectively. As described above, with the present embodiment, each of the temporary physical wiring layers K+5, K+6, and K+7 are converted into actual wiring layers in the same manner over the entire area.

With such an arrangement, the temporary physical wiring layers K through K+4 are subjected to the aforementioned series of processing shown in FIG. 14 in a manner shown in FIGS. 17A, 17B and 18A through 18D.

On the other hand, each of the temporary physical wiring layers K+5 through K+7 is converted into actual wiring layers by the processing in Step S230 based upon the circuit variables determined by the aforementioned processing in Step S220 shown in FIG. 14. FIGS. 24E and 24F show an example of such conversion of the temporary physical wiring layers into the actual wiring layers. Note that such conversion of each temporary physical wiring layer into actual wiring layers is preferably performed so as to create the wiring patterns which requires only a single mask for forming the wiring pattern on each actual wiring layer, as shown in FIGS. 2A-2D through 4A-4E, and so forth.

With the present embodiment described above, the integrated circuit is divided in the depth direction with a certain number of the temporary physical wiring layers as a depth unit. This allows adjustment of the circuit properties for each region thus obtained. Specifically, in general, the wiring on the uppermost layer of the integrated circuit is made with a long wiring length, leading to markedly increased wiring resistance. With the present embodiment, only the wiring pattern of this temporary physical wiring layer is converted into the wiring patterns shown in FIG. 2A-2D, for example, thereby suitably suppressing the resistance thereof.

The present embodiment described above provides the following advantages, in addition to the aforementioned advantages of the aforementioned fourth embodiment.

(15) With the present embodiment, the integrated circuit is divided in the depth direction with a certain number of the temporary physical wiring layers as a unit depth, as well as two-dimensionally dividing the integrated circuit. Then, conversion of each temporary physical wiring layer into the actual wiring layers is performed for each region thus obtained. This allows more suitable adjustment of the circuit properties of the integrated circuit.

### Seventh Embodiment

Description will be made below regarding a semiconductor integrated circuit and a design method thereof according to a seventh embodiment of the present invention, primarily regarding the difference as to the first embodiment as described above, with reference to the drawings.

With the aforementioned first embodiment, following connection based upon the temporary physical wiring layers, the wiring pattern of each temporary physical wiring layer is converted into the wiring patterns of the actual wiring layers. On the other hand, with the present embodiment, the temporary physical wiring layers and the actual wiring layers, into which each temporary physical wiring layer has been converted, are prepared beforehand, following which wiring is performed using an automatic wiring tool. Specifically, wiring is performed using the automatic wiring tool with the region in the lower layer or the upper layer, underneath or above the region having a wiring pattern to be adjusted for controlling the electric properties, being set to a forbidden region where automatic wiring using the automatic wiring tool is forbidden. Subsequently, each of the predetermined wiring patterns in the forbidden region is converted into wiring patterns having the same structures as those shown as examples in FIGS. 2A-2D through 4A-4E, FIGS. 10A-10C, 11A-11D, 20A-20E, and so forth. Note that the wiring forbidden region may be set in various manners. For example, the wiring forbidden region may be set in a manner such that the automatic layout is forbidden except for via holes. Also, the wiring forbidden region may be set in a manner such that the automatic layout including formation of via holes is forbidden. This controls the degree of freedom of formation of the wiring path and the wiring structure.

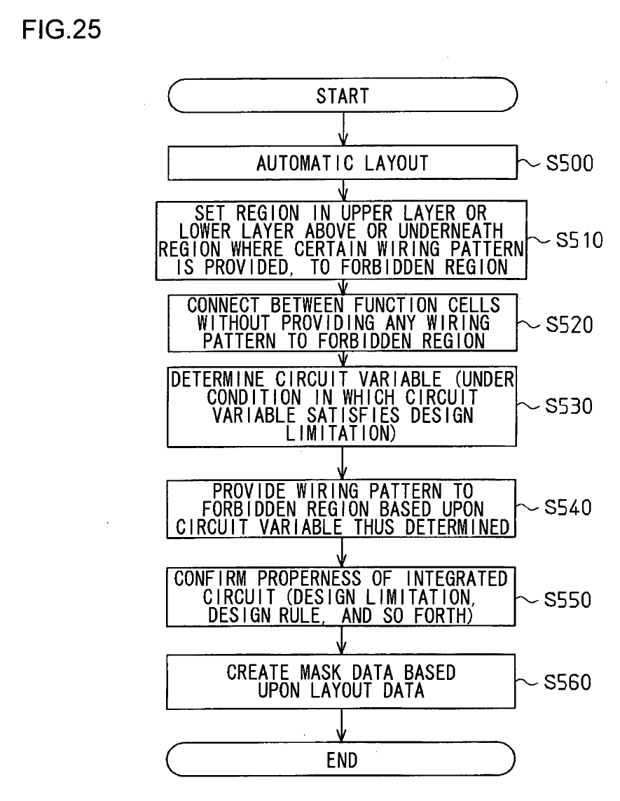

Description will be made regarding this processing with reference to FIGS. 25 through 28A-28C.

FIG. 25 is a flowchart which shows a design procedure for an integrated circuit according to the present invention. Note that this design procedure is performed using the aforementioned design support apparatus shown in FIG. 5.

With this series of processing, first, in Step S500, the automatic layout unit 22 performs automatic layout of the function cells in which circuit deign has already been performed.

In the following Step S510, a forbidden region is set for the region in the lower layer or the upper layer, underneath or above the region having a wiring pattern to be adjusted for controlling the electric properties thereof such as the resistance thereof, the capacitance between the wiring patterns, and so forth. Examples of such regions, which are preferably set to the forbidden regions, include a region for a bus wiring pattern, a region for a clock wiring pattern, and so forth. Furthermore, as the aforementioned lower wiring layer (upper wiring layer) underneath (above) the wiring layer including a wiring pattern to be adjusted, the adjacent layer just underneath (above) the wiring layer having such a wiring pattern is preferably employed.

Specifically, in order to set the forbidden region, the aforementioned wiring pattern to be adjusted, such as a bus wiring pattern, a clock wiring pattern, and so forth, bare identified based upon the circuit information or the like stored in the design specification storage unit 12. Then, the automatic wiring unit 24 is notified of the forbidden region determined based upon the information regarding the wiring pattern to be adjusted, through the input unit 50, for example.

In the following Step S520, the automatic wiring unit 24 makes wiring between the function cells except for the aforementioned forbidden regions.

Following connection between the function cells, in Step S530, the circuit variable determination unit 32 determines the circuit variables. The processing is performed as follows, for example. That is to say, the circuit variable calculation unit 20 calculates the circuit variables which can be obtained by converting the aforementioned wiring pattern into the wiring patterns provided to two wiring layers having any one of the structures shown as examples in FIGS. 2A-2D through 4A-4E, and FIGS. 10A-10C, 11A-11D, 20A-20E, and so forth, Then, the timing analysis unit 30 performs timing analysis based upon the circuit variables calculated by the circuit variable calculation unit 20. Then, the circuit variables are determined so as to satisfy the design limitation based upon the analysis results obtained by the timing analysis unit 30.

In the following Step S540, the wiring layer conversion unit 34 provides a wiring pattern to the forbidden region based upon the circuit variables thus determined. Then, in Steps S550 and S560, the same processing is performed as in Steps S140 and S150 shown in FIG. 6.

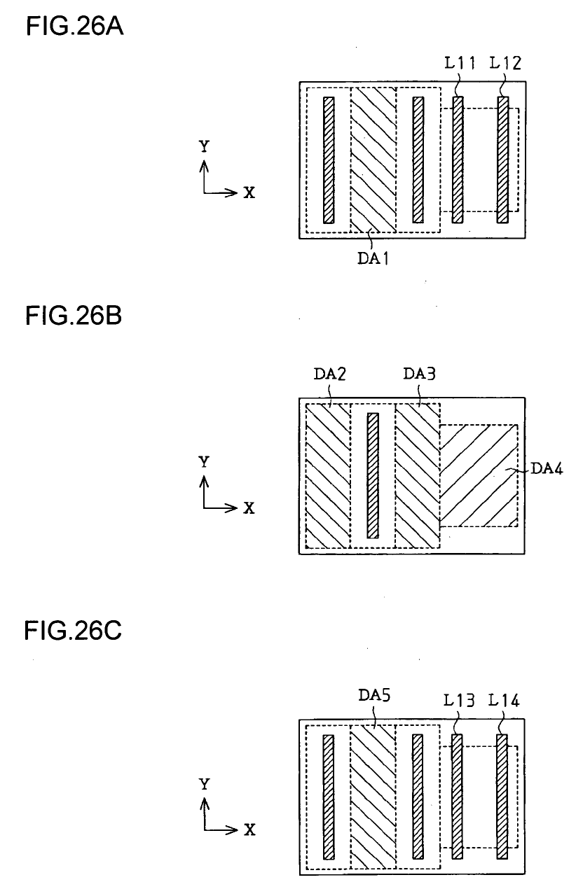

For example, FIGS. 26A through 26C show multiple actual wiring layers K(3) through K(1) where the conversion of a temporary physical wiring layer K is performed.

Prior to wiring by the automatic wiring tool, the forbidden regions are set in these actual wiring layers K(3) through K(1), as the regions where the conversion of the temporary physical wiring layer is performed. Specifically, FIG. 26A shows a wiring forbidden region DA1 set in the actual wiring layer K(3). FIG. 26B shows wiring forbidden regions DA2, DA3, and DA4 set in the actual wiring layer K(2) FIG. 26C shows a wiring forbidden regions DA5 set in the actual wiring layer K(1). Note that the forbidden region DA4 shown in FIG. 26B forbids wiring and formation (automatic layout) of through via holes (though holes connecting the upper layer and the lower layer with each other). The other forbidden regions DA1, DA2, DA3, and DA5 forbid wiring, but permit formation of through via holes. Furthermore, as shown in FIG. 26A, the actual wiring layer K(3) includes predetermined wiring patterns L11 and L12. Also, as shown in FIG. 26C, the actual wiring layer K(1) includes predetermined wiring patterns L13 and L14.

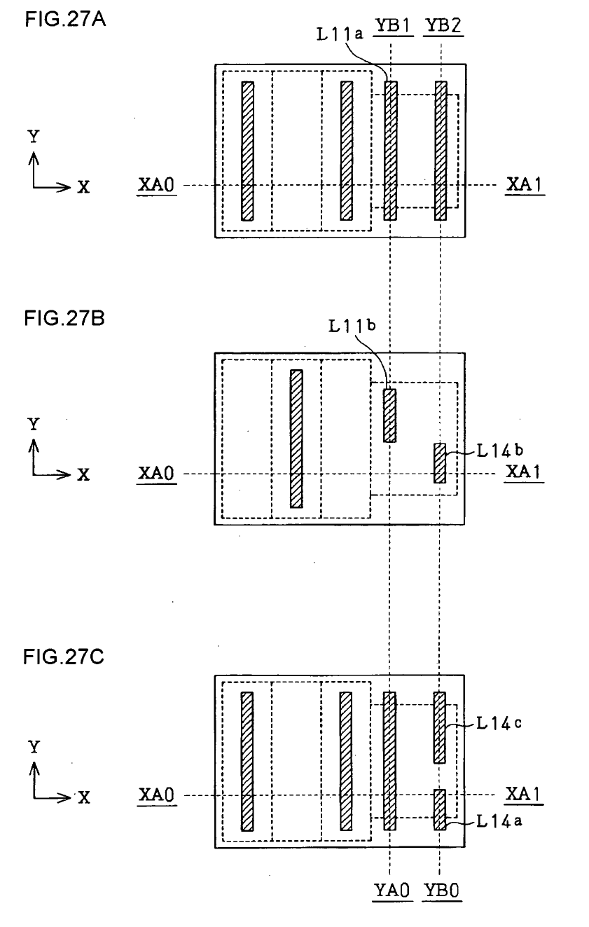

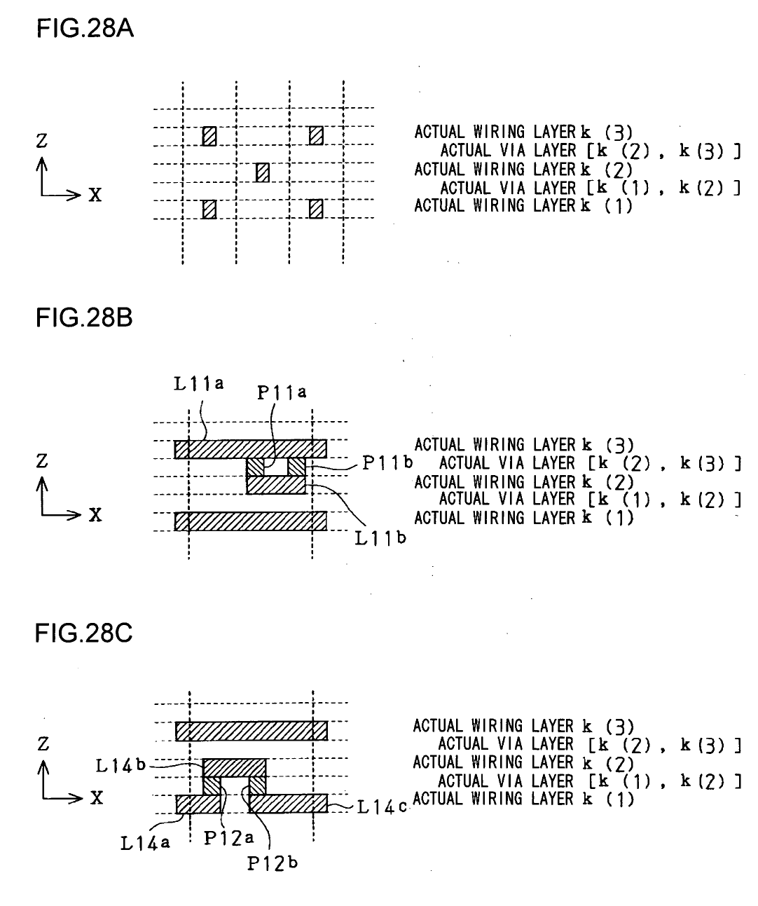

FIGS. 27A through 27C, and FIGS. 28A through 28C show the actual wiring layers K(3) through K(1) where the conversion of the temporary physical wiring layer K has been performed after connection. In this case, the wiring pattern L11 of the temporary physical layer K is converted into wiring patterns L11a and L11b and plugs P11a and P11b provided to the actual wiring layers K(2) and K(3) based upon the circuit variables thus determined. Furthermore, the wiring pattern L14 of the temporary physical wiring layer K is converted into wiring patterns L14a, L14b, and L14c and plugs P12a and P12b provided to the actual wiring layers K(1) and K(2) based upon the circuit variables thus determined.

The present embodiment described above provides the same advantages as the advantages (1) through (3) of the aforementioned first embodiment, the advantages (6) and (7) of the aforementioned second embodiment, and the advantages (11) through (13) of the aforementioned fifth embodiment.

### Eighth Embodiment

Description will be made below regarding a semiconductor integrated circuit and a design method thereof according to an eighth embodiment of the present invention, primarily regarding the difference as to the second embodiment as described above, with reference to the drawings.

With a semiconductor integrated circuit according to the present embodiment, the aforementioned logic circuit unit 2 further includes a wiring pattern shown in FIGS. 29A through 29E. FIG. 29A shows a circuit diagram of the wiring pattern included in the logic circuit unit 2. Specifically, FIG. 29A shows a wiring structure in which a signal-transmission wiring pattern Lm1 is shielded by wiring pattern Lm2 and Lm3 fixed to the power supply electric potential and the ground electric potential, respectively.

FIGS. 29B through 29E shows a wiring structure corresponding to the circuit diagram shown in FIG. 29A. FIGS. 29B and 29C are plan views of the aforementioned wiring patterns Lm1 through Lm3 provided to the (n+1)'th wiring layer and the n'th wiring layer. Here, the face of each wiring layer is a plane defined by the x and y axes. Furthermore, let us say that the wiring patterns are provided in the X direction. On the other hand, FIGS. 29D and 29E are cross-sectional views of the wiring patterns Lm2 and Lm3, respectively. Here, the direction orthogonal to the xy plane is defined as the z direction. As shown in FIGS. 29D and 29E, the wiring layer where the wiring pattern Lm2 is provided is switched through a plug pg17. On the other hand, the wiring layer where the wiring pattern Lm3 is provided is switched through a plug pg18.

As described above, with the wiring patterns Lm2 and Lm3 for shielding the signal-transmission wiring pattern Lm1 provided to the n'th wiring layer according to the present embodiment, the wiring layer where the wiring patterns Lm2 (Lm3) is provided is switched between the n'th wiring layer and (n+1)'th wiring layer. This allows adjustment of the capacitance between the signal-transmission wiring pattern Lm1 and the wiring pattern Lm2, and the capacitance between the signal-transmission wiring pattern Lm1 and the wiring pattern Lm3. More specifically, as shown in FIG. 29C, a part of the wiring pattern Lm2 (Lm3) is provided to the n'th wiring layer at a position adjacent to the signal-transmission wiring pattern Lm1. Furthermore, as shown in FIG. 29B, the other part of the wiring pattern Lm2 (Lm3) is provided to the (n+1)'th wiring layer. Such a wiring structure reduces the capacitance between the wiring patterns Lm1 and Lm2, and the capacitance between the wiring patterns Lm1 and Lm3. Thus, such a wiring structure improves the signal transmission speed while providing sufficient shielding effects as compared with an arrangement in which the entire wiring patterns Lm2 and Lm3 are provided to the n'th wiring layer, at positions adjacent to the signal-transmission wiring pattern Lm1.

Furthermore, with the present embodiment, the wiring layer where the wiring pattern Lm2 (Lm3) is provided may be switched in various manners. This allows a wiring structure in which the wiring patterns Lm2 and Lm3 fixed to certain electric potentials are provided to the n'th wiring layer with different wiring lengths, at positions adjacent to the signal-transmission wiring pattern Lm1, for example. More specifically, this allows a wiring structure shown in FIGS. 29A through 29E in which the wiring pattern Lm3 fixed to the ground electric potential is provided with a greater wiring length than that of the wiring pattern Lm2 fixed to the power-supply electric potential. Such a wiring structure provides signal-transmission properties of the signal-transmission wiring pattern Lm1 in which a signal is transmitted with a relatively reduced rise time as compared with the fall time.

As described above, with such a wiring structure formed of the signal-transmission wiring pattern Lm1 and the wiring patterns Lm2 and Lm3 fixed-to certain electric potentials, these wiring patterns may be provided at positions adjacent to one another in various manners. This allows adjustment of the signal transmission speed and the signal shape with which a signal is transmitted through the wiring pattern Lm1.

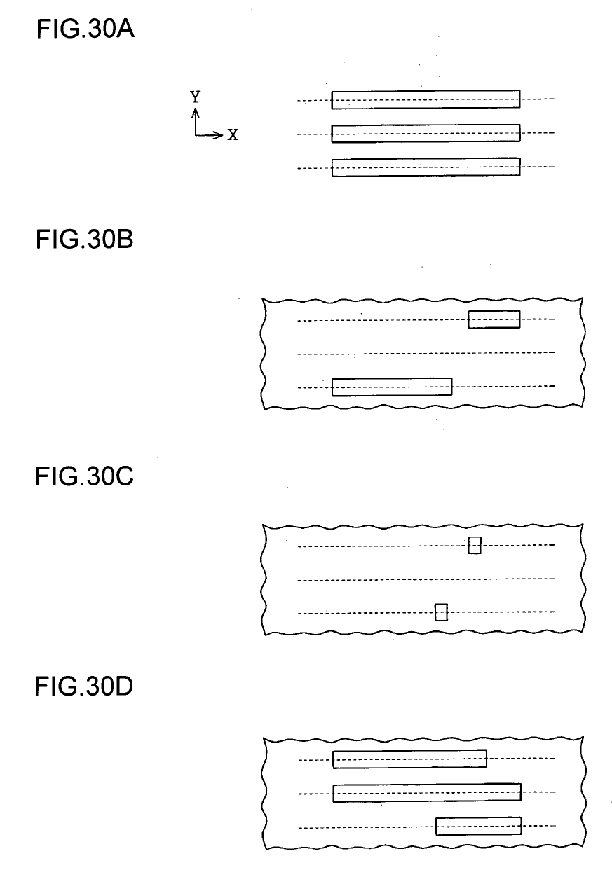

The integrated circuit having such a wiring structure according to the present invention can be designed according to the design procedure shown in FIG. 6. That is to say, first, in the aforementioned Step S110, layout design is performed using the temporary physical wiring layers, whereby the layout data of the wiring patterns shown in FIG. 30A is obtained based upon the circuit diagram shown in FIG. 29A. Furthermore, in the aforementioned Steps S120 and S130, the wiring pattern of each temporary physical wiring layer is converted into the wiring patterns of the actual wiring layers, thereby obtaining the layout data of the wiring structure shown in FIGS. 29B through 29E. Then, in the aforementioned Step S150, the mask data shown in FIGS. 30B through 30D is created. Here, FIG. 30B shows the mask data for the (n+1)'th wiring layer. FIG. 30C shows the mask data for via holes formed between the (n+1)'th wiring layer and n'th wiring layer. FIG. 30D shows the mask data for the n'th wiring layer.

The present embodiment described above provides the following advantages, in addition to the advantages (1) through (3) and (5) of the aforementioned first embodiment, and the advantages (6) and (7) of the aforementioned second embodiment.

(16) With the present embodiment, the wiring layer, where the wiring pattern Lm2 (Lm3) for shielding the signal-transmission wiring pattern Lm1 of the n'th wiring layer is provided, is switched between the n'th wiring layer and (n+1)'th wiring layer. This allows adjustment of the capacitance between the signal-transmission wiring pattern Lm1 and the wiring pattern Lm2 (Lm3).

### Ninth Embodiment

Description will be made below regarding a semiconductor integrated circuit and a design method thereof according to a ninth embodiment of the present invention, primarily regarding the difference as to the eighth embodiment as described above, with reference to the drawings.

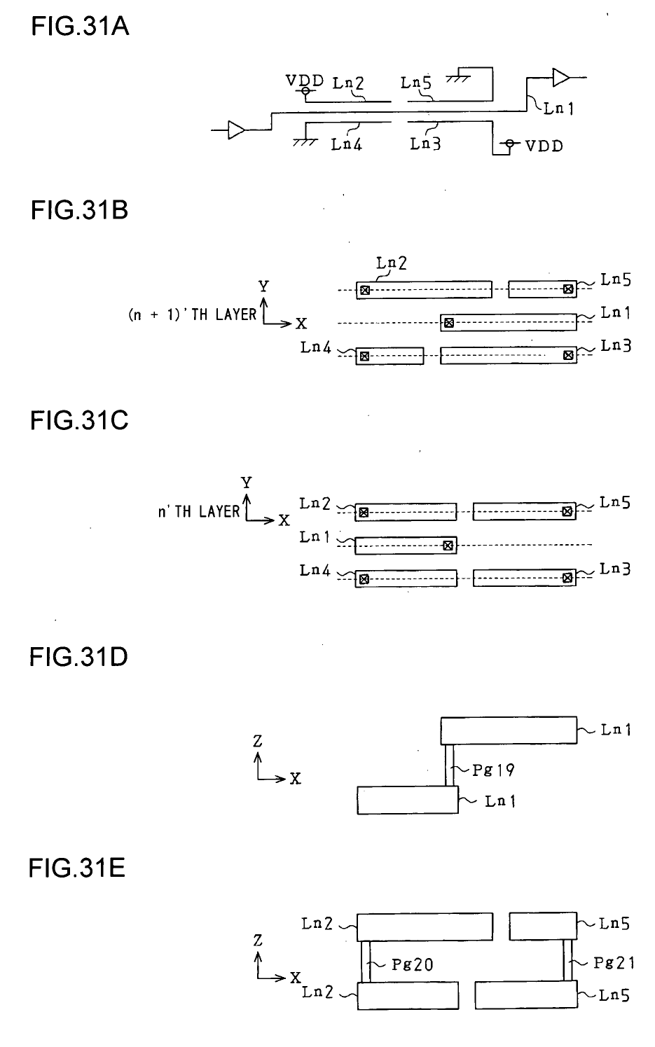

With a semiconductor integrated circuit according to the present embodiment, the aforementioned logic circuit unit 2 further includes a wiring pattern shown in FIGS. 31A through 31E. FIG. 31A shows a circuit diagram of the wiring pattern included in the logic circuit unit 2. Specifically, FIG. 31A shows a wiring structure in which a signal-transmission wiring pattern Ln1 is shielded by wiring pattern Ln2 and Ln3 fixed to the power supply electric potential, and wiring pattern Ln4 and Ln5 fixed to the ground electric potential.

FIGS. 31B through 31E shows a wiring structure corresponding to the circuit diagram shown in FIG. 31A. FIGS. 31B and 31C are plan views of the aforementioned wiring patterns Ln1 through Ln5 provided to the (n+1)'th wiring layer and the n'th wiring layer. Here, the face of each wiring layer is a plane defined by the x and y axes. Each wiring pattern is provided so as to extend in the x direction. On the other hand, FIGS. 31D and 31E are cross-sectional views of the wiring patterns Ln1, Ln2, and Ln5. Here, the direction orthogonal to the xy plane is defined as the z direction. As shown in FIGS. 31D, the wiring layer where the wiring pattern Ln1 is provided is switched through a plug pg19. Also, as shown in FIGS. 31E, the wiring pattern Ln2 is formed over the two adjacent wiring layers through a plug pg20. The wiring pattern Ln5 is formed over the two adjacent wiring layers through a plug pg21.

With such an arrangement, the wiring patterns Ln2 through Ln5 are provided to the n'th wiring layer with the same wiring length. Furthermore, the signal-transmission wiring pattern Ln1 is provided to a region between the wiring patterns Ln2 and Ln5 and the wiring patterns Ln3 and Ln4. On the other hand, in the (n+1)'th wiring layer, the wiring length of the wiring patterns Ln2 and Ln3 fixed to the power-supply electric potential is different from that of the wiring patterns Ln4 and Ln5 fixed to the ground electric potential. Accordingly, in the (n+1)'th wiring layer, the signal-transmission wiring pattern overlaps with the adjacent wiring patterns Ln2 and Ln3 with a length different from that with the adjacent wiring patterns Ln4 and Ln5.

Specifically, in an example shown in FIGS. 31A through 31E, the signal-transmission wiring pattern Ln1 overlaps with the adjacent wiring patterns Ln4 and Ln5 fixed to the ground electric potential with a shorter length than with the adjacent wiring patterns Ln2 and Ln3 fixed to the power-supply electric potential. Such a wiring structure provides signal-transmission properties of the signal-transmission wiring pattern Ln1 in which a signal is transmitted with a relatively reduced rise time as compared with the fall time. As described above, with such a wiring structure formed of the signal-transmission wiring pattern Ln1 and the wiring patterns Ln2 through Ln5 fixed to certain electric potentials, these wiring patterns may be provided at positions adjacent to one another in various manners. This allows adjustment of the signal transmission speed and the signal shape with which a signal is transmitted through the wiring pattern Ln1.

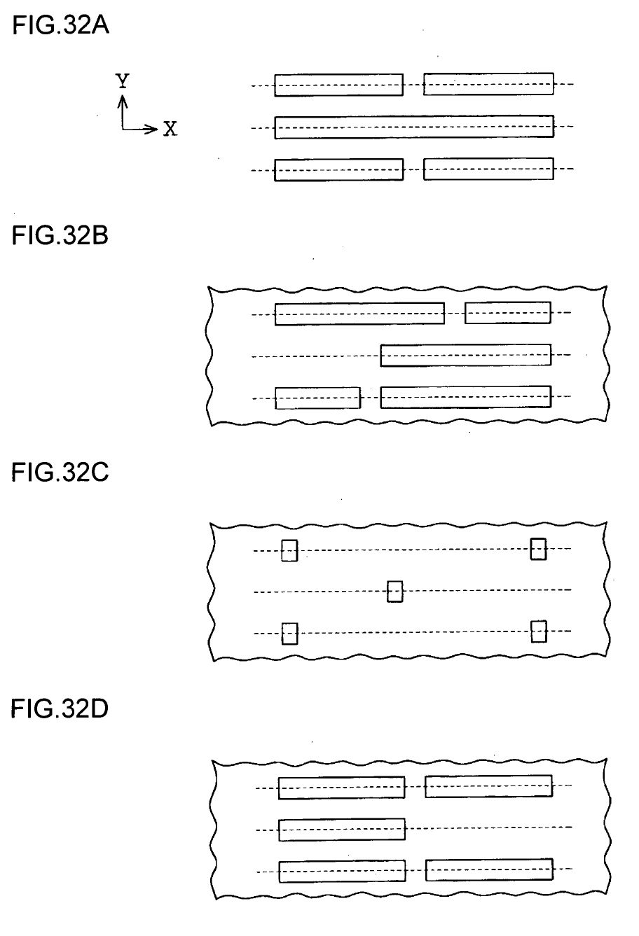

The integrated circuit having such a wiring structure according to the present invention can be designed according to the design procedure shown in FIG. 6. That is to say, first, in the aforementioned Step S110, layout design is performed using the temporary physical wiring layers, whereby the layout data of the wiring patterns shown in FIG. 32A is obtained based upon the circuit diagram shown in FIG. 31A. Furthermore, in the aforementioned Steps S120 and S130, the wiring pattern of each temporary physical wiring layer is converted into the wiring patterns of the actual wiring layers, thereby obtaining the layout data of the wiring structure shown in FIGS. 31B through 31E. Then, in the aforementioned Step S150, the mask data shown in FIGS. 32B through 32D is created. Here, FIG. 32B shows the mask data for the (n+1)'th wiring layer. FIG. 32C shows the mask data for via holes formed between the (n+1)'th wiring layer and n'th wiring layer. FIG. 32D shows the mask data for the n'th wiring layer.

The present embodiment described above provides the following advantages, in addition to the advantages (1) through (3) and (5) of the aforementioned first embodiment, the advantages (6) and (7) of the aforementioned second embodiment, and the advantage (16) of the aforementioned eighth embodiment.

### Tenth Embodiment

The aforementioned embodiments may be modified as follows.

In a case that the circuit properties such as timing and so forth are satisfied with a sufficient margin in the aforementioned step S140, S240, S370, S480, or the like, the actual wiring layers thus converted may be converted into a reduced number of actual wiring layers. In other words, in this case, inverse conversion of the aforementioned conversion, in which the temporary physical wiring layer is converted into the actual wiring layers, may be performed. That is to say, in this case, the patterns of the actual wiring layers shown in FIG. 2A-2D may be converted into a reduced number of the wiring patterns shown in FIGS. 7A through 7C, for example.

A wiring structure having a pair of adjacent wiring patterns with increased capacitance therebetween is not restricted to the aforementioned example shown in FIG. 4A-4E. Also, an arrangement may be made as shown in FIGS. 33A and 33B, for example.

FIG. 33A shows a wiring structure including two adjacent pairs of wiring patterns (a pair of wiring patterns Lo1 and Lo2, and a pair of wiring patterns Lo3 and Lo4) with the wiring patterns forming each pair being provided to separate wiring layers, and being connected in parallel with each other. Furthermore, these two pair of wiring patterns are provided to the same wiring layers. Specifically, the wiring patterns Lo1 and Lo2 are connected in parallel with each other using plugs pg22 and pg23. On the other hand, the wiring patterns Lo3 and Lo4 are connected in parallel with each other using plugs pg24 and pg25. The wiring patterns Lo1 and Lo3 are formed in the same wiring layer. The same can be said of the wiring patterns Lo2 and Lo4.

FIG. 33B shows a wiring structure including two adjacent pairs of wiring patterns (a pair of wiring patterns Lp1 and Lp2, and a pair of wiring patterns Lp3 and Lp4) with the wiring patterns forming each pair being provided so as to extend in parallel with a mirror image relation therebetween, and being connected in serial with each other. Specifically, the wiring patterns Lp1 and Lp2 are connected in serial with each other using a plug pg26. On the other hand, the wiring patterns Lp3 and Lp4 are connected in serial with each other using a plug pg27. The wiring patterns Lp1 and Lp3 are formed in the same wiring layer. The same can be said of the wiring patterns Lp2 and Lp4.

Also, an arrangement may be made having the same wiring structure as that shown in FIG. 4A-4E, except that either of the wiring pattern Lb1 or Lb2 is not connected to the corresponding wiring pattern La1 or La2. With such an arrangement, the wiring pattern formed of the wiring pattern Lb1 or Lb2 and the corresponding wiring pattern La1 or La2 of the (n+1)'th wiring layer connected with each other serves as a dummy wiring pattern with one end being opened. A wiring pattern connected to the dummy wiring pattern has the capacitance between the dummy wiring pattern and the wiring pattern adjacent thereto. Thus, with such an arrangement, the wiring pattern connected to the dummy wiring pattern has the increased capacitance with the adjacent wiring patterns.

Note that the aforementioned pair of the wiring patterns shown in FIGS. 33A and 33B is preferably formed of at least one of the wiring patterns as follows

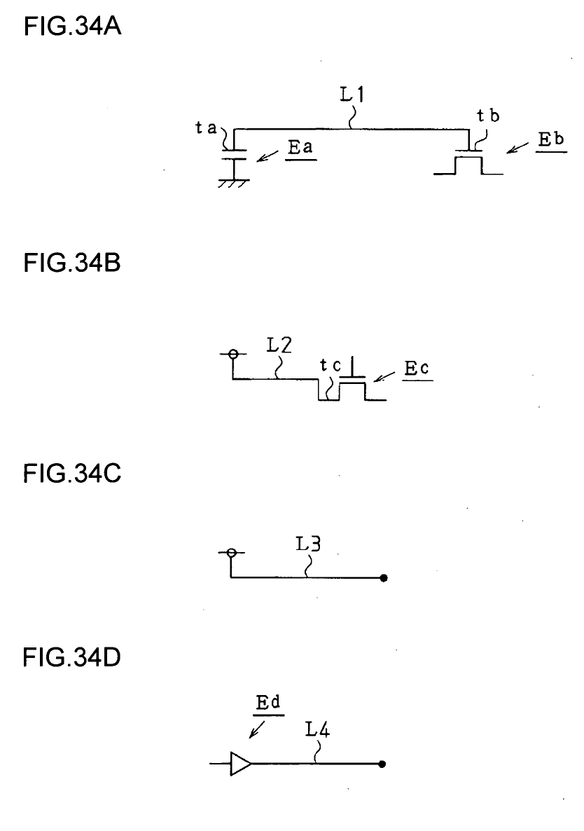

a) the wiring pattern L1 which connects predetermined terminals ta and tb of two desirable device elements Ea and Eb included in the integrated circuit shown in FIG. 34A.

b) the wiring pattern L2 for fixing the electric potential of a predetermined terminal tc of a desired device element Ec included in the integrated circuit shown in FIG. 34B.

Note that the aforementioned wiring pattern shown in FIG. 2A-2D is preferably formed of a wiring pattern for connecting two determined terminals such as a wiring pattern for connecting the predetermined terminals ta and tb of two desirable device elements Ea and Eb included in the integrated circuit as shown in FIG. 34A.

Also, wiring structures according to the present invention are not restricted to those shown in FIGS. 2A-2D, 3A-3D, 4A-4E, 10A-10C, 11A-11D, 13A, 13B, 20A-20E, 29A-29E, 31A-31E, 33A-33B, and so forth. Any modification may be made as long as maintaining a wiring structure in which wiring patterns are provided to multiple wiring layer with the images thereof projected to the substrate of the integrated circuit generally matching one another, and with the wiring patterns being connected with each other using via holes.

Note that the wiring pattern having such a wiring structure is preferably formed of at least one of the wiring patterns as follows.

a) the wiring pattern L1 which connects predetermined terminals ta and tb of two desirable device elements Ea and Eb included in the integrated circuit as shown in FIG. 34A.

b) the wiring pattern L2 for fixing the electric potential of a predetermined terminal tc of a desired device element Ec included in the integrated circuit as shown in FIG. 34B.

c) the wiring pattern L3 in which the electric potential thereof is fixed, and one end thereof is opened, as shown in FIG. 34C.

d) the wiring pattern L4 in which one end thereof is connected to a terminal of a predetermined device element Ed, and the other end is opened, as shown in FIG. 34D.

Description has been made in the aforementioned embodiments regarding an arrangement in which, after design of the layout based upon the layout data, the mask data is created based upon the results of the layout design. The present invention is not restricted to such an arrangement. For example, an arrangement may be made in which layout and connection is performed using the automatic layout wiring tool based upon the mask data. Also, conversion into the actual wiring layers is performed based upon the mask data.

Also, an arrangement in which a region is divided into sub-regions according to the aforementioned sixth embodiment may be applied to an arrangement according to the fifth embodiment.

Also, the wiring structure shown in FIGS. 20A through 20E may be employed in the aforementioned second through fourth embodiments, and the sixth embodiment.

An arrangement in which the division setting unit 42 divides a region into sub-regions according to the present invention is not restricted to the aforementioned arrangements shown in FIGS. 17 and 24. Each sub-region is not restricted to a rectangular region. A region designed using an automatic wiring tool is not restricted to the logic circuit unit.

An arrangement in which forbidden regions are set for a wiring layer according to the aforementioned seventh embodiment is not restricted to an arrangement in which the forbidden regions are set for a single wiring layer alone. Also, an arrangement may be made in which forbidden regions are set for multiple layers selected from the lower layers or the upper layers, underneath or above the region having a wiring pattern to be adjusted for controlling the electric properties thereof. Then, connection is performed for these wiring layers with the forbidden regions.

A design procedure for an integrated circuit according to the present invention is not restricted to the arrangements described in the aforementioned embodiments.

For example, the design procedures described below may be employed.

Design procedure 1: i) Automatic layout is performed using the temporary physical wiring layers using conventional techniques, following which temporary connection is performed on the temporary physical wiring layers with a smaller calculation load than that of the final-stage connection, so as to estimate the wiring paths on the temporary physical wiring layers. In this step, temporary connection is made giving consideration to the following processing in which the wiring pattern of a certain temporary physical wiring layer is converted into the wiring patterns which generally have a mirror image relation therebetween, and which are provided to multiple wiring layers, for at least one region. ii) The final-stage connection is made based upon the estimation results of the aforementioned wiring paths. iii) The aforementioned conversion of a certain temporary physical wiring layer is performed based upon the circuit properties corresponding to the aforementioned estimation results of the wiring paths.

Design procedure 2: i) Layout is performed based upon the circuit properties giving consideration to the following processing in which the wiring pattern of a certain temporary physical wiring layer is converted into the wiring patterns which generally have a mirror image relation therebetween, and which are provided to multiple wiring layers, for at least one region. (ii) Connection is performed each portion in the integrated circuit based upon the temporary physical wiring layers using conventional techniques. iii) The wiring pattern of a certain wiring layer selected from the temporary physical wiring layers is converted to the wiring patterns which generally have a mirror image relation therebetween, and which are provided to multiple wiring layers, for at least one region.

With layout design in Step S310 shown in FIG. 16, after layout, cost conditions may be determined for wiring processing for each of sub-regions into which the integrated circuit is divided. With such an arrangement, connection is made for each portion of the integrated circuit so as to satisfy the cost conditions thus determined.

Specifically, a high cost condition is set for a region which particularly requires conversion into the actual wiring layers for adjustment of the circuit variables therein, such as a region which requires high-speed operation and so forth. This reduces the number of the temporary physical wiring layers used for providing the wiring patterns in this region. Accordingly, the temporary physical wiring layer can be converted into the actual wiring layers with higher priority. In other words, such a region which requires special circuit properties such as high-speed operation and so forth is set to a region where the number of the temporary physical wiring layers which can be used for providing the wiring patterns is reduced. Thus, the temporary physical wiring layer can be converted into an increased number of the actual wiring layers in such a region with higher priority, thereby markedly improving the circuit properties.

An integrated circuit having a wiring structure as shown in FIGS. 2A-2D, 3A-3D, 4A-4E, 10A-10C, 11A-11D, 13A-13B, 20A-20E, 29A-29E, 31A-31E, 33A-33B, and so forth, is not restricted to an arrangement obtained by design according to the aforementioned embodiments and modifications thereof. Also, the integrated circuit having any one of the wiring structures shown in FIGS. 2A-2D, 3A-3D, 4A-4E, 10A-10C, 11A-11D, 13A-13B, 20A-20E, 29A-29E, 31A-31E, 33A-33B, and so forth, may be designed based upon the layout created by a conventional automatic wiring tool, with the wiring patterns provided to adjacent wiring layers being orthogonal to one another. Specifically, let us say that high-speed operation or the like is required for a certain region. In this case, in order to provide a wiring structure to such a region with a lower resistance, two wiring layers may form such a structure with another wiring layer (intermediate wiring layer) introduced therebetween as shown in FIG. 20A. Specifically, the third wiring layer and the fifth wiring layer may form such a wiring structure, for example. With such a wiring structure, the intermediate wiring layer may be provided so as to extend in the direction orthogonal to the wiring-extending direction of the wiring patterns Lg1 and Lg2, and may cross the space between the wiring patterns Lg1 and Lg2.

The present invention is not restricted to an arrangement employing the standard cell method. Also, the design method according to the present invention may be applied to a gate array. Also, the present invention may be applied to various kinds of wiring design for an integrated circuit employing a multi-layer structure.

Description has been made in the aforementioned embodiments regarding computation means for converting the wiring pattern of a certain temporary physical wiring layer into the wiring patterns which generally have a mirror image relation therebetween, and which are provided to multiple wiring layers, for at least one region, thereby enabling adjustment of the circuit properties to desirable values for the wiring pattern provided to the aforementioned temporary physical wiring layer. Such computation means are not restricted to the arrangements described in the aforementioned embodiments. Also, such computation means may be formed of dedicated hardware means, instead of software and a program, for example.

Description has been made in the aforementioned embodiments regarding the division setting unit 42 as computation means for setting a connection layer used for connecting the adjacent regions where conversion into the wiring patterns provided to the actual wiring layers is performed in different manners. Such computation means is not restricted to the division setting unit 42 described above. For example, such computation means may be formed of dedicated hardware means, instead of software and a program.

Description has been made in the aforementioned first through sixth embodiments and the modifications thereof regarding a design method for converting a certain temporary wiring layer into the actual wiring layers for each region where design is performed using an automatic layout wiring tool. The present invention is not restricted to such an arrangement. For example, after temporary connection, the wiring pattern of a certain temporary physical wiring layer may be converted into the wiring patterns which generally have a mirror image relation therebetween, and which are provided to multiple wiring layers, for at least one region, even in a case of design without using any automatic wiring tool. This allows adjustment of the circuit properties without change of design. Examples of circuits to be designed without using the automatic wiring tool include analog macros formed of analog device elements and so forth, such as a D/A converter, A/D converter, and so forth.

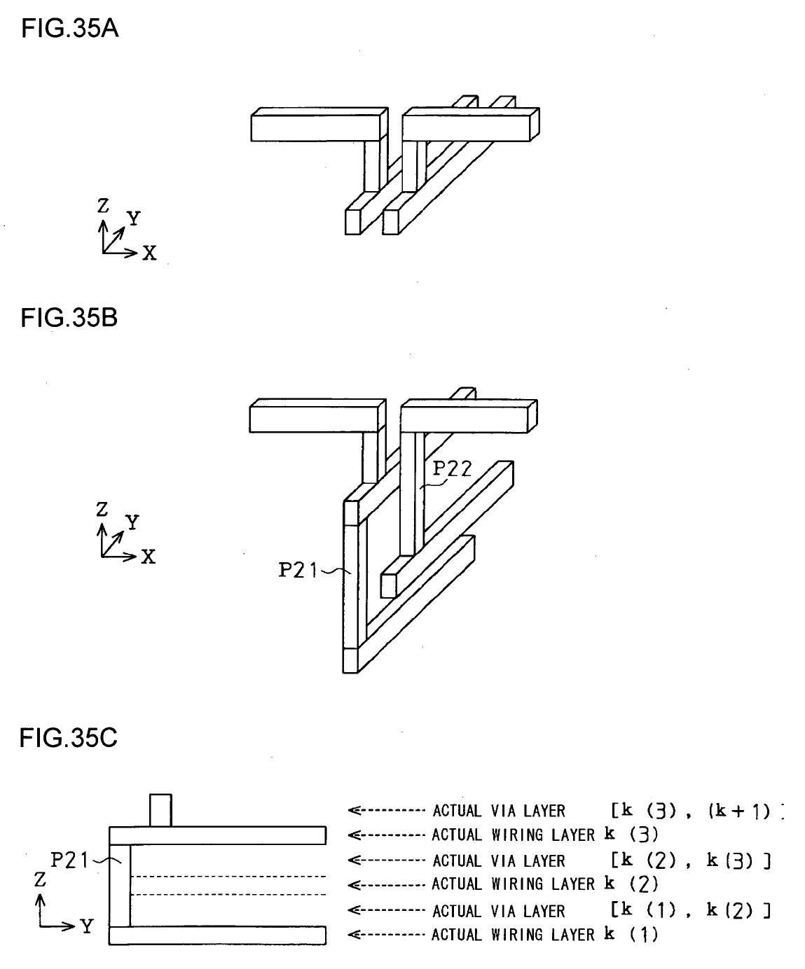

Description has been made in the aforementioned embodiments regarding actual wiring layers into which the temporary physical wiring layer has been converted. With such actual wiring layers, the positions of the plugs may be changed as appropriate. For example, let us say that a wiring structure created based upon the temporary physical wiring layers shown in FIG. 35A is converted into a wiring structure formed of multiple physical wiring patterns as shown in FIG. 35B. FIG. 35C is a cross-sectional view of the wiring structure formed of the actual wiring layers thus converted, as viewed from the X direction. With such a wiring structure, adjacent plugs (formed within via holes) P21 and P22 indicated by arrows are formed with a certain offset in the X direction so as to not overlay or overlap one another in this direction. Note that, with such a wiring structure, these plugs are formed at positions with a certain offset in the Y direction so as to not overlay or overlap one another in this direction, depending upon the wiring-extending direction.

Also, the temporary physical wiring layer may be converted into the actual wiring layers with plugs being formed at desired positions in an actual via layer between the actual wiring layers. This allows a wiring structure as shown in FIG. 13A in which the plugs are formed at positions so as to overlay one another in the X direction or the Y direction, thereby increasing the capacitance between the plugs. Conversely, as shown in FIG. 35B, an arrangement may be made in which the plugs are formed at positions so as to not overlay one another in any direction, thereby reducing the capacitance between the plugs. This reduces cross-talk noise. As described above, adjustment of the positions, where the plugs (via holes) are formed, allows adjustment of the capacitance of the wiring patterns without changing any wiring path, thereby enabling a circuit exhibiting desired electric properties.

Also, with the aforementioned embodiments, in the step where the wiring pattern designed on the temporary physical wiring layer is converted into wiring patterns on the actual wiring layers, wiring separation layers (insulating layers formed so as to two-dimensionally extend in the X and Y directions, with a thickness in the Z direction) may be designed while adjusting the thickness or width of each wiring separation layer, and/or selecting the material (e.g., high dielectric material or low dielectric material) as appropriate. This allows adjustment of electric properties of the wiring patterns on the actual wiring layers thus converted, thereby realizing desired electric properties thereof.

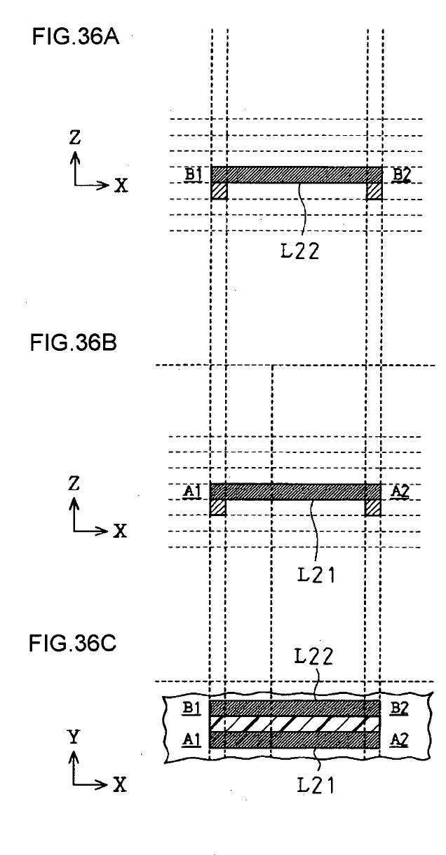

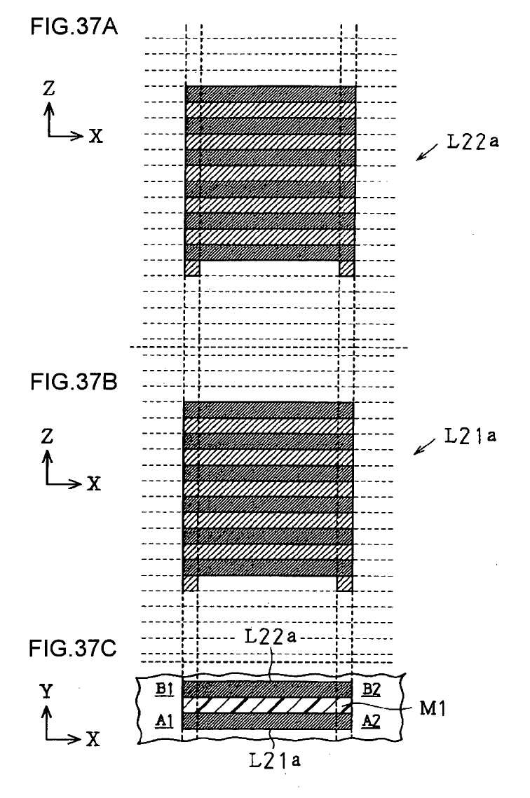

For example, let us say that wiring patterns L21 (between terminals A1 and A2) and L22 (between terminals B1 and B2) provided to a temporary physical wiring layer in parallel with each other as shown in FIGS. 36A through 36C are converted into multiple wiring layers (six wiring layers in the drawing) as shown in FIGS. 37A and 37B. Furthermore, the actual wiring layers arranged in the Z direction are connected with each other using plugs with an adjusted length in the X direction. Such a wiring structure thus created has a pair of sub-wiring structures L21a and L22a which are formed at a certain interval in the Y direction, and each of which has a certain area in parallel with the XZ plane. Each of the two sub-wiring structures L21a and L22a are formed of multiple wiring patterns, thereby reducing the resistance thereof, and increasing the capacitance therebetween as compared with an arrangement in which a wiring pattern is provided to a single wiring layer.

Furthermore, as shown in FIG. 37C, an insulating film M1 may be formed of a high dielectric (high-k) material between the sub-wiring structures L21a and L22a adjacent to one another in the Y direction, and between the plugs adjacent to one another in the Y direction. This increases the capacitance therebetween, and facilitates control of the capacitance by selecting the material used for the insulating film.

Description has been made in the aforementioned embodiments regarding a design method in which the wiring pattern designed on a certain temporary physical wiring layer is converted into wiring patterns provided to actual wiring layers, and plugs (via holes) are formed at appropriate positions. With such a design method, a coil-shaped wiring structure may be formed over the actual wiring layers. With such a coil-shaped wiring structure, the inductance thereof can be controlled by adjusting the positions of the plugs (via holes) as appropriate. Various kinds of coil-shaped wiring structures may be formed.

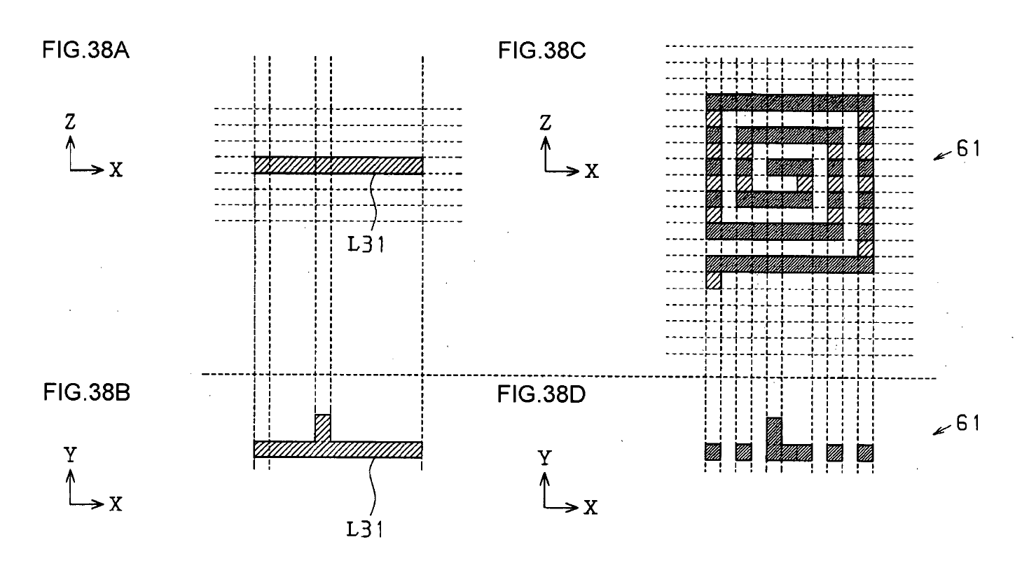

For example, a wiring pattern L31 designed on a temporary physical wiring layer shown in FIGS. 38A and 38B is converted into actual wiring layers, whereby a coil-shaped wiring structure 61 is formed as shown in FIGS. 38C and 38D. The coil-shaped wiring structure 61 is two-dimensional spiral coil-shaped structure formed in parallel with the XZ plane.

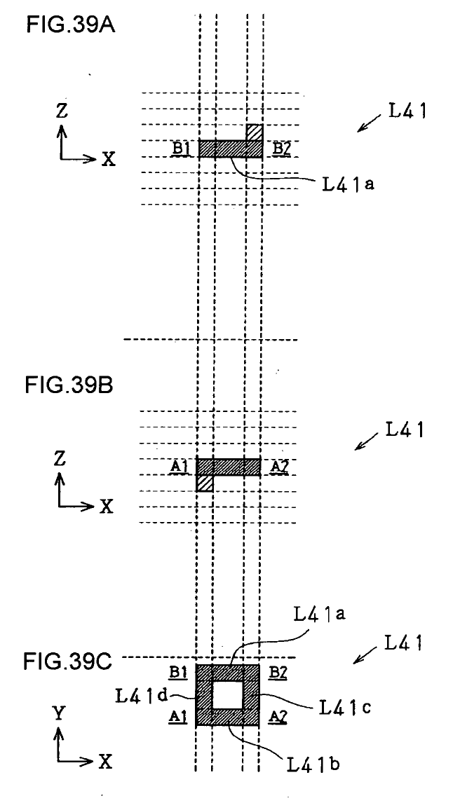

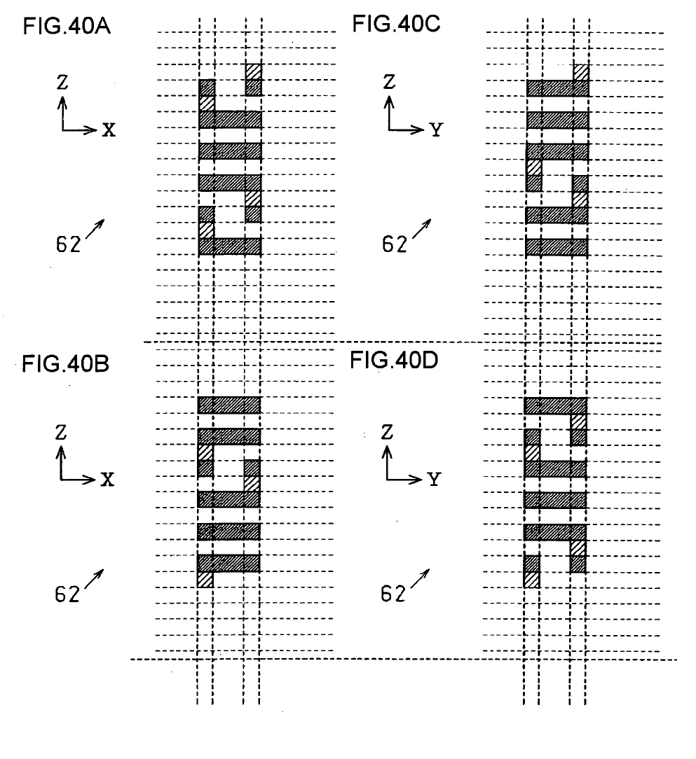

FIGS. 40A through 40D show a coil-shaped wiring structure 62. In this case, a frame-shaped wiring structure L41 designed on a temporary physical wiring layer shown in FIGS. 39A through 39C is converted into wiring patterns provided to actual wiring layers, whereby the coil-shaped wiring structure 62 is created. The coil-shaped wiring structure 62 is a spiral coil-shaped wiring structure extending in the Z direction. Note that FIG. 40A shows the wiring patterns and plugs converted from a wiring pattern L41a (wiring pattern between terminals B1 and B2) shown in FIG. 39C. FIG. 40B shows the wiring patterns and plugs converted from a wiring pattern L41b (wiring pattern between terminals A1 and A2) shown in FIG. 39C. FIG. 40C shows the wiring patterns and plugs converted from a wiring pattern L41c (wiring pattern between terminals A2 and B2) shown in FIG. 39C. FIG. 40D shows the wiring patterns and plugs converted from a wiring pattern L41d (wiring pattern between terminals A1 and B1) shown in FIG. 39C.

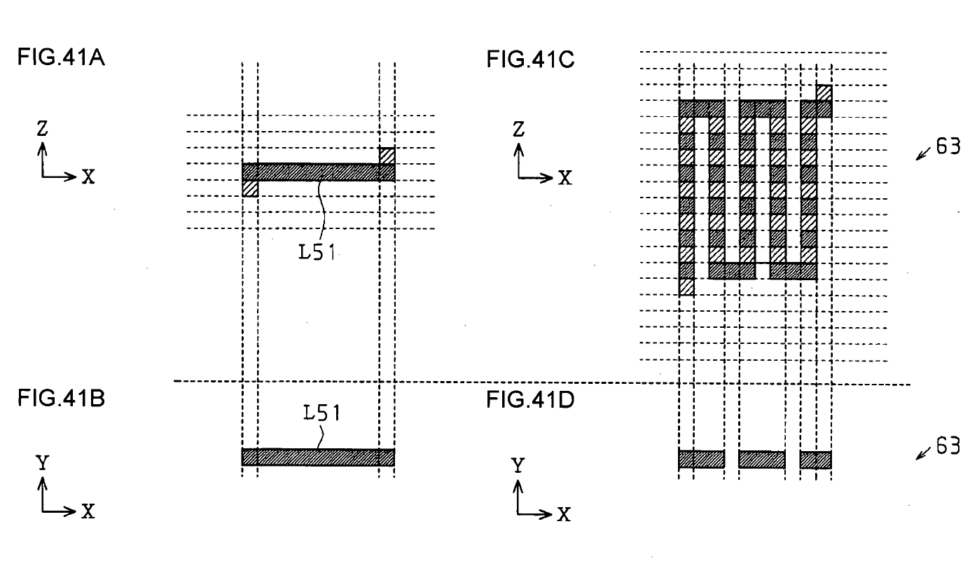

FIGS. 41C and 41D show a coil-shaped wiring structure 63. In this case, a wiring pattern L51 designed on a temporary physical wiring layer shown in FIGS. 41A and 41B is converted into wiring patterns provided to actual wiring layers, whereby the coil-shaped wiring structure 63 is formed. The coil-shaped wiring structure 63 is a zigzag (meander-shaped) coil-shaped wiring structure formed along the XZ plane.

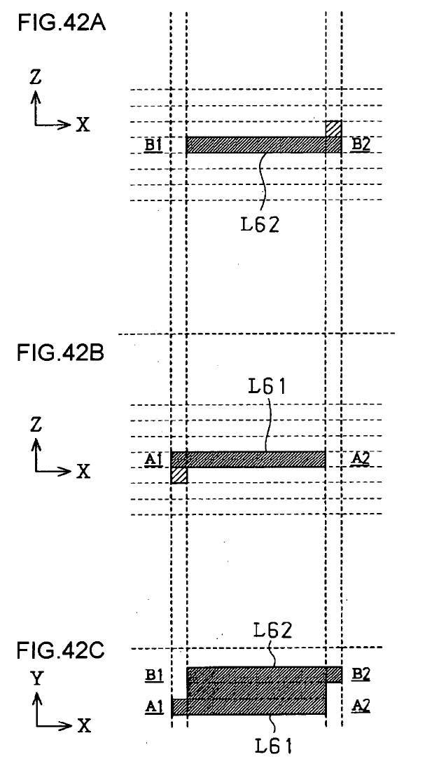

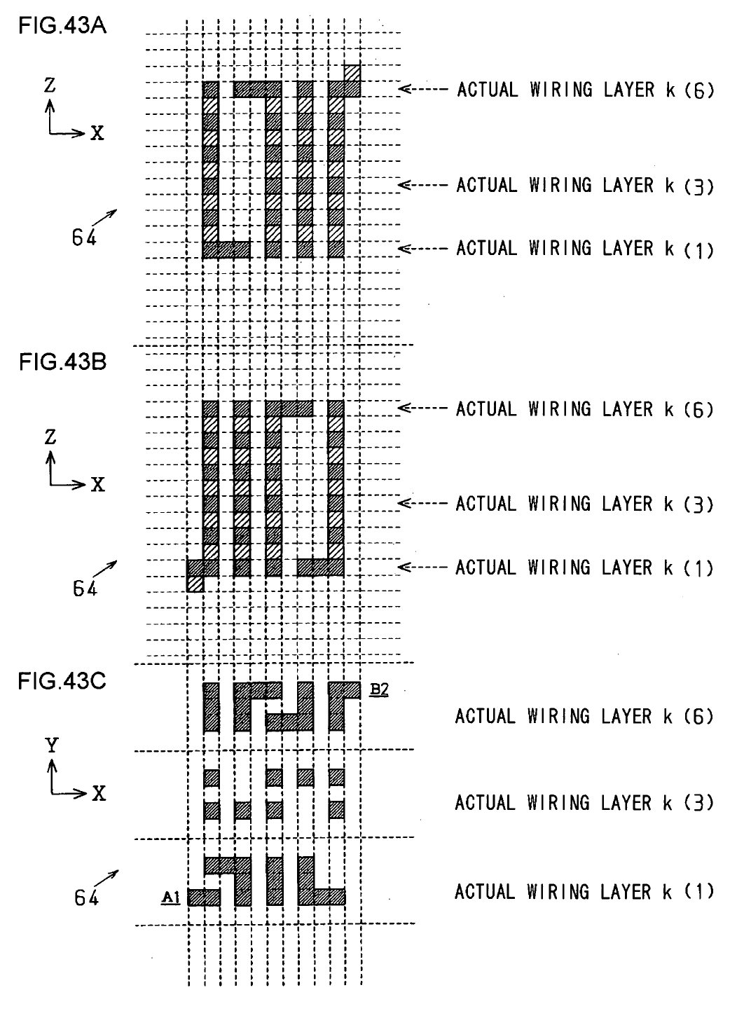

FIGS. 43A through 43C show a coil-shaped wiring structure 64. In this case, frame-shaped wiring patterns L61 and L62 designed in a temporary physical wiring layer shown in FIGS. 42A through 42C are converted into wiring patterns provided to actual wiring layers, whereby the coil-shaped wiring structure 64 is formed. The coil-shaped wiring structure 64 is a spiral coil-shaped wiring structure extending in the X direction. Note that FIG. 43A shows the wiring patterns and plugs converted from a wiring pattern L62 shown in FIG. 42A. FIG. 43B shows the wiring patterns and plugs converted from a wiring pattern L61 shown in FIG. 42B. FIG. 43C shows the wiring patterns provided to actual wiring layers K(1), K(3), and K(6).

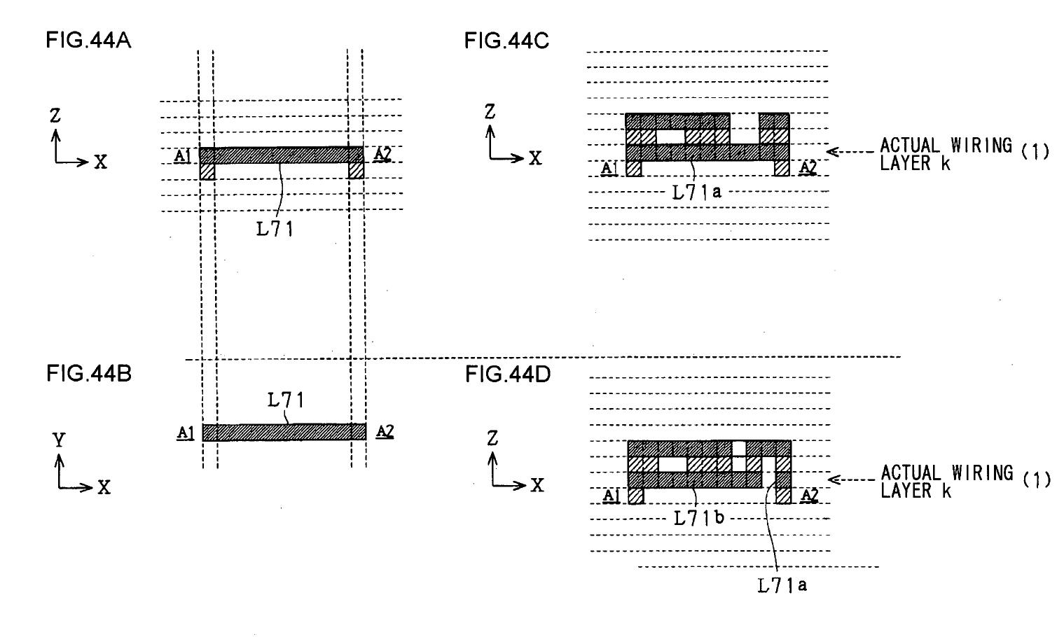

An arrangement may be made according to the first embodiment as shown in FIGS. 44A through 44D, in which the wiring patterns are provided to the actual wiring layers so as to have a bridge structure, thereby enabling the wiring length thereof to be reduced. Such a wiring structure allows the antenna rule to be satisfied. For example, a wiring pattern L71 designed on a temporary wiring layer shown in FIGS. 44A and 44B is converted into the wiring patterns provided to the actual wiring layers, thereby designing the wiring pattern L71 shown in FIG. 44C. Let us say that the terminal A2 of the wiring pattern L71 is connected to the gate terminal of a transistor. Furthermore, let us say that wiring pattern L71 does not satisfy the antenna rule due to the length of a wiring pattern L71a provided to the actual wiring layer K(1) to be connected to the terminal A2. With the present arrangement, the wiring pattern L71a is divided into two wiring patterns L71b and L71c as shown in FIG. 44D, thereby designing a wiring pattern, which is to be connected with the gate terminal of the transistor, with a reduced length. Such a wiring structure reduces the charge amount accumulated in the wiring structure in manufacturing. With such an arrangement, the wiring pattern which does not satisfy the antenna rule is converted into a wiring pattern having a bridge structure, thereby enabling the antenna rule to be satisfied with ease.

Description has been made in the aforementioned embodiments regarding an arrangement in which the wiring pattern of the temporary physical wiring layer is converted into the wiring patterns provided to multiple actual wiring layers with the same thickness. Such an arrangement is applied to a manufacturing method in which the actual wiring layers are generally formed with a fixed thickness. Let us consider a manufacturing method in which the actual wiring layers are formed with desired (multiple) thicknesses. In this case, an arrangement may be made in which the wiring pattern of the temporary physical wiring layer is converted into the wiring patterns provided to multiple actual wiring layers with different thicknesses.

Also, wiring structures shown in FIGS. 2A-2D, 3A-3D, 4A-4E, 10A-10C, 11A-11D, 13A-13B, 20A-20E, 29A-29E, 31A-31E, 33A-33B, 35A-35C through 44A-44D may effectively be applied to an arrangement designed using the aforementioned method in which a certain temporary physical wiring layer is converted into actual wiring layers, instead of an integrated circuit.

### Eleventh Embodiment

Description will be made below regarding an eleventh embodiment in which an integrated circuit and a design method thereof according to the present invention are applied to a semiconductor integrated circuit and a design method thereof with reference to the drawings.

FIGS. 45A through 45E shows a configuration of a semiconductor integrated circuit having a multi-layer wiring structure according to the present embodiment. A semiconductor integrated circuit 1 shown in FIG. 45A includes a logic circuit unit 2 and an analog circuit unit 3. With the present embodiment, the logic circuit unit 2 is designed using an automatic layout wiring tool.

FIGS. 45B through 45E show the (n+3)'th wiring layer through n'th wiring layer where wiring patterns are provided in different manners. FIG. 45B shows the (n+3)'th wiring layer where the wiring patterns are provided substantially in parallel with each other. Furthermore, these wiring patterns are arranged at an interval of an integer multiple of a unit pitch Pd. Specifically, a pair of wiring patterns is arranged at an interval one of: Pd, 2Pd, 3Pd, . . . . Furthermore, the wiring patterns are provided to the (n+3)'th wiring layer so as to extend in the Y direction.

FIG. 45C shows the (n+2)'th wiring layer where the wiring patterns are provided substantially in parallel with each other. Furthermore, these wiring patterns are arranged at an interval of an integer multiple of a unit pitch Pc. Furthermore, the wiring patterns are provided to the (n+2)'th wiring layer so as to extend in the X direction.

FIG. 45D shows the (n+1)'th wiring layer where the wiring patterns are provided substantially in parallel with each other. Furthermore, these wiring patterns are arranged at an interval of an integer multiple of the same unit pitch Pc as that of the (n+2)'th wiring layer. Furthermore, the wiring patterns are provided to the (n+1)'th wiring layer so as to extend in the X direction.

FIG. 45E shows the n'th wiring layer where the wiring patterns are provided substantially in parallel with each other. Furthermore, these wiring patterns are arranged at an interval of an integer multiple of the unit pitch Pa. Furthermore, the wiring patterns are provided to the n'th wiring layer so as to extend in the Y direction.

As described above, with the present embodiment, in general, layout design is performed such that the closer the wiring layer is to the uppermost layer, the grater the wiring pitch is. That is to say, the layout design according to the present embodiment follows the inverse scaling rule. With the layout design following the inverse scaling rule, the wiring patterns are provided such that the closer the wiring layer is to the uppermost layer, the greater the wiring width and the wiring pitch are. Such an arrangement reduces the wiring resistance and the capacitance between the adjacent wiring patterns formed in an upper wiring layer. Thus, the closer the wiring layer is to the uppermost layer, the easier formation of a wiring pattern with a great length is. In some cases, the layout design follows such an inverse scaling rule in order to facilitate design of the wiring pattern with a great length on an upper wiring layer. Alternatively, the inverse scaling rule is employed from the perspective of manufacturing. Specifically, in general, the closer the wiring layer is to the uppermost layer, the poorer the flatness thereof is. Accordingly, layout design is preferably performed such that the closer the wiring layer is to the uppermost layer, the greater the wiring pitch is.

Furthermore, with the present embodiment, the (n+2)'th wiring layer and the (n+1)'th wiring layer adjacent to one another include the wiring patterns provided so as to extend in the same direction, for example. In general, with ordinary wiring structures, the adjacent wiring layers include wiring patterns provided so as to extend in different directions. In particular, the intermediate wiring layers adjacent to one another include wiring patterns provided so as to extend in different directions. On the other hand, with the present embodiment, the wiring patterns are provided to the wiring layers in predetermined different manners. Furthermore, the adjacent wiring layers may include the wiring patterns provided so as to extend in the same direction. In this case, the adjacent wiring layers can include the wiring patterns at the same pitch without difficulty. That is to say, with the present embodiment, the wiring is designed following the inverse scaling rule in order to facilitate design of the wiring pattern with a great length on an upper wiring layer. Accordingly, with the present embodiment, the adjacent wiring layers can include the wiring patterns provided in parallel with each other at the same pitch without hardly any problem with respect to the aforementioned purpose. On the other hand, let us say that the inverse scaling rule is employed from the perspective of manufacturing. In this case, while different unit pitches are preferably employed in the adjacent wiring patterns, the difference in the preferably unit pitch between the adjacent wiring layers is smaller than that between distant wiring layers. Accordingly, the adjacent wiring layers can include the wiring patterns at the same pitch without hardly any problem with respect to the aforementioned purpose.

With the present embodiment, the adjacent wiring layers include the wiring patterns provided so as to extend in the same direction. Such an arrangement facilitates adjustment of the electric properties of the wiring structure, as shown in FIGS. 46A-46C through 48A-48D.

FIG. 46A shows the images of the wiring patterns Le1, Le3, and Le5 provided to the (n+1)'th wiring layer and wiring patterns Le2 and Le4 provided to the (n+2)'th wiring layer, which are projected onto the substrate (XY plane) of the integrated circuit. FIG. 46B is a YZ cross-sectional view of the wiring patterns Le1 through Le5. As shown in the drawings, the wiring patterns Le1, Le3, and Le5 are provided to the (n+1)'th wiring layer at a wiring pitch Pe twice the unit pitch Pc. Also, the wiring patterns Le2 and Le4 are provided to the (n+2)'th wiring layer at the same wiring pitch Pe twice the unit pitch Pc. Furthermore, the wiring structures thus created in the (n+1)'th wiring layer and (n+2)'th wiring layer are arranged with an offset of the unit pitch Pc, thereby enabling the layout in which all the wiring patterns provided to these wiring layers are arranged without overlapping or overlaying one another on the XY plane.

Such an arrangement allows the wiring patterns to be arranged adjacent to one another in the same wiring layer at a greater pitch than the unit pitch thereof while maintaining the electric properties. This suitably reduces the capacitance between the adjacent wiring patterns. Also, let us consider a case in which the wiring pattern Le3 is connected to a wiring pattern, provided to the (n+3)'th wiring layer in the wiring-extending direction, through a via hole. In this case, the present arrangement allows each wiring pattern in the intermediate (n+2) layer to be directly connected to the wiring pattern in the (n+3)'th wiring layer. Thus, such a wiring structure facilitates via connection.

Description has been made regarding an arrangement in which the wiring patterns are arranged in the same wiring layer at a wiring pitch Pe twice the unit pitch Pc. The present invention is not restricted to such an arrangement. Rather, an arrangement may be made as long as the wiring pitch thus employed is twice or more the unit pitch Pc. Furthermore, the wiring pitch of an integer multiple of the unit pitch Pc is more preferably employed. Description has been made regarding an arrangement in which the wiring structures thus created in the separate wiring layers are arranged with an offset of the unit pitch Pc. The present invention is not restricted to such an arrangement. Rather, an arrangement may be made as long as all the wiring patterns provided to these wiring layers are arranged without overlapping or overlaying one another on the XY plane.

FIG. 47A shows the images of the wiring patterns La1 and La2 provided to the (n+1)'th wiring layer and the (n+2)'th wiring layer, which are projected onto the substrate (XY plane) of the integrated circuit. FIG. 47B is an XZ cross-sectional view of the wiring patterns La1. FIG. 47C is an XZ cross-sectional view of the wiring patterns La2. As shown in the drawings, the wiring patterns La1 and La2 are provided to the (n+1)'th wiring layer, adjacent to one another. Furthermore, the wiring pattern La2 is provided so as to shift to the (n+2)'th wiring layer through a plug pg formed within a via hole.

Such an arrangement markedly reduce the portion where the wiring patterns La1 and La2 are provided adjacent to one another in the same wiring layer. This suitably reduces the capacitance between the wiring patterns La1 and La2.

FIGS. 48A through 48C show a shielding wiring structure according to the present embodiment, for shielding a signal-transmission wiring pattern Lc1 to be protected from noise and so forth. With the present wiring structure, the (n+1)'th wiring layer includes wiring patterns Lc2 and Lc3, which are to be fixed to a certain electric potential, with the signal-transmission wiring pattern Lc1 introduced therebetween. On the other hand, the (n+2)'th wiring layer includes a wiring pattern Lc4, which is to be fixed to a certain electric potential, over a region including the images of the signal-transmission wiring pattern Lc1 projected onto the (n+2)'th wiring layer.

Furthermore, as shown in FIGS. 48B and 48C, the wiring patterns Lc2 and Lc3 provided to the (n+1)'th wiring layer and the wiring pattern Lc4 provided to the (n+2)'th wiring layer are electrically connected with each other through plugs pg formed within via holes. Thus, the wiring patterns Lc2 and Lc3 provided to the (n+1)'th wiring layer and the wiring pattern Lc4 provided to the (n+2)'th wiring layer form a shielding wiring structure for shielding the signal-transmission wiring pattern Lc1 from surrounding electromagnetic waves.

Such an arrangement suitably protects the signal-transmission wiring pattern Lc1 from cross-talk noise and electromagnetic interference (EMI). Note that a bus line and a clock line are preferably shielded using such a shielding wiring structure.

On the other hand, FIGS. 46C, 47D, and 48D show wiring structures designed according to ordinary wiring-design settings of the automatic wiring tool. With this wiring design, the wiring patterns are provided to the adjacent wiring layers in wiring-extending direction orthogonal to one another.

Specifically, with the wiring structure shown in FIG. 46C, the (n+1)'th wiring layer includes the wiring patterns Le1, Le3, and Le5, provided thereto. Furthermore, the (n+3)'th wiring layer includes the wiring patterns Le2 and Le4, provided thereto.

FIG. 47D shows a wiring structure in which the (n+1)'th wiring layer includes the wiring patterns Lb1 and Lb2 adjacent to one another. Furthermore, the wiring pattern Lb2 is provided so as to shift to the (n+3)'th wiring layer through a plug formed within a via hole.

FIG. 48D shows a shielding wiring structure for shielding the signal-transmission wiring pattern Lc1, which is formed of the wiring patterns Lc2 and Lc3 provided to the (n+1)'th wiring layer and the wiring pattern Lc4 provided to the (n+3)'th wiring layer.

With the wiring structures shown in FIGS. 46C, 47D, and 48D, the unit pitch Pd, which is a unit pitch of the (n+3)'th wiring layer, is employed both in the (n+1)'th wiring layer and the (n+3)'th wiring layer. The reason why the unit pitch Pd of the (n+3)'th wiring layer is also employed in the (n+1)'th wiring layer as a common unit pitch is that, in general, the wiring patterns are provided to the (n+1)'th wiring layer with a large wiring length as compared with the (n+3)'th wiring layer. This further reduces wiring resources as compared with the wiring structures shown in FIGS. 46A and 46B, FIGS. 47A through 47C, and FIG. 48A through 48C.

Now, let us say that the layout design according to the inverse scaling rule is not requested from the manufacturing side. In this case, let us consider an arrangement in which the unit pitch, which is a unit pitch of the (n+1)'th wiring layer, is employed both in the (n+1)'th wiring layer and the (n+3)'th wiring layer as a common unit pitch. However, the inverse scaling rule is requested from the perspective of layout design giving consideration to the fact that, in general, the wiring pattern is provided to an upper wiring layer with greater length. Accordingly, such layout design often leads to problems with respect to the resistance of the wiring pattern, the capacitance therebetween, and so forth.

Furthermore, with the wiring structures shown in FIGS. 46C, 47D, and 48D, layout design of the connection between the wiring patterns of the (n+3)'th wiring layer and the (n+1)'th wiring layer needs to be made giving consideration to the layout of the wiring pattern provided to the intermediate (n+2)'th wiring layer. Accordingly, with such layout design, connection is made giving consideration to the layout of the wiring pattern provided to the intermediate wiring layer. This increases the computation load and reduces wiring resources in the design step using an automatic wiring tool.

On the other hand, with the present embodiment, the wiring patterns are provided to the the (n+1)'th wiring layer and the (n+2)'th wiring layer in the same wiring-extending direction. This suppresses problems due to the aforementioned common unit pitch employed in multiple wiring layers. Furthermore, the present embodiment provides suitable electric connection design without giving consideration to the intermediate wiring layer described above.

Description will be made below regarding a design procedure for a semiconductor integrated circuit having such a structure according to the present embodiment.

FIG. 49 is a block diagram which shows a configuration of a design support apparatus for a semiconductor integrated circuit according to the present embodiment. Note that this design support apparatus has a configuration for supporting a design using the standard cell method or the gate array method.

First, description will be made regarding functions of each component of the design support apparatus.

A library 1010 is a unit for storing cell information regarding various kinds of function cells forming an integrated circuit, and performance information regarding these function cells such as delay information regarding these function cells, limitation information regarding setup and hold time, and so forth. Here, examples of the function cells include: logic computation elements (AND, OR, exclusive OR, exclusive-AND, NOT, and so forth), a flip-flop, memory such as RAM and so forth, analog elements such as A/D and so forth, and a circuit formed of these components. Furthermore, the library 1010 stores information regarding the layout of the function cells such as information regarding the area thereof, and so forth.

On the other hand, a design specification storage unit 1012 stores information regarding the functions and the structure of an integrated circuit described by the hardware description language (HDL), for example. Specifically, the design specification storage unit 1012 stores circuit information represented by an RTL (resistor transfer level), a gate level, and so forth, timing information such as the operation frequency and so forth, power-supply conditions, and so forth. Here, the gate-level circuit information is represented by a net list formed of the information regarding the kinds of cells, the number thereof, and logical connection therebetween. Note that these cells are defined in and selected from the aforementioned library 1010.

On the other hand, a process parameter storage unit 1014 stores information regarding element properties, the wiring properties for each material, and so forth, corresponding to a specified design rule (rule with respect to the highest processing accuracy, the element size, the minimum wiring interval, and so forth).

Note that these library 1010, the design specification storage unit 1012, and the process parameter storage unit 1014 are realized by storage devices such as semiconductor memory, hard disk devices, and so forth.

On the other hand, an automatic layout unit 1020 and an automatic wiring unit 1022 serve as an automatic layout wiring tool having a function of layout design. Specifically, the automatic wiring unit 1022 is a unit having a function of connecting these function cells after layout. Note that the automatic layout of these function cells and automatic wiring for connecting these function cells after layout are performed based upon the layout data corresponding to these function cells, stored in the library 1010.

The net list of the circuit created by the automatic wiring unit 1022 is supplied to a timing analysis unit 1033. The net list has a layered structure formed of: a net list which represents the inside of each function block which comprises the function cells; and a net list which represents connection between the function blocks.

The timing analysis unit 1030 performs timing analysis based upon the aforementioned net list and the information stored in the process parameter storage unit 1014.

Note that the aforementioned automatic layout unit 1020, automatic wiring unit 1022, and timing analysis unit 1030 are realized by storage devices such as semiconductor memory, hard disk devices, and so forth, for storing a program for executing the aforementioned processing, and a computer.

On the other hand, an input unit 1040 is realized by input devices such as a touch pen, keyboard, mouse, and so forth, which allows the designer to input various information and instructions for layout design. An image display unit 1042 visually displays the aforementioned input information, layout view, and so forth. On the other hand, a control unit 1050 centrally controls the operation of the image display unit 1042, automatic layout unit 1020, automatic wiring unit 1022, timing analysis unit 1030, and so forth.

Next, description will be made regarding a design procedure for an integrated circuit according to the present embodiment. Note that the design procedure is performed using the design support apparatus having the aforementioned configuration. FIG. 50 shows a design procedure for an integrated circuit according to the present embodiment.

With a series of processing, first, in Step S1100, the automatic layout unit 1020 receives the layout information regarding the function cells stored in the library 1010 and the gate-level circuit information stored in the design specification storage unit 1012. Then, the automatic layout unit 1020 performs automatic layout of the function cells based upon the gate-level circuit information.

Following the automatic layout of the function cells, in Step S1110, the input unit 1040 specifies a region where a shielded wiring pattern is provided. Here, the shielded wiring pattern means a wiring pattern which is to be shielded by shielding wiring patterns therearound. Furthermore, the input unit 1040 specifies a region where wiring patterns are provided in the same wiring-extending direction at a wiring pitch greater than the aforementioned unit pitch in adjacent wiring layers. Note that, in such a region in the adjacent wiring layers, the wiring patterns are provided so as to not overlay or overlap one another as viewed from the substrate side of the semiconductor integrated circuit.

In the following Steps S1120 and S1130, connection is performed for connecting the function cells with each other after the layout based upon connection information regarding the function cells stored in the design specification storage unit 1012, the information regarding a region where a shielded wiring pattern is provided, which has been specified in Step S1110, and a region where the wiring patterns are provided so as to not overlay or overlap one another as viewed from the substrate side.

Specifically, in Step S1120, wiring and connection are performed for the wiring patterns which are to be fixed to a certain electric potential, such as power lines and so forth. In this step, the region where the shielding wiring pattern is provided is set corresponding to the aforementioned region where the shielded wiring pattern is provided, through the aforementioned input unit 1040, for example. Note that the region where the shielded wiring pattern is provided, which has been specified in Step S1110, is set to a forbidden region where the wiring pattern to be fixed to a certain electric potential cannot be provided.

In the following Step S1130, wiring patterns are provided for transmitting signals between the function cells.

Furthermore, in Step S1140, the timing analysis unit 1030 performs timing analysis based upon the layout data in which connection between the function cells has been performed, and the information stored in the process parameter storage unit 1014. Note that the timing analysis in this stage preferably includes cross-talk noise analysis based upon the estimated capacitance between the adjacent wiring patterns.

Then, in Step S1150, the timing analysis unit 1030 determines whether or not the results of the timing analysis are within a permissible range. In a case that the results are not within the permissible range, the flow returns to Step S1130 where connection of the function cells is performed again. In this case, redesign is made such that one of adjacent wiring patterns forming a pair provided to either the (n+1)'th wiring layer or the (n+2)'th wiring layer is shifted to the other wiring layer in a manner shown in FIGS. 47A through 47D, in order to remove the timing violation due to cross-talk noise. Also, in Step S1130 immediately following Steps S1110 and S1120, redesign may be made such that one of adjacent wiring patterns forming a pair provided to either the (n+1)'th wiring layer or the (n+2)'th wiring layer is shifted to the other wiring layer. With the present embodiment, for example, the automatic wiring unit 1022 has a function of detecting the adjacent wiring patterns in the same wiring layer with a length exceeding a predetermined length, and a function of redesigning these adjacent wiring patterns such that either of the adjacent wiring patterns thus detected is shifted to the other wiring layer, thereby enabling the aforementioned redesigning function.

Also, the input unit 1040 may specify a region where wiring patterns are provided at a wiring pitch greater than the aforementioned unit pitch in adjacent wiring layers so as to not overlay or overlap one another as viewed from the substrate side of the semiconductor integrated circuit, based upon the results of the timing analysis performed in Step S1150, through the input unit 1040. Then, the flow may return to Step S1130 where connection of the function cells is made again.

Also, as indicated by broken lines in FIG. 50, in a case that determination has been made in Step S1140 that the timing violation cannot be removed based upon the layout, the flow may return to Step S1100 where layout of the function cells is performed again.

In a case that determination has been made in Step S1150 that the results of timing analysis are within the permissible range, the aforementioned series of processing temporarily ends.

The present embodiment described above provides the following advantages.

(17) Of the regions where wiring is performed using an automatic wiring tool, wiring patterns are provided to two adjacent wiring layers in the same wiring-extending direction. Such an arrangement provides simple and effective countermeasures for removing various problems due to improved fine processing technology. This allows the designer to make effective design.

(18) With the present embodiment, the wiring patterns are provided such that the closer the wiring layer is to the uppermost layer, the greater the wiring pitch is. Such an arrangement allows design in which the closer the wiring layer is to the uppermost layer, the longer the wiring pattern, which can be provided to the wiring layer for electrically connecting the distant portions, is.

(19) With the present embodiment, in the adjacent wiring layers where the wiring patterns are provided in the same wiring-extending direction, generally the same unit pitch is employed. Note that the wiring patterns are arranged in each wiring layer in increments of the unit pitch. This facilitates electric connection between the wiring layers, and so forth.

(20) With the present embodiment, the wiring patterns are provided to the (n+1)'th wiring layer and the (n+2)'th wiring layer with a greater pitch than the unit pitch so as to not overlay or overlap one another as viewed above the substrate. Such an arrangement suppresses the capacitance between the wiring patterns in the same wiring layer. This suppresses the timing violation due to cross-talk noise.

(21) With the present embodiment, redesign is made as appropriate such that one of adjacent wiring patterns forming a pair provided to either the (n+1)'th wiring layer or the (n+2)'th wiring layer is shifted to the other wiring layer. Such an arrangement suppresses the timing violation due to cross-talk noise.

(22) With the present embodiment, a shielding wiring structure is formed using the adjacent wiring layers where the wiring patterns are provided in the same wiring-extending direction. With ordinary wiring structures, the wiring patterns forming the shielding wiring structure are arranged with another wiring layer introduced therebetween. Accordingly, in this case, the separate wiring patterns forming the shielding wiring structure need to be electrically connected with each other giving consideration to the layout of the wiring pattern provided to the intermediate wiring layer therebetween. With the present embodiment, the wiring patterns forming the shielding wiring structure can be connected without giving consideration to such a concern. Thus, such an arrangement provides a shielding wiring structure without major loss of the wiring resources. Thus, such an arrangement provides simple and effective countermeasures for removing various problems due to cross-talk noise and electromagnetic interference (EMI).

Also, modifications of the aforementioned embodiment may be made as follows.

A first wiring structure which is a component of the shielding wiring structure, and which is provided so as to extend in parallel with the shielded wiring pattern, is not restricted to the aforementioned wiring structure shown in FIGS. 48A through 48D as an example in which two wiring patterns are provided on the both sides of the signal-transmission wiring pattern.

A second wiring structure which is another component of the shielding wiring structure, and which is provided to a wiring layer other than the wiring layer where the signal-transmission wiring pattern is provided, do not need to have the same positional relation with the signal-transmission wiring pattern as that shown in FIGS. 48A through 48D as an example. Specifically, the second wiring structure may be provided underneath the wiring layer where the signal-transmission wiring pattern is provided. Also, a pair of the second wiring structures may be provided both above and underneath the wiring layer where the signal-transmission wiring pattern is provided.

The present invention is not restricted to an arrangement in which the same unit pitch is employed in the (n+2)'th wiring layer and the (n+1)'th wiring layer. For example, let us consider an arrangement in which the wiring patterns are provided to the (n+2)'th wiring layer at a greater unit pitch than that of the wiring patterns provided to (n+1)'th wiring layer. Even in such a case, with the present embodiment, the wiring patterns are provided to the adjacent wiring layers in the same wiring-extending direction. With such a arrangement, connection may be made without giving consideration to the layout of the wiring patterns provided to the intermediate wiring layer. Furthermore, let us say that the inverse scaling rule is employed in the wiring design. In this case, while different unit pitches are preferably employed in the adjacent wiring patterns, the difference in the preferably unit pitch between the adjacent wiring layers is smaller than that between distant wiring layers. Accordingly, the adjacent wiring layers can include the wiring patterns at generally the same pitch.

The region designed by the automatic wiring tool is not restricted to the logic circuit unit.

The present invention is not restricted to an arrangement in which the two adjacent wiring layers include the wiring patterns provided so as to extend in the same direction in a region where wiring is designed using an automatic wiring tool. Also, an arrangement may be made in which the two adjacent wiring layers include the wiring patterns provided so as to extend in the same direction only in a region where the electric properties should be adjusted.

Description has been made in the aforementioned embodiments regarding an arrangement in which the integrated circuit and the design method thereof according to the present invention is applied to a semiconductor integrated circuit. The present invention is not restricted to such an arrangement. Rather, the present invention may be applied to various kinds of integrated circuit having a general multi-layer structure, such as an integrated circuit in which device elements are electrically connected so as to form a circuit on a silicon substrate, glass substrate, or printed wiring board.

One or more embodiments of the present invention can also be understood as follows. 1. The essence of one embodiment of the present invention in one form is an integrated circuit having a multi-layer wiring structure, configured of at least one of the wiring patterns of

a. a wiring pattern connecting predetermined terminals of two arbitrary circuit elements which the integrated circuit has,

b. a wiring pattern for fixing the electric potential of a predetermined terminal of an arbitrary circuit element of the integrated circuit,

c. a wiring pattern of which the electric potential is fixed and one end thereof is substantially opened, and

d. a wiring pattern connected to a terminal of a predetermined element with the other end thereof being substantially opened

provided to a plurality of wiring layers extending as signal paths in generally the same direction in a manner in which the images of the wiring patterns projected onto the substrate of the integrated circuit overlay or overlap one another and are connected with each other through via holes.

In general, the aforementioned wiring patterns a through d have a single wiring-pattern structure. With the above configuration, the aforementioned wiring patterns a through d have a wiring structure in which the wiring patterns extending in generally the same direction are provided to multiple wiring layers such that the images thereof projected onto the substrate of the integrated circuit overlay or overlap one another. Furthermore, the wiring patterns in the multiple wiring layers are connected with each other through via holes. Accordingly, the degree of freedom of the circuit variables which these wiring patterns can assume is increased in comparison with an arrangement wherein the wiring patterns are all formed on a single wiring layer. Accordingly, problems owing to reduction of size to minute dimensions can easily be dealt with.

Note that “signal path” as used here is the longer side in the longitudinal direction of the wiring pattern divided by a via hole, and does not include the via hole. Also, projection of the signal path as to the wiring layers overlaying or overlapping includes cases of projection to the layer of the signal path itself and the signal path coming into contact.

2. The essence of one embodiment of the present invention in one form is an integrated circuit having a region where wiring patterns are provided to multiple wiring layers, and are electrically connected in parallel with each other, for connecting two predetermined terminals of a device element included in the integrated circuit.

With the above configuration, the portions provided in parallel over multiple wiring layers and electrically connected with each other can transmit single signals from one of two predetermined places within the wiring layer (both ends connected in parallel) to the other, via each of these wiring patterns, for example. Accordingly, resistance of the wiring patterns can be reduced as compared to cases wherein the wiring pattern is a single wiring line.

At this time, the wiring patterns electrically connected in parallel are preferably formed such that projection of images thereof onto the substrate of the integrated circuit overlay or overlap each other. This way, the resistance of the wiring patterns can be adjusted without enlarging the effective wiring pattern width or wiring pattern length, i.e., without enlarging the wiring pattern width or wiring pattern length of the wiring pattern perpendicularly projected onto the substrate of the integrated circuit. This enables inductance to be reduced without enlarging the effective wiring pattern length, i.e., without enlarging the wiring pattern length of the wiring pattern perpendicularly projected onto the substrate of the integrated circuit.

3. The essence of one embodiment of the present invention in one form is an integrated circuit having a multi-layer wiring structure, wherein a plurality of wiring patterns provided in parallel to each other to a plurality of wiring layers in a manner in which the images thereof projected onto the substrate of the integrated circuit overlay or overlap one another, are electrically connected in serial with each other such that a signal is transmitted in the direction opposite to that of the adjacent wiring pattern.

With the above configuration, wiring patterns are serially connected in an arrangement wherein the direction of transmitting signals is opposite one from another, so resistance of the wiring pattern can be increased without enlarging the effective wiring pattern length, i.e., without enlarging the wiring pattern length of the wiring pattern perpendicularly projected onto the substrate of the integrated circuit. Accordingly, this can be applied to adjusting the resistance value in the direction of increasing, such as for adjusting the delay of signals in the integrated circuit and generating reference potential, and so forth.

Note that with the above configuration, inductance is increased without enlarging the effective wiring pattern length, i.e., without enlarging the wiring pattern length of the wiring pattern perpendicularly projected onto the substrate of the integrated circuit.

Also, the arrangements in 2. above or 3. may be made to include wiring layers where the multiple wiring layers are adjacent one to another.

Thus, electrical interference which readily occurs between the wiring patterns of the multiple wiring layers of the configuration described above and wiring patterns laid in wiring layers in between these wiring layers in an arrangement wherein the multiple wiring layers are not adjacent, can be avoided or suppressed.

4. The essence of one embodiment of the present invention in one form is that in a region wherein the direction and interval in which wiring patterns provided parallel to each other, are substantially the same between adjacent wiring layers, one pair of wiring patterns made up of wiring patterns of which the images are in closest proximity when projected onto the substrate of the integrated circuit, are provided so as to be situated in different wiring layers.

With the above configuration, the pair of wiring patterns are each provided in diffident wiring layers of the adjacent wiring layers. Accordingly, the capacitance between the pair of wiring patterns can be suitably reduced without widening the intervals between the pair of wiring patterns in the horizontal direction.

5. The essence of one embodiment of the present invention in one form is that wiring patterns of whose projections onto the substrate of the integrated circuit are mutually adjacent alternately switch between at least two wiring layers through via holes.

With the above configuration, the portions where wiring patterns, of whose projections onto the substrate of the integrated circuit are mutually adjacent, are adjacent in the horizontal direction within the same wiring layer, can be minimized, and the capacitance between horizontally adjacent wiring patterns can be suitably reduced.

Note that with this arrangement, the at least two wiring layers may be mutually adjacent wiring layers.

Thus, electrical interference which readily occurs between the wiring patterns of the multiple wiring layers of the configuration described above and wiring patterns laid in wiring layers in between these wiring layers in an arrangement wherein the multiple wiring layers are not adjacent, can be avoided or suppressed.

6. The essence of one embodiment of the present invention in one form is an integrated circuit having a multi-layer wiring structure, wherein at least one of a pair of wiring patterns provided to a predetermined wiring layer adjacent one another in parallel with each other is connected through a vial hole to the corresponding wiring pattern of another pair of wiring patterns provided to another predetermined wiring layer adjacent one another in the same direction as the above pair of wiring patterns in parallel with each other, thereby serving as a dummy wiring pattern wherein one end of at least one of the pair of wiring patterns provided to the other wiring layer are substantially open, i.e., formed as dummy wiring.

With the above configuration, at least one wiring pattern of the one pair of wiring patterns in the predetermined wiring layer receives the capacitance between the dummy wiring pattern connected to the at least one wiring pattern and the adjacent wiring pattern (the other wiring pattern of the other pair of wiring patterns) in the other wiring layer. Accordingly, the capacitance between the wiring pattern connected to this dummy wiring pattern and the adjacent wiring pattern can be increased. Thus, the delay of signals transmitted over the wiring pattern can be adjusted, and impedance matching can be performed.

Moreover, the capacitance can be increased without reducing the effective wiring pattern pitch or increasing the wiring pattern length, in other words, without reducing the effective wiring pattern pitch or increasing the wiring pattern length of the wiring patterns perpendicularly projected onto the substrate of the integrated circuit. This neither violates design rule nor increases the resistance.

Particularly, in a case wherein both of the pair of wiring patterns of the other wiring layer become dummy wiring patterns by connecting each of the pair of wiring patterns of the predetermined wiring layer and the pair of wiring patterns of the other wiring layer, the capacitance between the dummy wiring patterns is applied to the capacitance between the pair of the wiring patterns of the predetermined wiring layer, so the capacitance between the pair of the wiring patterns of the predetermined wiring layer can be increased.

Note that this arrangement may be formed such that the pair of wiring patterns of the other wiring layer are generally equal to the images of the pair of wiring patterns of the predetermined wiring layer projected onto the other wiring layer. Accordingly, the same mask pattern can be used for the predetermined wiring layer and the other wiring layer, at least for these pairs of wiring patterns.

Note that with this arrangement, the predetermined wiring layers and the other wiring layer may be mutually adjacent wiring layers. Thus, electrical interference which readily occurs between the wiring patterns of the multiple wiring layers of the configuration described above and wiring patterns laid in wiring layers in between these wiring layers in an arrangement wherein the multiple wiring layers are not adjacent, can be avoided or suppressed.

7. The essence of one embodiment of the present invention in one form is an integrated circuit having a multi-layer wiring structure, wherein a pair of wiring patterns formed from at least one of a wiring pattern for connecting between predetermined terminals of two arbitrary elements of the integrated circuit, and a wiring pattern for fixing the electric potential of a predetermined terminal of an arbitrary circuit element of the integrated circuit, are each configured of a parallel connection of the wiring patterns of multiple wiring layers, and further, the multiple wiring layers are shared between the pair of wiring patterns and the pair of wiring patterns in these wiring layers are formed adjacently.

With the above configuration, the pair of wiring patterns are configured of a parallel connection of wiring patterns on multiple wiring layers, so the wiring pattern resistance can be reduced as compared with a case wherein the pair of wiring patterns are formed of single wiring lines. Further, the pair of wiring patterns are formed mutually adjacent in the wiring layers, so the capacitance between the pair of wiring patterns can be made greater as compared with a case wherein at least one of the pair of wiring patterns is formed as a wiring pattern formed on a single wiring layer.

Note that the wiring patterns of the multiple wiring layers preferably include mutually adjacent wiring layers. Thus, electrical interference which readily occurs between the wiring patterns of the multiple wiring layers of the configuration described above and wiring patterns laid in wiring layers in between these wiring layers in an arrangement wherein the multiple wiring layers are not adjacent, can be avoided or suppressed.

8. The essence of one embodiment of the present invention in one form is an integrated circuit having a multi-layer wiring structure, wherein a pair of wiring patterns formed from at least one of a wiring pattern for connecting between predetermined terminals of two arbitrary circuit elements of the integrated circuit, and a wiring pattern for fixing the electric potential of a predetermined terminal of an arbitrary circuit element of the integrated circuit, are provided mutually parallel and are formed of wiring patterns of multiple wiring layers connected serially one with another such that the projection of images from one end to the other end of the signal path onto the substrate of the integrated circuit overlay or overlap each other, and further, the multiple wiring layers are shared between the pair of wiring patterns and the pair of wiring patterns in these wiring layers are formed adjacently.

With the above configuration, the above pair of wiring patterns is serially connected wiring patterns by the pair of wiring patterns overlaying or overlapping each other, so the resistance of the pair of wiring patterns can be increased without increasing the wiring pattern length, in other words, without increasing the wiring pattern length of the wiring patterns perpendicularly projected onto the substrate of the integrated circuit. Further, the pair of wiring patterns are formed mutually adjacent in the wiring layers, so the capacitance between the pair of wiring patterns can be made greater as compared with a case wherein at least one of the pair of wiring patterns is formed as a wiring pattern formed on a single wiring layer.

With regard to the aforementioned wiring patterns in the multiple wiring layers, these wiring patterns are preferably provided to the adjacent wiring layers. Thus, electrical interference which readily occurs between the wiring patterns of the multiple wiring layers of the configuration described above and wiring patterns laid in wiring layers in between these wiring layers in an arrangement wherein the multiple wiring layers are not adjacent, can be avoided or suppressed.

9. The essence of one embodiment of the present invention in one form is an integrated circuit having a multi-layer wiring structure, wherein, with regard to a plurality of fixed-electric-potential wiring patterns each fixed to different electric potentials and a signal-transmission wiring pattern, at least one of these wiring patterns switches wiring layers at a portion wherein the images of these wiring patterns projected onto the substrate of the integrated circuit are adjacent and parallel, thereby changing the length over which the signal-transmission wiring pattern is adjacent to the plurality of fixed-electric-potential wiring patterns in an arbitrary wiring layer, for each fixed-electric-potential wiring pattern.

The length over which the signal-transmission wiring pattern and the fixed-electric-potential wiring patterns are adjacent corresponds to the magnitude of the capacitance between the wiring patterns. The transmission speed of signals over the signal-transmission wiring pattern changes depending on the magnitude of the capacitance between the signal-transmission wiring pattern and the adjacent fixed-electric-potential wiring pattern.

Also, the waveform of signals transmitted over the signal-transmission wiring pattern changes according to the ratio of length adjacent of the fixed-electric-potential wiring patterns each fixed to different electric potentials and the signal-transmission wiring pattern.

From this perspective, with the above-described configuration, the transmission speed and waveform of signals can be adjusted for the signals transmitted over the signal-transmission wiring pattern, depending on the length over which signal-transmission wiring pattern is adjacent to the fixed-electric-potential wiring patterns.

10. The essence of one embodiment of the present invention in one form is an integrated circuit having a multi-layer wiring structure comprising a region having a plurality of wiring layers in which wiring patterns are provided so as to extend in parallel in substantially the same direction having a pitch, which is the interval between center lines of the line width of the wiring patterns provided in parallel, of an integer multiple of a predetermined unit pitch, the region having at least one of

a. a wiring pattern connecting predetermined terminals of two circuit elements which the integrated circuit has, the wiring pattern being provided over multiple wiring layers in parallel and having a portion electrically connected in parallel,

b. a plurality of wiring patterns provided in parallel with each other over a plurality of wiring layers and having a region wherein the projection of the images of each onto the wiring layers overlap, wherein the plurality of wiring patterns are electrically connected in serial with each other such that a signal is transmitted in the direction opposite to that of the adjacent wiring pattern,

c. a pair of wiring patterns provided to a predetermined wiring layer adjacent one another in parallel with each other, and another pair of wiring patterns provided to another predetermined wiring layer adjacent one another in parallel with each other, with at least one wiring pattern of the other pair of wiring patterns being connected to the corresponding wiring pattern of the one pair of wiring patterns through a via hole, whereby the other pair of wiring patterns serve as a dummy wiring pattern of which one end is substantially opened.

d. one pair of wiring patterns made up of wiring patterns of which the images are in closest proximity when projected onto the substrate of the integrated circuit, being provided so as to be situated in different wiring layers,

e. wiring patterns of which the images are adjacent when projected onto the substrate of the integrated circuit, provided so as to alternately switch between at least two wiring layers of the plurality of wiring layers through via holes, and

f. a plurality of fixed-electric-potential wiring patterns each fixed to different electric potentials and a signal-transmission wiring pattern, wherein at least one of these wiring patterns switches wiring layers at a portion wherein the images of these wiring patterns projected onto the substrate of the integrated circuit are adjacent and parallel, thereby changing the length over which the signal-transmission wiring pattern is adjacent to the plurality of fixed-electric-potential wiring patterns in an arbitrary wiring layer, for each fixed-electric-potential wiring pattern.

The above configuration has a region having a plurality of wiring layers in which wiring patterns are provided so as to extend in parallel in substantially the same direction having a pitch, which is the interval between center lines of the line width of the wiring patterns provided in parallel, of an integer multiple of a predetermined unit pitch. Setting the manner in which the wiring patterns of each of the wiring layers are provided enables each of the wiring patterns a through f above to be easily formed.

That is to say, in the event that the above wiring pattern “a” is provided, multiple wiring patterns, provided parallel with each other over multiple wiring layers such that the projected images of the signal transmission paths to the substrate of the integrated circuit overlay or overlap each other, are used for transmitting single signals from one of two predetermined places within the wiring layer to the other. Accordingly, the wiring pattern resistance can be suitably adjusted depending on the manner in which the multiple wiring patterns are provided, and the relation of the transmission direction of mutual signals between the wiring layers corresponding to the overlaying or overlapping region.

Also, in the event that the above wiring pattern “b” is provided, the capacitance between the dummy wiring patterns is added to the capacitance of the adjacent wiring patterns of the one wiring layer, so the capacitance between the adjacent wiring patterns can be increased. Note that the pair of dummy wiring patterns is preferably provided in the region where the pair of wiring patterns are projected onto the other wiring layer.

Further, in the event that the above wiring pattern “c” is provided, at least one wiring pattern of the one pair of wiring patterns in the predetermined wiring layer receives the capacitance between the dummy wiring pattern connected to the at least one wiring pattern and the adjacent wiring pattern (the other wiring pattern of the other pair of wiring patterns). Accordingly, the capacitance between the wiring pattern connected to this dummy wiring pattern and the adjacent wiring pattern can be increased.

Additionally, in the event that the above wiring pattern “d” is provided, the capacitance between the pair of wiring patterns can be suitably reduced without widening the intervals between the pair of wiring patterns in the horizontal direction.

Further, in the event that the above wiring pattern “e” is provided, the portions where wiring patterns, of whose projections onto the substrate of the integrated circuit are mutually adjacent in the horizontal direction, are adjacent in the horizontal direction within the same wiring layer, can be minimized, and the capacitance between horizontally adjacent wiring patterns can be suitably reduced.

Also, in the event that the above wiring pattern “f” is provided, the transmission speed and waveform of signals can be adjusted for the signals transmitted over the signal-transmission wiring pattern according to the length over which the signal-transmission wiring pattern is adjacent to the fixed-electric-potential wiring patterns.

Note that in the above region, two or more wiring patterns of the wiring patterns a through f are preferably provided so as to satisfy the multiple requirements regarding increase/decrease of resistance, capacitance between wiring patterns, and so forth.

Incidentally, in the above region, the interval between center lines of the line width of the wiring patterns provided in parallel is an integer multiple of a predetermined unit pitch, so designing can be easily performed for the region with an automatic wiring tool.

11. The essence of one embodiment of the present invention in one form is having multiple regions in which the wiring patterns extend in different directions between adjacent regions at a predetermined wiring layer, for the region with at least one of the above a through f according to the above item 10.

This configuration has multiple regions in which the wiring patterns extend in different directions between adjacent regions, so suitable wiring structure can be applied for each region of the integrated circuit.

12. With the arrangement of the above item 11, a wiring pattern may be used for the connection between adjacent regions where the direction of providing wiring patterns differ, which switches wiring layers is that the projected images on the substrate of the integrated circuit form a single line.

Accordingly, the wiring pattern signal path to be connected between the adjacent regions can be kept to a suitable path length, without detour paths or the like being made.

13. The essence of one embodiment of the present invention in one form is having a step wherein wiring layers of the integrated circuit, in which layout has been designed, are set to temporary physical wiring layers, calculation means perform conversion of predetermined one or more of the temporary physical wiring layers in at least one region, and with the conversion, the calculation means convert each predetermined temporary physical wiring layer into wiring patterns of a plurality of actual wiring layers such that the images thereof projected onto the substrate generally match one another, so that the circuit properties of each wiring pattern of a predetermined temporary physical wiring layer of the temporary physical wiring layers are desired circuit properties.

With the above design method, the wiring patterns of temporary physical wiring, layers are converted into wiring patterns using at least one region where projection of the images of actual wiring layers formed of multiple wiring layers onto the substrate generally match. Accordingly, circuit properties (properties such as wiring pattern properties, capacitance between wiring patterns, and so forth) which were impossible to realize with conventional wiring techniques that do not use such a wiring pattern formation technique employing conversion can be realized. Accordingly, circuit property adjustment can be easily performed.

Further, wiring pattern conversion is performed at this time based on the wiring pattern paths of each wiring pattern in the temporary physical wiring layers, so such circuit property adjustment can be performed without performing correction to electrical connection arrangements in wiring patterns on the original physical wiring layer.

Note that the phrase “projected onto the substrate generally match one another” is not necessarily restrictive to a region of projection in the normal line direction as to the temporary physical wiring layer, and also includes regions in contact with such a region. Also, the phrase “an integrated circuit . . . , in which layout has been designed” means an integrated circuit having layout data and mask data with each part being connected.

14. The essence of one embodiment of the present invention in one form is a design method for an integrated circuit, for determining a wiring path connecting each circuit element of the. integrated circuit, wherein wiring layers for the connection are set to temporary physical wiring layers, and wiring pattern paths on the temporary physical wiring layers are determined by automatic wiring, based on circuit properties assuming conversion of the wiring patterns of a predetermined temporary physical wiring layer into wiring patterns formed using at least one region of regions where the wiring patterns which are projected to actual wiring layers made up of a plurality of wiring layers generally match one another.

According to this design method, wiring pattern paths on the temporary physical wiring layers are determined by automatic wiring, based on circuit properties assuming conversion of the wiring patterns of a predetermined temporary physical wiring layer into wiring patterns formed using at least one region of regions where the wiring patterns which are projected to actual wiring layers made up of a plurality of wiring layers generally match one another. Accordingly, at the time of determining the wiring pattern paths by automatic wiring, circuit properties (properties such as wiring pattern properties, capacitance between wiring patterns, and so forth) can be realized which were impossible to realize with conventional wiring techniques that do not use such conversion. Consequently, the degree of freedom in selection of wiring pattern paths can be improved, and the computation load of determining the signal paths of temporary wiring patterns by automatic wiring can be reduced.

Performing conversion to the assumed wiring patterns based on the wiring pattern paths thus determined enables wiring patterns having desired circuit properties to be easily designed. Accordingly, adjustment of circuit properties can be easily performed. Moreover, with wiring patterns converted in this way, projection of images of the wiring patterns onto the substrate of the integrated circuit overlay each other (either match or are in close proximity), so wiring patterns with a high-density projection can be formed.

Note that the phrase “regions where . . . projected to . . . generally match one another” is not necessarily restrictive to a region of projection in the normal line direction as to the temporary physical wiring layer, and also includes regions in contact with such a region.

15. The essence of one embodiment of the present invention in one form is a design method for an integrated circuit in which the circuit elements thereof are automatically positioned, wherein wiring layers for connection regarding place in the integrated circuit are set to temporary physical wiring layers, and automatic placement is performed, based on circuit properties assuming conversion of the wiring patterns of a predetermined temporary physical wiring layer of the integrated circuit where connection is to be made into wiring patterns formed using at least one region of regions where the wiring patterns which are projected to actual wiring layers made up of a plurality of wiring layers generally match one another.

According to this design method, automatic placement is performed, based on circuit properties assuming conversion of the wiring patterns of a predetermined temporary physical wiring layer of the integrated circuit where connection is to be made into wiring patterns formed using at least one region of regions where the wiring patterns which are projected to actual wiring layers made up of a plurality of wiring layers generally match one another. Accordingly, at the time of performing automatic placement, placement can be performed based on circuit properties (properties such as wiring pattern properties, capacitance between wiring patterns, and so forth) which were impossible to realized which were impossible to realize with conventional wiring techniques that do not use such conversion, thereby improving freedom of placement. Particularly, with conversion of wiring patterns onto actual wiring layers, high density is more readily enabled as compared to before conversion, so according to the above design method, high density of placement of the elements of the integrated circuit can be achieved.

Performing conversion to the assumed wiring patterns based on the placement thus determined enables wiring patterns having circuit properties suitable for the determined placement to be easily designed.

Note that the phrase “regions where . . . projected to . . . generally match one another” is not necessarily restrictive to a region of projection in the normal line direction as to the temporary physical wiring layer, and also includes regions in contact with such a region. Also, “connection” as used above includes Steiner routing or the like employed as a rough indication for placement, for example.

16. The essence of one embodiment of the present invention in one form is the arrangement in the above items 13 through 15, having a step for dividing the integrated circuit into multiple sub-regions. With such an arrangement, in at least one region including at least one temporary physical wiring layer, the wiring pattern in the temporary physical wiring layer is converted into the multiple actual wiring layers generally in a mirror image relation therebetween for each sub-region. With this conversion, the number of the actual wiring layers used for the conversion of the temporary physical wiring layer is determined for each sub-region.

With this design method, conversion is performed for each sub-region, so the desired circuit properties can be efficiently realized. Particularly, wiring patterns are not necessarily provided uniformly over all regions of each of the wiring layers in the layout design, and there are often regions where no wiring pattern is provided. Accordingly, the present design methods performs the above conversion in increments of sub-regions, wherein, the more temporary physical wiring layers with no wiring patterns provided a sub-region contains, the more actual wiring layers are provided thereto, thereby suitably suppressing increase in the final number of wiring layers of the integrated circuit.

In the event that this arrangement is dependent on the arrangement of the above item 14, an arrangement is made wherein wherein automatic wiring is performed at a level so as to satisfy a predetermined cost. Accordingly, defining a greater cost for sub-regions where adjustment of circuit variables by conversion to the actual wiring layers is particularly desired, such as sub-regions where high-speed is required for example, enables the number of temporary physical wiring layers used for providing the wiring patterns in these sub-regions to be reduced. Accordingly, the number of actual wiring layers used for the above conversion can be increased with greater priority in this region.

17. The essence of one embodiment of the present invention in one form is the integrated circuit design method in the above item 16, further having a step for setting wiring pattern paths on actual wiring layers across adjacent sub-regions. With such an arrangement, after the aforementioned conversion, computation means set such a wiring pattern path which enables the wiring to switch from one actual wiring layer to another, so as to maintain the connection state of the wiring patterns designed on temporary physical wiring layers. When performing the above conversion in increments of sub-regions described above, the arrangement of conversion into wiring patterns on multiple actual wiring layers may not always be the same between adjacent sub-regions. Accordingly, there are cases wherein the manner in which the wiring patterns are provided to the same actual wiring layer differs between the adjacent sub-regions. With such portions, direct connection of the wiring patterns between sub-regions may be difficult in some cases.

As for this design method, after the aforementioned conversion, wiring pattern paths are set on actual wiring layers across adjacent sub-regions. Such a wiring pattern path enables the wiring to stitch from one actual wiring layer to another so as to maintain the connection state of the wiring patterns designed on temporary physical wiring layers. Such an arrangement suitably performs connection between both sub-regions. Also, “connection” as used above includes Steiner routing or the like employed as a rough indication for placement, for example.

18. The essence of one embodiment of the present invention in one form is an integrated circuit having a multi-layer wiring structure, with a region having wiring layers in which wiring patterns are provided so as to extend in parallel having a pitch, which is the interval between center lines of the line width, of an integer multiple of a unit pitch, the region comprising adjacent wiring layers having wiring patterns provided so as to extend in the same direction.

This integrated circuit has adjacent wiring layers having wiring patterns provided so as to extend in the same direction. Accordingly, generally the same unit pitch can be set for the adjacent wiring layers without particular difficulty. Accordingly, electrical connection of the adjacent wiring layers can be easily performed. Also, regarding electrical connection between the adjacent wiring layers, interference with an a wiring pattern of an intermediate wiring layer, as with cases wherein an intermediate wiring layer is introduced between the wiring layers, can be suitably avoided. Accordingly, problems owing to reduction of size to minute dimensions can be easily dealt with, and design can be performed more efficiently.

Also, the regions have the wiring patterns provided thereto having a pitch, which is the interval between center lines of the line width of the wiring patterns provided in parallel, of an integer multiple of a unit pitch, so connection in designing of the integrated circuit can be easily designed following a regular pattern. Accordingly, in cases of using automatic layout wiring tools to connect the regions in particular, programming of the tool can be simplified, and processing for connection with the tool can also be simplified.

Note that of the integrated circuit, a logic circuit is preferably formed at this region. Memory, analog circuits, I/O (input/output) circuits, etc., may be formed at other regions of the integrated circuit.

19. The essence of one embodiment of the present invention in one form is that with the arrangement in the item 18 above, the higher the layer is in the multi-layer wiring structure, the larger the unit pitch is set.

With the above configuration, so-called inverse scaling is applied, wherein the higher the layer is, the larger the unit pitch is, so the configuration is such that the higher the layer is, the more readily wiring resistance is reduced. Accordingly, at the upper layers, long wiring patterns for connecting distanced parts can be provided.

Moreover, the above configuration has adjacent wiring layers with the direction in which the wiring patterns extend being the same, so even though inverse scaling is implemented, the unit pitch between the adjacent wiring layers is generally approximated.

20. The essence of one embodiment of the present invention in one form is that with the arrangements in the items 18 or 19 above, the unit pitch is set to generally the same pitch for each of the adjacent layers in the multi-layer wiring structure.

According to this configuration, electrical connection and the like of wiring patterns between wiring layers can be easily performed, since the unit pitch is generally the same in the adjacent wiring layers.

21. The essence of one embodiment of the present invention in one form is that with any one of the arrangements in the items 18 through 20 above, at the adjacent wiring layers, wiring patterns are provided at intervals greater than the unit pitch, and are provided such that the images of the wiring patterns thereof projected to the substrate do not overlay or overlap one another as viewed from above the substrate of the semiconductor integrated circuit.

With this configuration, the interval between adjacent wiring patterns can be increased within the same wiring layer, so capacitance between adjacent wiring patterns is smaller, and cross-talk noise can be suppressed. Also, in the event of electrically connecting a wiring pattern of the adjacent wiring layer where the wiring pattern extends in the same direction and a wiring pattern of another wiring layer where the wiring pattern extends in a different direction, direct connection can be made without the wiring pattern of the other adjacent layer interfering, so connection can be easily performed, and the amount of time required and the load for calculating the connection path with the automatic wiring tool can be reduced.

22. The essence of one embodiment of the present invention in one form is that with any one of the arrangements in the items 18 through 21 above. With such an arrangement, a pair of the wiring patterns are provided to one of the adjacent wiring layers. Furthermore, one of the wiring patterns forming a pair is provided so as to switch to the other one of the adjacent wiring layers.

With this configuration, portions where the pair of wiring patterns are mutually adjacent in the same wiring layer can be minimized, and the capacitance between this pair of wiring patterns can be suitably reduced. Also, designing the wiring layers adjacently enables interference with other wiring patterns, such as in cases wherein another wiring layer is provided between the wiring layers where the switching is performed, to be avoided.

23. The essence of one embodiment of the present invention in one form is that with any one of the arrangements in the items 18 through 22 above, one of the adjacent wiring layers includes a signal-transmission wiring pattern and a first wiring structure to be fixed to a certain electric potential, provided adjacent to one another, and the other wiring layer includes a second wiring structure to be fixed to a certain electric potential, which is provided over a region including the image of the signal-transmission wiring pattern projected to the other wiring layer, wherein the first and second wiring structures are electrically connected so as to form a shielding wiring structure for shielding the signal-transmission wiring pattern.

According to this configuration, the shielding wiring structure is configured using adjacent wiring layers. Accordingly, interference between the electrical connection of shielding wiring patterns and wiring patterns on other wiring layers, such as in cases wherein another wiring layer is provided between the wiring layers where the wiring patterns making up the shielding structure are provided, can be avoided. Consequently, a shielding wiring structure can be configured without major loss to wiring resources, thereby easily dealing with crosstalk and electromagnetic interference (EMI).

24. The essence of one embodiment of the present invention in one form is an integrated circuit, having a multi-layer wiring structure formed on a substrate, wherein one of adjacent wiring layers forming a pair includes a signal-transmission wiring pattern and a first wiring structure to be fixed to a certain electric potential, which are provided in parallel with each other and adjacent to one another, and the other wiring layer includes a second wiring structure to be fixed to a certain electric potential, which is provided over a region including the image of the signal-transmission wiring pattern projected to the other wiring layer, wherein the first and second wiring structures are electrically connected so as to form a shielding wiring structure for shielding the signal-transmission wiring pattern.

According to this configuration, the shielding wiring structure is configured using adjacent wiring layers. Accordingly, interference between the electrical connection of shielding wiring patterns and wiring patterns on other wiring layers, such as in cases wherein another wiring layer is provided between the wiring layers where the wiring patterns making up the shielding structure are provided, can be avoided. Consequently, a shielding wiring structure can be configured without major loss to wiring resources, thereby easily dealing with crosstalk and electromagnetic interference (EMI).

25. The essence of one embodiment of the present invention in one form is a design method for a semiconductor integrated circuit in which connection of wiring lines is performed using an automatic wiring tool regarding a semiconductor integrated circuit regarding which placement has been completed, wherein the connection is performed by setting wiring patterns extending in the same direction for adjacent wiring layers.

According to this design method, connection is performed for the wiring layers in which the adjacent wiring layers have the wiring patterns provided so as to extend in the same direction. Such an arrangement has the advantage as follows. With such an arrangement, generally the same unit pitch can be set for the adjacent wiring layers without particular difficulty. The wiring patterns are provided in parallel with each other at a pitch, which is the interval between center lines of the line width of the wiring patterns provided in parallel, of an integer multiple of the predetermined unit pitch. Accordingly, electrical connection of the adjacent wiring layers can be easily performed. Also, designing the wiring layers adjacent to each other can avoid and suppress electrical interference between the wiring patterns as compared to arrangements wherein a wiring pattern is disposed on an intermediate layer. Accordingly, problems owing to reduction of size to minute dimensions can be easily dealt with, and design can be performed more efficiently.

26. The essence of one embodiment of the present invention in one form is that with the arrangement in the above item 22, connection is performed while further setting a region wherein the wiring patterns on each layer are provided at a pitch greater than the unit pitch, and wherein the wiring patterns of each layer do not overlap when viewed from above the substrate of the semiconductor integrated circuit.

With the above design method, the interval between adjacent wiring patterns in the same wiring layer can be made greater, so capacitance between the adjacent wiring patterns is reduced, and crosstalk noise can be suppressed. Also, in the event of electrically connecting to a wiring pattern of another wiring layer where the wiring pattern extends in a different direction, direct connection can be made without the wiring pattern of the other adjacent layer interfering, so connection can be easily performed, and the amount of time required and the load for calculating the connection path with the automatic wiring tool can be reduced.

27. The essence of one embodiment of the present invention in one form is a design method for a semiconductor integrated circuit in which connection of wiring patterns is performed using an automatic wiring tool regarding a semiconductor integrated circuit regarding which placement has been completed, wherein the connection is performed by setting a region having wiring patterns extending in the same direction for adjacent wiring layers, under predetermined conditions that adjustment of electrical properties of the wiring patterns is required.

With this design method, providing a region wherein the direction of providing of wiring patterns is the same between wiring layers facilitates approximation with regard to the unit pitch of adjacent wiring layers. Accordingly, electrical connection of adjacent wiring layers can be easily performed in this region. Also, designing the wiring layers adjacently enables electrical interference between the wiring patterns and the wiring pattern of an intermediate wiring layer, as with a case wherein a wiring pattern is disposed on an intermediate layer, to be avoided. Accordingly, adjustment of the electric properties can be easily performed for the wiring pattern that requires adjustment of the electric properties thereof, and designing can be performed more effectively.

28. The essence of one embodiment of the present invention in one form is that with the arrangement in the above item 23. With such an arrangement, in the event that determination has been made that a shielded wiring pattern provided to a certain region requires adjustment of the electric properties, according to predetermined conditions, the automatic wiring tool creates fixed-potential wiring patterns each of which is a wiring pattern to be fixed to a certain electric potential. In this case, the automatic wiring tool provides the fixed-potential wiring patterns to regions adjacent to the shielded wiring pattern, and to another region which is a region in at least one of the layer above and the layer below the shielded wiring pattern, and which generally has a mirror image relation therebetween.

According to this design method, the fixed-potential wiring patterns serving as shielding wiring patterns to be fixed to a certain electric potential for shielding the shielded wiring pattern is configured using adjacent wiring layers. Accordingly, interference between the electrical connection of the shielding wiring structure and the wiring pattern of another wiring layer, as with a case wherein a shielding wiring structure is formed of shielding wiring layers with an intermediate wiring layer having a different wiring pattern introduced therebetween, can be avoided. Consequently, a shielding wiring structure can be configured without major loss to wiring resources, thereby easily dealing with crosstalk and electromagnetic interference (EMI)

Further note that following is included in the technical idea which can be understood from the above embodiments and modifications thereof.

With an integrated circuit design method according to any one of the arrangements in the items 13 through 15 above, in at least one region including at least one temporary physical wiring layer, the wiring pattern in the temporary physical wiring layer is converted into the multiple actual wiring layers generally in a mirror image relation therebetween. Examples of such conversions include:

a. converting predetermined wiring patterns on the temporary physical wiring layer into wiring patterns, provided to a region formed of at least two actual wiring layers generally in a mirror image relation therebetween, with the wiring patterns of the actual wiring layers being connected in parallel with each other,

b. converting predetermined wiring patterns on the temporary physical wiring layer into wiring patterns, provided to a region formed of at least two actual wiring layers generally in a mirror image relation therebetween, with the wiring patterns of the, actual wiring layers being connected serially with each other,

c. converting a pair of wiring patterns adjacent one to another and in parallel on the temporary physical wiring layer into wiring patterns, provided to a region formed of multiple actual wiring layers generally in a mirror image relation therebetween, with the wiring patterns of the actual wiring layers being connected with each other,

d. converting a pair of wiring patterns which are wiring patterns closest to each other on the temporary physical wiring layer into wiring patterns, provided to a region formed of multiple actual wiring layers generally in a mirror image relation therebetween, with the converted wiring patterns forming a pair being situated in different wiring,

e. converting a pair of wiring patterns which are wiring patterns closest to each other on the temporary physical wiring layer into wiring patterns, provided to a region formed of at least two actual wiring layers generally in a mirror image relation therebetween, such that the converted wiring patterns forming a pair alternately shift between wiring layers through via holes,

f. converting multiple fixed-potential wiring patterns which are multiple wiring patterns to be fixed to potentials which differ one from another, and a signal-transmission wiring pattern, designed on the temporary physical wiring layer, into wiring patterns, provided to a region formed of multiple actual wiring layers generally in a mirror image relation therebetween, such that at least one of the converted fixed-potential wiring patterns and the converted signal-transmission wiring pattern shift between wiring layers.

While the preferred embodiments of the present invention have been described using specific terms, such description is for illustrative purposes only, and it is to be understood that changes and variations may be made without departing from the spirit or scope of the appended claims.

What is claimed is:

1. An integrated circuit having a multi-layer wiring structure formed on a substrate, comprising wiring patterns provided to a plurality of wiring layers so as to extend as signal paths in generally the same direction in a manner in which the images of said wiring patterns projected onto the substrate of said integrated circuit overlay or overlap one another,
wherein said wiring patterns provided to said plurality of wiring layers are connected with each other through via holes so as to form a single wiring pattern connecting two desired points in said integrated circuit,
and wherein said single wiring pattern thus formed has one of: a wiring structure for connecting predetermined terminals of two desired circuit elements; a wiring structure for fixing the electric potential of a predetermined terminal of a desired element; and a wiring structure in which one end of said single wiring pattern is substantially opened.

2. An integrated circuit having a multi-layer wiring structure formed on a substrate, comprising:
a first wiring pattern for connecting two desired points in said integrated circuit; and
a second wiring pattern provided to a wiring layer different from the wiring layer where said first wiring pattern is provided,
wherein said first wiring layer and said second wiring layer are electrically connected in parallel with each other so as to form a single wiring pattern for connecting said two desired points.

3. An integrated circuit having a multi-layer wiring structure formed on a substrate, comprising a plurality of wiring patterns provided to a plurality of wiring layers in a manner in which the images thereof projected onto said substrate overlay or overlap one another,
wherein said plurality of wiring patterns are electrically connected in serial with each other such that a signal is transmitted in the direction opposite to that of the adjacent wiring pattern, thereby forming a single wiring pattern for connecting two desired points in said integrated circuit.

4. An integrated circuit having a multi-layer wiring structure formed on a substrate, comprising:
a first pair of wiring patterns provided to a predetermined wiring layer adjacent one another in parallel with each other; and
a second pair of wiring patterns provided to another predetermined wiring layer adjacent one another in parallel with each other,
wherein said first pair of wiring patterns and said second pair of wiring patterns are provided such that the images thereof projected onto said substrate overlay or overlap one another,
and wherein, while the one ends of said second pair of wiring patterns are connected to said first pair of wiring patterns, the other ends thereof are open, whereby said second pair of wiring patterns serve as a dummy wiring pattern.

5. An integrated circuit having a multi-layer wiring structure formed on a substrate, comprising:
a first wiring structure formed of wiring patterns which are provided to a plurality of wiring layers such that the images thereof projected onto said substrate overlay or overlap one another, and which are electrically connected in serial with each other via through holes; and
a second wiring structure formed of wiring patterns which are provided to the same plurality of wiring layers as with the wiring patterns forming said first wiring structure, such that the images thereof projected onto said substrate overlay or overlap one another, and which are electrically connected in serial with each other via through holes,
wherein each wiring pattern of said first wiring structure and the corresponding wiring pattern of said second wiring structure are provided adjacent one another in parallel with each other in the same wiring layer.

6. An integrated circuit having a multi-layer wiring structure formed on a substrate, comprising:
a signal-transmission wiring pattern for transmitting a signal; and
a plurality of fixed-electric-potential wiring patterns fixed to different electric potentials,
wherein said signal-transmission wiring pattern and one of said plurality of fixed-electric-potential wiring patterns are provided such that the images thereof projected onto said substrate are arranged adjacent one another,
and wherein said signal-transmission wiring pattern and said one of said plurality of fixed-electric-potential wiring patterns are provided so as to shift back and forth between a first wiring layer and a second wiring layer, wherein said signal-transmission wiring pattern and said one of said plurality of fixed-electric-potential wiring patterns are always situated in the wiring layer in which the other is not situated.

7. An integrated circuit having a multi-layer wiring structure formed on a substrate, comprising a region having a plurality of wiring layers in which wiring patterns are provided so as to extend in generally the same direction at a pitch of an integer multiple of a predetermined unit pitch,
wherein said region includes an integrated circuit according to claim 2, formed therein.

8. An integrated circuit according to claim 7, wherein said wiring patterns are provided so as to extend in different directions in at least one wiring layer between adjacent regions.

9. An integrated circuit according to claim 8, wherein said adjacent regions, having at least one wiring layer where said wiring patterns are provided in different manners one from another, are electrically connected using a wiring pattern provided in a wiring layer other than said one wiring layer, in which the image thereof projected to said substrate forms a single line across the boundary between said adjacent regions.

10. An integrated circuit having a multi-layer wiring structure formed on a substrate, comprising a region having a plurality of wiring layers in which wiring patterns are provided so as to extend in generally the same direction at a pitch of an integer multiple of a predetermined unit pitch,
wherein said region includes an integrated circuit according to claim 3, formed therein.

11. An integrated circuit according to claim 10, wherein said wiring patterns are provided so as to extend in different directions in at least one wiring layer between adjacent regions.

12. An integrated circuit according to claim 11, wherein said adjacent regions, having at least one wiring layer where said wiring patterns are provided in different manners one from another, are electrically connected using a wiring pattern provided in a wiring layer other than said one wiring layer, in which the image thereof projected to said substrate forms a single line across the boundary between said adjacent regions.

13. An integrated circuit having a multi-layer wiring structure formed on a substrate, comprising a region having a plurality of wiring layers in which wiring patterns are provided so as to extend in generally the same direction at a pitch of an integer multiple of a predetermined unit pitch,
wherein said region includes an integrated circuit according to claim 4, formed therein.

14. An integrated circuit according to claim 13, wherein said wiring patterns are provided so as to extend in different directions in at least one wiring layer between adjacent regions.

15. An integrated circuit according to claim 14, wherein said adjacent regions, having at least one wiring layer where said wiring patterns are provided in different manners one from another, are electrically connected using a wiring pattern provided in a wiring layer other than said one wiring layer, in which the image thereof projected to said substrate forms a single line across the boundary between said adjacent regions.

16. An integrated circuit having a multi-layer wiring structure formed on a substrate, comprising a region having a plurality of wiring layers in which wiring patterns are provided so as to extend in generally the same direction at a pitch of an integer multiple of a predetermined unit pitch,
wherein said region includes an integrated circuit according to claim 6, formed therein.

17. An integrated circuit according to claim 16, wherein said wiring patterns are provided so as to extend in different directions in at least one wiring layer between adjacent regions.

18. An integrated circuit according to claim 17, wherein said adjacent regions, having at least one wiring layer where said wiring patterns are provided in different manners one from another, are electrically connected using a wiring pattern provided in a wiring layer other than said one wiring layer, in which the image thereof projected to said substrate forms a single line across the boundary between said adjacent regions.
